(19) United States
(12) Patent Application Publication
(10) Pub. No.: US 2017/0055025 A1
(43) Pub. Date: Feb. 23, 2017

(54) BROADCAST TRANSMISSION APPARATUS, BROADCAST RECEPTION APPARATUS, OPERATION METHOD OF THE BROADCAST TRANSMISSION APPARATUS AND OPERATION METHOD OF THE BROADCAST RECEPTION APPARATUS

(71) Applicant: LG ELECTRONICS INC., SEOUL (KR)

(72) Inventors: Jinwon LEE, Seoul (KR); Sejin OH, Seoul (KR); Kyoungsoo MOON, Seoul (KR); Jangwon LEE, Seoul (KR); Woosuk KO, Seoul (KR); Sungryong HONG, Seoul (KR)

(21) Appl. No.: 15/307,760

(22) PCT Filed: Apr. 24, 2015
(86) PCT No.: PCT/KR2015/004130

§ 371 Date: Oct. 31, 2016

Related U.S. Application Data
(60) Provisional application No. 61/986,113, filed on Apr. 30, 2014.
(60) Provisional application No. 62/004,211, filed on May 29, 2014.

(51) Int. Cl. H04N 21/434; H04N 21/643; H04N 21/235; H04N 21/435; H04L 29/08; H04L 29/06

(52) U.S. Cl. CPC H04N 21/4345; H04L 67/02; H04L 65/601; H04L 65/608; H04N 21/235; H04N 21/435; H04N 21/64322

(57) ABSTRACT

A broadcast reception apparatus for receiving broadcast signals according to one embodiment of the present invention comprises: a broadcast reception unit for receiving broadcast signals; and a control unit for obtaining application signaling information regarding application signaling included in a broadcasting service on the basis of the broadcast signals.

### TECHNICAL FIELD

The present invention relates to a broadcast transmission apparatus, a broadcast reception apparatus, an operation method of the broadcast transmission apparatus, and an operation method of the broadcast reception apparatus.

### BACKGROUND ART

With the advances in digital broadcast environment and communication environment, hybrid broadcast using a communication network (broadband) as well as an existing broadcast network is getting in the spotlight. Also, such a hybrid broadcast provides an application or a broadcast service that interoperates with a terminal device such as a smartphone or a tablet PC. Also, the hybrid broadcast provides an application related to a broadcast service and a personalization function of providing content suitable for each user.

In order for such a hybrid broadcast, a broadcast reception apparatus must be able to freely access a communication network (broadband). Also, the broadcast reception apparatus must be able to present content received via the communication network (broadband). For this purpose, a broadcast reception apparatus and a broadcast transmission apparatus must support a content transport protocol that supports both a broadcast network and a communication network (broadband). In this regard, it has been proposed that the broadcast transmission apparatus and the broadcast reception apparatus must use MPEG-Dynamic Adaptive Streaming over HTTP (DASH), which is the standard technology for adaptively transmitting media content according to a network environment, and MPEG Media Transport (MMT), which is the transport technology for efficiently transmitting media content via an IP network.

### DISCLOSURE OF THE INVENTION

### Technical Problem

Embodiments of the present invention are directed to provide a broadcast transmission apparatus, a broadcast reception apparatus, an operation method of the broadcast transmission apparatus, and an operation method of the broadcast reception apparatus, which provide transmission and presentation of media content via a communication network (broadband) and a broadcast network.

### Technical Solution

In one embodiment, a broadcast reception apparatus for receiving broadcast signals includes: a broadcast reception unit for receiving broadcast signals; and a control unit for obtaining application signaling information regarding application signaling included in a broadcasting service on the basis of the broadcast signals.

The control unit may obtain the application signaling information based on Moving Picture Expert Group-Dynamic Adaptive Streaming over HTTP (MPEG-DASH).

The control unit may obtain the application signaling message based on an event message of a Media Presentation Description (MPD) of an event stream of the MPEG-DASH.

The control unit may obtain a start time of a triggering event from the MPD.

The control unit may obtain the application signaling information from an inband event stream of the MPEG-DASH.

The control unit may obtain a start time of a triggering event from an event message box.

The control unit may obtain the application signaling information based on a Moving picture expert group Media Transport (MMT) protocol packet.

The control unit may obtain the application signaling information based on a format of the MMT protocol packet including a Media Processing Unit (MPU).

The control unit may obtain the application signaling information based on a format of the MMT protocol packet including a generic object.

The control unit may obtain the application signaling information based on a format of the MMT protocol packet including a signaling message.

The control unit may obtain the application signaling information based on header extension information indicating information for header expansion of the MMT protocol packet.

The application signaling information may include a trigger for triggering the application.

The control unit may carry out an action of the application based on the trigger.

The control unit may carry out the action of the application after a start time of a triggering event from the trigger and before an end time of the triggering event included in the trigger, and the triggering event may indicate an event generated by a trigger.

The control unit may change a status of the application based on the trigger.

The control unit may obtain a location of triggering application information for signaling information about an application triggered by the trigger, based on the trigger, and may obtain the triggering application information based on the location of the triggering application information.

The control unit may obtain a media time of content presented by the broadcast reception apparatus, based on the trigger.

The control unit may generate a timeline which is a reference for synchronization between the triggering event and the content based on the media time of the content, and the triggering event may indicate an event generated by a trigger.

In another embodiment, an operation method of a broadcast reception apparatus for receiving broadcast signals includes: receiving broadcast signals; and obtaining application signaling information regarding application signaling included in a broadcasting service on the basis of the broadcast signals.

In further another embodiment, an operation method of a broadcast transmission apparatus for transmitting broadcast signals includes: a control unit for obtaining information about an application included in a broadcast service and generating application signaling information regarding application signaling on the basis of the information about the application; and a transmission unit for transmitting the broadcast signal on the basis of the application signaling information.

### Advantageous Effects

According to embodiments, it is possible to provide a broadcast transmission apparatus, a broadcast reception apparatus, an operation method of the broadcast transmission apparatus, and an operation method of the broadcast reception apparatus, which provide transmission and presentation of media content via a communication network (broadband) and a broadcast network.

### BRIEF DESCRIPTION OF THE DRAWINGS

FIG. 1 illustrates a configuration of an apparatus for transmitting broadcast signals for future broadcast services according to an embodiment of the present invention.

FIG. 2 illustrates an input formatting block according to one embodiment of the present invention.

FIG. 3 illustrates an input formatting block according to another embodiment of the present invention.

FIG. 4 illustrates a BICM (bit interleaved coding & modulation) block according to an embodiment of the present invention.

FIG. 5 illustrates a BICM block according to another embodiment of the present invention.

FIG. 6 illustrates a frame building block according to one embodiment of the present invention.

FIG. 7 illustrates an OFDM (orthogonal frequency division multiplexing) generation block according to an embodiment of the present invention.

FIG. 8 illustrates a configuration of an apparatus for receiving broadcast signals for future broadcast services according to an embodiment of the present invention.

FIG. 9 illustrates a frame structure according to an embodiment of the present invention.

FIG. 10 illustrates a signaling hierarchy structure of a frame according to an embodiment of the present invention.

FIG. 11 illustrates preamble signaling data according to an embodiment of the present invention.

FIG. 12 illustrates PLS1 data according to an embodiment of the present invention.

FIG. 13 illustrates PLS2 data according to an embodiment of the present invention.

FIG. 14 illustrates PLS2 data according to another embodiment of the present invention.

FIG. 15 illustrates a logical structure of a frame according to an embodiment of the present invention.

FIG. 16 illustrates PLS (physical layer signaling) mapping according to an embodiment of the present invention.

FIG. 17 illustrates EAC (emergency alert channel) mapping according to an embodiment of the present invention.

FIG. 18 illustrates FIC (fast information channel) mapping according to an embodiment of the present invention.

FIG. 19 illustrates an FEC (forward error correction) structure according to an embodiment of the present invention.

FIG. 20 illustrates a time interleaving according to an embodiment of the present invention.

FIG. 21 illustrates the basic operation of a twisted row-column block interleaver according to an embodiment of the present invention.

FIG. 22 illustrates an operation of a twisted row-column block interleaver according to another embodiment of the present invention.

FIG. 23 illustrates a diagonal-wise reading pattern of a twisted row-column block interleaver according to an embodiment of the present invention.

FIG. 24 illustrates interleaved XFECBLOCKs from each interleaving array according to an embodiment of the present invention.

FIG. 25 is a block diagram illustrating a media content transmission/reception system according to an embodiment.

FIG. 26 is a diagram illustrating a system for transmitting/receiving media content via a broadband according to an embodiment.

FIG. 27 illustrates a structure of a Media Presentation Description (MPD) according to an embodiment of the present invention.

FIG. 28 illustrates a syntax of the MPD according to an embodiment of the present invention.

FIG. 29 illustrates an XML syntax of a period element of the MPD according to an embodiment of the present invention.

FIG. 30 is a flowchart of an operation of receiving, by a broadcast reception apparatus, media content via a communication network according to an embodiment.

FIG. 31 illustrates a bitstream syntax for the case where the MPD is transmitted in a format of an MPD information table according to an embodiment of the present invention.

FIG. 32 is a flowchart of an operation of extracting, by a broadcast reception apparatus, the MPD on the basis of an information table including the MPD according to an embodiment of the present invention.

FIG. 33 illustrates an MPD link table including an MPD link according to an embodiment of the present invention.

FIG. 34 is a flowchart of an operation of receiving, by a broadcast reception apparatus, the MPD on the basis of a media content presentation information table including a media content presentation information link according to an embodiment of the present invention.

FIG. 35 illustrates that the MPD or the MPD information table is added to an IP datagram so as to be transmitted according to an embodiment of the present invention.

FIG. 36 illustrates a syntax of the IP datagram for the case where the MPD or the MPD information table is added to the IP datagram so as to be transmitted according to an embodiment of the present invention.

FIG. 37 illustrates a syntax of an MPD payload included in the IP datagram for the case where the MPD or the MPD information table is added to the IP datagram so as to be transmitted according to an embodiment of the present invention.

FIG. 38 is a flowchart of an operation of extracting, by a broadcast reception apparatus, the media content presentation information or the media content presentation information table on the basis of the IP datagram including the media content presentation information or the media content presentation information table according to an embodiment of the present invention.

FIG. 39 illustrates a syntax of an MPD descriptor for transmitting the MPD according to an embodiment of the present invention.

FIG. 40 illustrates a syntax of MPD bootstrap_data in the case where the MPD descriptor directly includes the MPD.

FIG. 41 illustrates the syntax of the MPD bootstrap_data in the case where the MPD descriptor includes a link that links the MPD.

FIG. 42 illustrates the syntax of the MPD bootstrap_data in the case where the MPD descriptor includes an identifier of a data packet including the MPD.

FIG. 43 illustrates the syntax of the MPD bootstrap_data in the case where the MPD descriptor includes an identifier of an additional broadcast stream including the MPD.

FIG. 44 illustrates the syntax of the MPD bootstrap_data in the case where the MPD descriptor includes information about an IP datagram including the MPD.

FIG. 45 illustrates the syntax of the MPD bootstrap_data in the case where the MPD descriptor includes information about a session-based transport protocol session for transmitting the MPD.

FIG. 46 is a flowchart of an operation of receiving, by a broadcast reception apparatus, the media content presentation information in the case where a method of transmitting the media content presentation information is added to the broadcast information signaling information table so as to be transmitted.

FIG. 47 is a flowchart of an operation of presenting, by a broadcast reception apparatus, media content on the basis of whether transmission of a broadcast stream is stable in the case where broadcast content is transmitted via not only a broadcasting network but also a communication network.

FIG. 48 illustrates a syntax of a broadcast stream packet including synchronization information of media content transmitted via a communication network according to an MPEG-DASH standard.

FIG. 49 illustrates a syntax of synchronization information added to a header of a packet including broadcast content such as a video or an audio according to an embodiment of the present invention.

FIG. 50 illustrates a syntax of synchronization information added to a header of a packet including broadcast content such as a video or an audio according to another embodiment of the present invention.

FIG. 51 is a flowchart of an operation of synchronizing, by a broadcast reception apparatus, broadcast content with media content according to an embodiment of the present invention.

FIG. 52 illustrate a format of information for identifying broadcast content included in media content presentation information when broadcast content is transmitted according to an ATSC standard.

FIG. 53 illustrates an example of an MPD of MPEG-DASH including information for identifying broadcast content transmitted according to the ATSC standard.

FIG. 54 is a flowchart of an operation of, by a broadcast reception apparatus, receiving broadcast content based on media content presentation information.

FIG. 55 illustrates a block diagram for describing an example in which a broadcast reception apparatus receives an MPD of MPEG-DASH via a broadcast network for transmitting a broadcast stream according to an MPEG-2 TS standard.

FIG. 56 is a block diagram for describing an example in which a broadcast reception apparatus synchronizes broadcast content of a broadcast stream transmitted according to the MPEG-2 TS standard with media content transmitted via a communication network.

FIG. 57 illustrates a configuration of a broadcast reception apparatus according to an embodiment of the present invention.

FIG. 58 illustrates a configuration of a broadcast reception apparatus according to another embodiment of the present invention.

FIG. 59 illustrates a configuration of a broadcast reception apparatus according to another embodiment of the present invention.

FIG. 60 is a flowchart of an operation of scanning a broadcast service and generating a channel map in the broadcast reception apparatus.

FIG. 61 is a flowchart of an operation of receiving, by a broadcast reception apparatus, a broadcast service.

FIG. 62 is a flowchart of an operation of acquiring, by a broadcast reception apparatus, a media component based on media content presentation information.

FIG. 63 illustrates a broadcast transport frame according to an embodiment of the present invention.

FIG. 64 illustrates a broadcast transport frame according to another embodiment of the present invention.

FIG. 65 illustrates a configuration of a service signaling message, according to an embodiment of the present invention.

FIG. 66 illustrates a configuration of a broadcast service signaling message in a future broadcast system, according to an embodiment of the present invention.

FIG. 67 illustrates content meant by a value indicated by a timebase_transport_mode field and a signaling_transport_mode field in a service signaling message, according to an embodiment of the present invention.

FIG. 68 illustrates a syntax of a bootstrap( ) field according to a value of the timebase_transport_mode field and a value of the signaling_transport_mode field in an embodiment of the present invention.

FIG. 69 illustrates a syntax of a bootstrap( ) field according to a value of the timebase_transport_mode field and a value of the signaling_transport_mode field in an embodiment of the present invention.

FIG. 70 illustrates a syntax of a bootstrap( ) field according to a value of the timebase_transport_mode field and a value of the signaling_transport_mode field in an embodiment of the present invention.

FIG. 71 illustrates a syntax of a bootstrap( ) field according to a value of the timebase_transport_mode field and a value of the signaling_transport_mode field in an embodiment of the present invention.

FIG. 72 illustrates a syntax of a bootstrap( ) field according to a value of the timebase_transport_mode field and a value of the signaling_transport_mode field in an embodiment of the present invention.

FIG. 73 illustrates a syntax of a bootstrap( ) field according to a value of the timebase_transport_mode field and a value of the signaling_transport_mode field in an embodiment of the present invention.

FIG. 74 illustrates a syntax of a bootstrap( ) field according to a value of the timebase_transport_mode field and a value of the signaling_transport_mode field in an embodiment of the present invention.

FIG. 75 illustrates a process of acquiring a timebase and a service signaling message according to the embodiments of FIGS. 66 to 74.

FIG. 76 illustrates a configuration of a broadcast service signaling message in a future broadcast system, according to an embodiment of the present invention.

FIG. 77 illustrates a configuration of a broadcast service signaling message in a future broadcast system, according to an embodiment of the present invention.

FIG. 78 illustrates the meaning of values represented by the transport modes described with reference to FIG. 77.

FIG. 79 illustrates a configuration of a signaling message for signaling a component data acquisition path of a broadcast service in a future broadcasting system.

FIG. 80 illustrates a syntax an app_delivery_info( ) field according to an embodiment of the present invention.

FIG. 81 illustrates a syntax of an app_delivery_info( ) field according to another embodiment of the present invention.

FIG. 82 illustrates component location signaling including information about a path in which one or more pieces of component data constituting a broadcast service can be acquired, according to another embodiment of the present invention.

FIG. 83 illustrates a configuration of the component location signaling of FIG. 82 according to another embodiment of the present invention.

FIG. 84 is a flowchart of operation of a broadcasting receiving apparatus according to an embodiment of the present invention.

FIG. 85 is a flowchart of operation of a broadcasting transmitting apparatus according to an embodiment of the present invention.

FIG. 86 illustrates a trigger based on a trigger syntax according to an embodiment of the present invention.

FIG. 87 illustrates a syntax of application signaling information according to an embodiment of the present invention.

FIG. 88 illustrates a syntax of an Event Stream element included in an MPD according to an embodiment of the present invention.

FIG. 89 illustrates a syntax of an Event element of the Event Stream element included in the MPD according to an embodiment of the present invention.

FIG. 90 illustrates a syntax of an event message box for inband event signaling according to an embodiment of the present invention.

FIG. 91 illustrates a matching relationship among a trigger property, an MPD element, and an event message box for signaling a location of application signaling information according to an embodiment of the present invention.

FIG. 92 illustrates a matching relationship among a trigger property, an MPD element, and an event message box for signaling a status of an application according to an embodiment of the present invention.

FIG. 93 illustrates a matching relationship among a trigger property, an MPD element, and an event message box for signaling an action of an application according to an embodiment of the present invention.

FIG. 94 illustrates a matching relationship among a trigger property, an MPD element, and an event message box for signaling a media time according to an embodiment of the present invention.

FIG. 95 illustrates a definition of value attributes for signaling all trigger properties as one event according to an embodiment of the present invention.

FIG. 96 illustrates a matching relationship among an identifier attribute and a message attribute of an event element and an identifier field and a message data field of an event message box for signaling all trigger properties as one event according to an embodiment of the present invention.

FIG. 97 illustrates a structure of a package of an MMT protocol according to an embodiment of the present invention.

FIG. 98 illustrates a structure of an MMTP packet and types of data included in the MMTP packet according to an embodiment of the present invention.

FIG. 99 illustrates a syntax of a header of an MMTP payload header when the MMTP packet includes a fragment of an MPU according to an embodiment of the present invention.

FIG. 100 illustrates synchronization of content and a trigger transmitted through an MPU according to an embodiment of the present invention.

FIG. 101 illustrates a syntax of an MMT signaling message according to another embodiment of the present invention.

FIG. 102 illustrates a relationship between a value of an identifier for identifying an MMT signaling message and data signaled by the MMT signaling message according to another embodiment of the present invention.

FIG. 103 illustrates a syntax of a signaling message including application signaling information according to another embodiment of the present invention.

FIG. 104 illustrates a syntax of an application signaling table including application signaling information according to another embodiment of the present invention.

FIG. 105 illustrates a relationship between trigger type information included in an application signaling table and a trigger property included in a trigger according to another embodiment of the present invention.

FIG. 106 illustrates a relationship between a value of an identifier for identifying an MMT signaling message and data signaled by the MMT signaling message according to another embodiment of the present invention.

FIG. 107 illustrates a syntax of an application signaling table not including trigger type information according to another embodiment of the present invention.

FIG. 108 illustrates a structure of an MMTP according to another embodiment of the present invention.

FIG. 109 illustrates a structure of an MMTP packet and a syntax of a header extension field for transmitting application signaling information according to another embodiment of the present invention.

FIG. 110 illustrates that a broadcast transmission apparatus transmits a broadcast signal based on application signaling information according to another embodiment of the present invention.

FIG. 111 illustrates that a broadcast reception apparatus acquires application signaling information based on a broadcast signal according to embodiments of the present invention.

### MODE FOR CARRYING OUT THE INVENTION

Hereinafter, embodiments of the present invention will be described in more detail with reference to the accompanying drawings, in order to allow those skilled in the art to easily realize the present invention. The present invention may be realized in different forms, and is not limited to the embodiments described herein. Moreover, detailed descriptions related to well-known functions or configurations will be ruled out in order not to unnecessarily obscure subject matters of the present invention. Like reference numerals refer to like elements throughout.

In additional, when a part “includes” some components, this means that the part does not exclude other components unless stated specifically and further includes other components.

The present invention provides broadcast signal transmission/reception device and method. According to the embodiment of the present invention, the further broadcast services include a terrestrial broadcasting service, a mobile broadcasting server, and UHDTV service. The present invention may process broadcast signals for the future broadcast services through non-MIMO (Multiple Input Multiple Output) or MIMO according to one embodiment. A non-MIMO scheme according to an embodiment of the present invention may include a MISO (Multiple Input Single Output) scheme, a SISO (Single Input Single Output) scheme, etc.

While MISO or MIMO uses two antennas in the following for convenience of description, the present invention is applicable to systems using two or more antennas. The present invention may defines three physical layer (PL) profiles (base, handheld and advanced profiles) each optimized to minimize receiver complexity while attaining the performance required for a particular use case. The physical layer (PHY) profiles are subsets of all configurations that a corresponding receiver should implement.

The three PHY profiles share most of the functional blocks but differ slightly in specific blocks and/or parameters. Additional PHY profiles can be defined in the future. For the system evolution, future profiles can also be multiplexed with the existing profiles in a single RF channel through a future extension frame (FEF). The details of each PHY profile are described below.

1. Base Profile

The base profile represents a main use case for fixed receiving devices that are usually connected to a roof-top antenna. The base profile also includes portable devices that could be transported to a place but belong to a relatively stationary reception category. Use of the base profile could be extended to handheld devices or even vehicular by some improved implementations, but those use cases are not expected for the base profile receiver operation.

Target SNR range of reception is from approximately 10 to 20 dB, which includes the 15 dB SNR reception capability of the existing broadcast system (e.g. ATSC A/53). The receiver complexity and power consumption is not as critical as in the battery-operated handheld devices, which will use the handheld profile. Key system parameters for the base profile are listed in below table 1.

TABLE 1

| | |
|---|---|
| LDPC codeword length | 16K, 64K bits |
| Constellation size | 4~10 bpcu (bits per channel use) |
| Time de-interleaving memory size | ≦2¹⁹ data cells |
| Pilot patterns | Pilot pattern for fixed reception |
| FFT size | 16K, 32K points |

2. Handheld Profile

The handheld profile is designed for use in handheld and vehicular devices that operate with battery power. The devices can be moving with pedestrian or vehicle speed. The power consumption as well as the receiver complexity is very important for the implementation of the devices of the handheld profile. The target SNR range of the handheld profile is approximately 0 to 10 dB, but can be configured to reach below 0 dB when intended for deeper indoor reception.

In addition to low SNR capability, resilience to the Doppler Effect caused by receiver mobility is the most important performance attribute of the handheld profile. Key system parameters for the handheld profile are listed in the below table 2.

TABLE 2

| | |
|---|---|
| LDPC codeword length | 16K bits |
| Constellation size | 2~8 bpcu |
| Time de-interleaving memory size | ≦2¹⁸ data cells |
| Pilot patterns | Pilot patterns for mobile |
| | and indoor reception |
| FFT size | 8K, 16K points |

3. Advanced Profile

The advanced profile provides highest channel capacity at the cost of more implementation complexity. This profile requires using MIMO transmission and reception, and UHDTV service is a target use case for which this profile is specifically designed. The increased capacity can also be used to allow an increased number of services in a given bandwidth, e.g., multiple SDTV or HDTV services.

The target SNR range of the advanced profile is approximately 20 to 30 dB. MIMO transmission may initially use existing elliptically-polarized transmission equipment, with extension to full-power cross-polarized transmission in the future. Key system parameters for the advanced profile are listed in below table 3.

TABLE 3

| | |
|---|---|
| LDPC codeword length | 16K, 64K bits |
| Constellation size | 8~12 bpcu |
| Time de-interleaving memory size | ≦2¹⁹ data cells |
| Pilot patterns | Pilot pattern for fixed reception |
| FFT size | 16K, 32K points |

In this case, the base profile can be used as a profile for both the terrestrial broadcast service and the mobile broadcast service. That is, the base profile can be used to define a concept of a profile which includes the mobile profile. Also, the advanced profile can be divided advanced profile for a base profile with MIMO and advanced profile for a handheld profile with MIMO. Moreover, the three profiles can be changed according to intention of the designer.

The following terms and definitions may apply to the present invention. The following terms and definitions can be changed according to design.

auxiliary stream: sequence of cells carrying data of as yet undefined modulation and coding, which may be used for future extensions or as required by broadcasters or network operators

base data pipe: data pipe that carries service signaling data

baseband frame (or BBFRAME): set of Kbch bits which form the input to one FEC encoding process (BCH and LDPC encoding)

cell: modulation value that is carried by one carrier of the OFDM transmission

coded block: LDPC-encoded block of PLS1 data or one of the LDPC-encoded blocks of PLS2 data

data pipe: logical channel in the physical layer that carries service data or related metadata, which may carry one or multiple service(s) or service component(s).

data pipe unit: a basic unit for allocating data cells to a DP in a frame.

data symbol: OFDM symbol in a frame which is not a preamble symbol (the frame signaling symbol and frame edge symbol is included in the data symbol)

DP_ID: this 8 bit field identifies uniquely a DP within the system identified by the SYSTEM_ID

dummy cell: cell carrying a pseudorandom value used to fill the remaining capacity not used for PLS signaling, DPs or auxiliary streams

emergency alert channel: part of a frame that carries EAS information data

frame: physical layer time slot that starts with a preamble and ends with a frame edge symbol

frame repetition unit: a set of frames belonging to same or different physical layer profile including a FEF, which is repeated eight times in a super-frame

fast information channel: a logical channel in a frame that carries the mapping information between a service and the corresponding base DP

FECBLOCK: set of LDPC-encoded bits of a DP data

FFT size: nominal FFT size used for a particular mode, equal to the active symbol period Ts expressed in cycles of the elementary period T

frame signaling symbol: OFDM symbol with higher pilot density used at the start of a frame in certain combinations of FFT size, guard interval and scattered pilot pattern, which carries a part of the PLS data

frame edge symbol: OFDM symbol with higher pilot density used at the end of a frame in certain combinations of FFT size, guard interval and scattered pilot pattern

frame-group: the set of all the frames having the same PHY profile type in a super-frame.

future extension frame: physical layer time slot within the super-frame that could be used for future extension, which starts with a preamble

Futurecast UTB system: proposed physical layer broadcasting system, of which the input is one or more MPEG2-TS or IP or general stream(s) and of which the output is an RF signal

input stream: A stream of data for an ensemble of services delivered to the end users by the system.

normal data symbol: data symbol excluding the frame signaling symbol and the frame edge symbol

PHY profile: subset of all configurations that a corresponding receiver should implement

PLS: physical layer signaling data consisting of PLS1 and PLS2

PLS1: a first set of PLS data carried in the FSS symbols having a fixed size, coding and modulation, which carries basic information about the system as well as the parameters needed to decode the PLS2

NOTE: PLS1 data remains constant for the duration of a frame-group.

PLS2: a second set of PLS data transmitted in the FSS symbol, which carries more detailed PLS data about the system and the DPs

PLS2 dynamic data: PLS2 data that may dynamically change frame-by-frame

PLS2 static data: PLS2 data that remains static for the duration of a frame-group

preamble signaling data: signaling data carried by the preamble symbol and used to identify the basic mode of the system

preamble symbol: fixed-length pilot symbol that carries basic PLS data and is located in the beginning of a frame

NOTE: The preamble symbol is mainly used for fast initial band scan to detect the system signal, its timing, frequency offset, and FFTsize.

reserved for future use: not defined by the present document but may be defined in future

superframe: set of eight frame repetition units

time interleaving block (TI block): set of cells within which time interleaving is carried out, corresponding to one use of the time interleaver memory

TI group: unit over which dynamic capacity allocation for a particular DP is carried out, made up of an integer, dynamically varying number of XFECBLOCKs.

NOTE: The TI group may be mapped directly to one frame or may be mapped to multiple frames. It may contain one or more TI blocks.

Type 1 DP: DP of a frame where all DPs are mapped into the frame in TDM fashion

Type 2 DP: DP of a frame where all DPs are mapped into the frame in FDM fashion

XFECBLOCK: set of Ncells cells carrying all the bits of one LDPC FECBLOCK

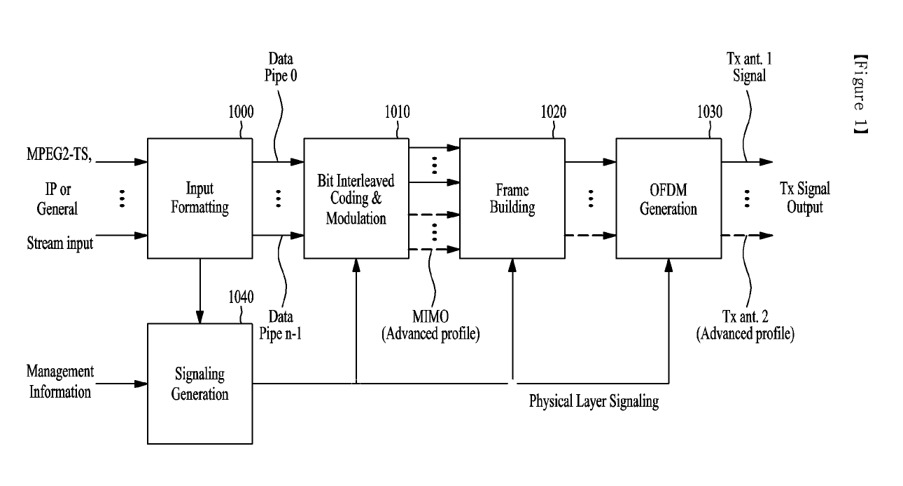

FIG. 1 illustrates a configuration of an apparatus for transmitting broadcast signals for future broadcast services according to an embodiment of the present invention.

The apparatus for transmitting broadcast signals for future broadcast services according to an embodiment of the present invention can include an input formatting block 1000, a BICM (Bit interleaved coding & modulation) block 1010, a frame building block 1020, an OFDM (Orthogonal Frequency Division Multiplexing) generation block 1030 and a signaling generation block 1040. A description will be given of the operation of each module of the apparatus for transmitting broadcast signals.

IP stream/packets and MPEG2-TS are the main input formats, other stream types are handled as General Streams. In addition to these data inputs, Management Information is input to control the scheduling and allocation of the corresponding bandwidth for each input stream. One or multiple TS stream(s), IP stream(s) and/or General Stream(s) inputs are simultaneously allowed.

The input formatting block 1000 can demultiplex each input stream into one or multiple data pipe(s), to each of which an independent coding and modulation is applied. The data pipe (DP) is the basic unit for robustness control, thereby affecting quality-of-service (QoS). One or multiple service(s) or service component(s) can be carried by a single DP. Details of operations of the input formatting block 1000 will be described later.

The data pipe is a logical channel in the physical layer that carries service data or related metadata, which may carry one or multiple service(s) or service component(s).

Also, the data pipe unit: a basic unit for allocating data cells to a DP in a frame.

In the BICM block 1010, parity data is added for error correction and the encoded bit streams are mapped to complex-value constellation symbols. The symbols are interleaved across a specific interleaving depth that is used for the corresponding DP. For the advanced profile, MIMO encoding is performed in the BICM block 1010 and the additional data path is added at the output for MIMO transmission. Details of operations of the BICM block 1010 will be described later.

The Frame Building block 1020 can map the data cells of the input DPs into the OFDM symbols within a frame. After mapping, the frequency interleaving is used for frequency-domain diversity, especially to combat frequency-selective fading channels. Details of operations of the Frame Building block 1020 will be described later.

After inserting a preamble at the beginning of each frame, the OFDM Generation block 1030 can apply conventional OFDM modulation having a cyclic prefix as guard interval. For antenna space diversity, a distributed MISO scheme is applied across the transmitters. In addition, a Peak-to-Average Power Reduction (PAPR) scheme is performed in the time domain. For flexible network planning, this proposal provides a set of various FFT sizes, guard interval lengths and corresponding pilot patterns. Details of operations of the OFDM Generation block 1030 will be described later.

The Signaling Generation block 1040 can create physical layer signaling information used for the operation of each functional block. This signaling information is also transmitted so that the services of interest are properly recovered at the receiver side. Details of operations of the Signaling Generation block 1040 will be described later.

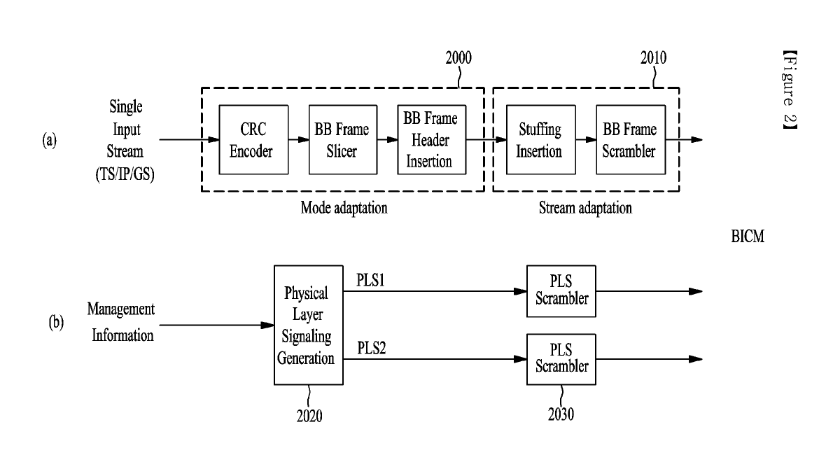

FIGS. 2, 3 and 4 illustrate the input formatting block 1000 according to embodiments of the present invention. A description will be given of each figure.

FIG. 2 illustrates an input formatting block according to one embodiment of the present invention. FIG. 2 shows an input formatting module when the input signal is a single input stream.

The input formatting block illustrated in FIG. 2 corresponds to an embodiment of the input formatting block 1000 described with reference to FIG. 1.

The input to the physical layer may be composed of one or multiple data streams. Each data stream is carried by one DP. The mode adaptation modules slice the incoming data stream into data fields of the baseband frame (BBF). The system supports three types of input data streams: MPEG2-TS, Internet protocol (IP) and Generic stream (GS). MPEG2-TS is characterized by fixed length (188 byte) packets with the first byte being a sync-byte (0x47). An IP stream is composed of variable length IP datagram packets, as signaled within IP packet headers. The system supports both IPv4 and IPv6 for the IP stream. GS may be composed of variable length packets or constant length packets, signaled within encapsulation packet headers.

(a) shows a mode adaptation block 2000 and a stream adaptation 2010 for signal DP and (b) shows a PLS generation block 2020 and a PLS scrambler 2030 for generating and processing PLS data. A description will be given of the operation of each block.

The Input Stream Splitter splits the input TS, IP, GS streams into multiple service or service component (audio, video, etc.) streams. The mode adaptation module 2010 is comprised of a CRC Encoder, BB (baseband) Frame Slicer, and BB Frame Header Insertion block.

The CRC Encoder provides three kinds of CRC encoding for error detection at the user packet (UP) level, i.e., CRC-8, CRC-16, and CRC-32. The computed CRC bytes are appended after the UP. CRC-8 is used for TS stream and CRC-32 for IP stream. If the GS stream doesn't provide the CRC encoding, the proposed CRC encoding should be applied.

BB Frame Slicer maps the input into an internal logical-bit format. The first received bit is defined to be the MSB. The BB Frame Slicer allocates a number of input bits equal to the available data field capacity. To allocate a number of input bits equal to the BBF payload, the UP packet stream is sliced to fit the data field of BBF.

BB Frame Header Insertion block can insert fixed length BBF header of 2 bytes is inserted in front of the BB Frame. The BBF header is composed of STUFFI (1 bit), SYNCD (13 bits), and RFU (2 bits). In addition to the fixed 2-Byte BBF header, BBF can have an extension field (1 or 3 bytes) at the end of the 2-byte BBF header.

The stream adaptation 2010 is comprised of stuffing insertion block and BB scrambler. The stuffing insertion block can insert stuffing field into a payload of a BB frame. If the input data to the stream adaptation is sufficient to fill a BB-Frame, STUFFI is set to ‘0’ and the BBF has no stuffing field. Otherwise STUFFI is set to ‘1’ and the stuffing field is inserted immediately after the BBF header. The stuffing field comprises two bytes of the stuffing field header and a variable size of stuffing data.

The BB scrambler scrambles complete BBF for energy dispersal. The scrambling sequence is synchronous with the BBF. The scrambling sequence is generated by the feed-back shift register.

The PLS generation block 2020 can generate physical layer signaling (PLS) data. The PLS provides the receiver with a means to access physical layer DPs. The PLS data consists of PLS1 data and PLS2 data.

The PLS1 data is a first set of PLS data carried in the FSS symbols in the frame having a fixed size, coding and modulation, which carries basic information about the system as well as the parameters needed to decode the PLS2 data. The PLS1 data provides basic transmission parameters including parameters required to enable the reception and decoding of the PLS2 data. Also, the PLS1 data remains constant for the duration of a frame-group.

The PLS2 data is a second set of PLS data transmitted in the FSS symbol, which carries more detailed PLS data about the system and the DPs. The PLS2 contains parameters that provide sufficient information for the receiver to decode the desired DP. The PLS2 signaling further consists of two types of parameters, PLS2 Static data (PLS2-STAT data) and PLS2 dynamic data (PLS2-DYN data). The PLS2 Static data is PLS2 data that remains static for the duration of a frame-group and the PLS2 dynamic data is PLS2 data that may dynamically change frame-by-frame.

Details of the PLS data will be described later.

The PLS scrambler 2030 can scramble the generated PLS data for energy dispersal.

The above-described blocks may be omitted or replaced by blocks having similar or identical functions.

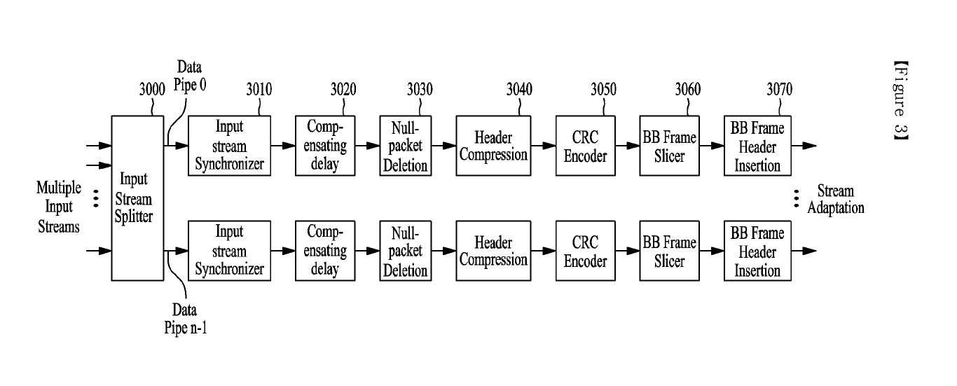

FIG. 3 illustrates an input formatting block according to another embodiment of the present invention.

The input formatting block illustrated in FIG. 3 corresponds to an embodiment of the input formatting block 1000 described with reference to FIG. 1.

FIG. 3 shows a mode adaptation block of the input formatting block when the input signal corresponds to multiple input streams.

The mode adaptation block of the input formatting block for processing the multiple input streams can independently process the multiple input streams.

Referring to FIG. 3, the mode adaptation block for respectively processing the multiple input streams can include an input stream splitter 3000, an input stream synchronizer 3010, a compensating delay block 3020, a null packet deletion block 3030, a head compression block 3040, a CRC encoder 3050, a BB frame slicer 3060 and a BB header insertion block 3070. Description will be given of each block of the mode adaptation block.

Operations of the CRC encoder 3050, BB frame slicer 3060 and BB header insertion block 3070 correspond to those of the CRC encoder, BB frame slicer and BB header insertion block described with reference to FIG. 2 and thus description thereof is omitted.

The input stream splitter 3000 can split the input TS, IP, GS streams into multiple service or service component (audio, video, etc.) streams.

The input stream synchronizer 3010 may be referred as ISSY. The ISSY can provide suitable means to guarantee Constant Bit Rate (CBR) and constant end-to-end transmission delay for any input data format. The ISSY is always used for the case of multiple DPs carrying TS, and optionally used for multiple DPs carrying GS streams.

The compensating delay block 3020 can delay the split TS packet stream following the insertion of ISSY information to allow a TS packet recombining mechanism without requiring additional memory in the receiver.

The null packet deletion block 3030, is used only for the TS input stream case. Some TS input streams or split TS streams may have a large number of null-packets present in order to accommodate VBR (variable bit-rate) services in a CBR TS stream. In this case, in order to avoid unnecessary transmission overhead, null-packets can be identified and not transmitted. In the receiver, removed null-packets can be re-inserted in the exact place where they were originally by reference to a deleted null-packet (DNP) counter that is inserted in the transmission, thus guaranteeing constant bit-rate and avoiding the need for time-stamp (PCR) updating.

The head compression block 3040 can provide packet header compression to increase transmission efficiency for TS or IP input streams. Because the receiver can have a priori information about certain parts of the header, this known information can be deleted in the transmitter.

For Transport Stream, the receiver has a-priori information about the sync-byte configuration (0x47) and the packet length (188 Byte). If the input TS stream carries content that has only one PID, i.e., for only one service component (video, audio, etc.) or service sub-component (SVC base layer, SVC enhancement layer, MVC base view or MVC dependent views), TS packet header compression can be applied (optionally) to the Transport Stream. IP packet header compression is used optionally if the input steam is an IP stream.

The above-described blocks may be omitted or replaced by blocks having similar or identical functions.

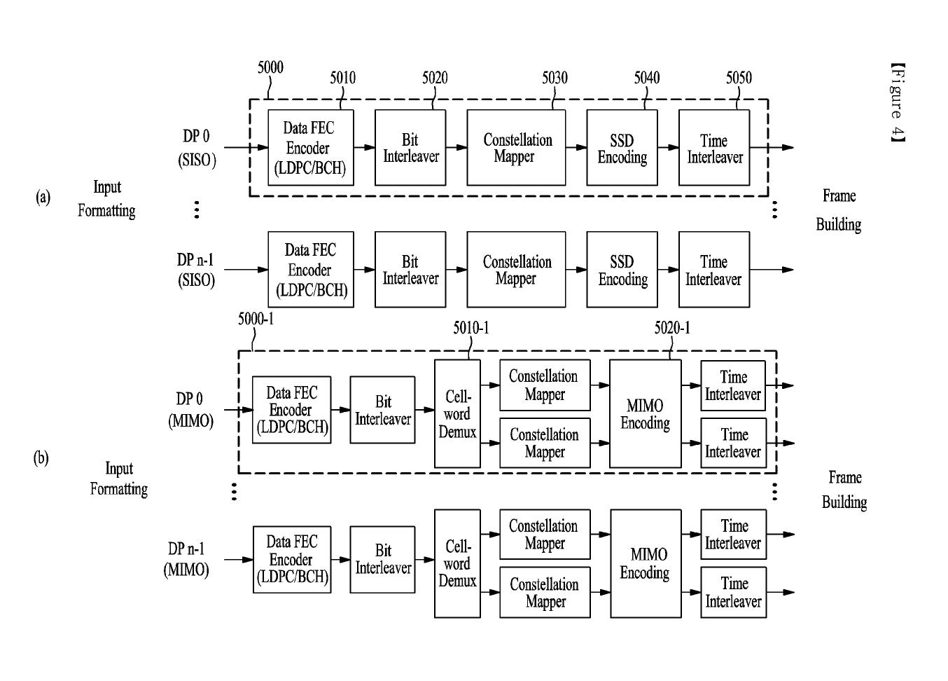

FIG. 4 illustrates a BICM block according to an embodiment of the present invention.

As described above, the apparatus for transmitting broadcast signals for future broadcast services according to an embodiment of the present invention can provide a terrestrial broadcast service, mobile broadcast service, UHDTV service, etc.

Since QoS (quality of service) depends on characteristics of a service provided by the apparatus for transmitting broadcast signals for future broadcast services according to an embodiment of the present invention, data corresponding to respective services needs to be processed through different schemes. Accordingly, the a BICM block according to an embodiment of the present invention can independently process DPs input thereto by independently applying SISO, MISO and MIMO schemes to the data pipes respectively corresponding to data paths. Consequently, the apparatus for transmitting broadcast signals for future broadcast services according to an embodiment of the present invention can control QoS for each service or service component transmitted through each DP.

(a) shows the BICM block shared by the base profile and the handheld profile and (b) shows the BICM block of the advanced profile.

The BICM block shared by the base profile and the handheld profile and the BICM block of the advanced profile can include plural processing blocks for processing each DP.

A description will be given of each processing block of the BICM block for the base profile and the handheld profile and the BICM block for the advanced profile.

A processing block 5000 of the BICM block for the base profile and the handheld profile can include a Data FEC encoder 5010, a bit interleaver 5020, a constellation mapper 5030, an SSD (Signal Space Diversity) encoding block 5040 and a time interleaver 5050.

The Data FEC encoder 5010 can perform the FEC encoding on the input BBF to generate FECBLOCK procedure using outer coding (BCH), and inner coding (LDPC). The outer coding (BCH) is optional coding method. Details of operations of the Data FEC encoder 5010 will be described later.

The bit interleaver 5020 can interleave outputs of the Data FEC encoder 5010 to achieve optimized performance with combination of the LDPC codes and modulation scheme while providing an efficiently implementable structure. Details of operations of the bit interleaver 5020 will be described later.

The constellation mapper 5030 can modulate each cell word from the bit interleaver 5020 in the base and the handheld profiles, or cell word from the Cell-word demultiplexer 5010-1 in the advanced profile using either QPSK, QAM-16, non-uniform QAM (NUQ-64, NUQ-256, NUQ-1024) or non-uniform constellation (NUC-16, NUC-64, NUC-256, NUC-1024) to give a power-normalized constellation point, el. This constellation mapping is applied only for DPs. Observe that QAM-16 and NUQs are square shaped, while NUCs have arbitrary shape. When each constellation is rotated by any multiple of 90 degrees, the rotated constellation exactly overlaps with its original one. This “rotation-sense” symmetric property makes the capacities and the average powers of the real and imaginary components equal to each other. Both NUQs and NUCs are defined specifically for each code rate and the particular one used is signaled by the parameter DP_MOD filed in PLS2 data.

The SSD encoding block 5040 can precode cells in two (2D), three (3D), and four (4D) dimensions to increase the reception robustness under difficult fading conditions.

The time interleaver 5050 can operates at the DP level. The parameters of time interleaving (TI) may be set differently for each DP. Details of operations of the time interleaver 5050 will be described later.

A processing block 5000-1 of the BICM block for the advanced profile can include the Data FEC encoder, bit interleaver, constellation mapper, and time interleaver. However, the processing block 5000-1 is distinguished from the processing block 5000 further includes a cell-word demultiplexer 5010-1 and a MIMO encoding block 5020-1.

Also, the operations of the Data FEC encoder, bit interleaver, constellation mapper, and time interleaver in the processing block 5000-1 correspond to those of the Data FEC encoder 5010, bit interleaver 5020, constellation mapper 5030, and time interleaver 5050 described and thus description thereof is omitted.

The cell-word demultiplexer 5010-1 is used for the DP of the advanced profile to divide the single cell-word stream into dual cell-word streams for MIMO processing. Details of operations of the cell-word demultiplexer 5010-1 will be described later.

The MIMO encoding block 5020-1 can processing the output of the cell-word demultiplexer 5010-1 using MIMO encoding scheme. The MIMO encoding scheme was optimized for broadcasting signal transmission. The MIMO technology is a promising way to get a capacity increase but it depends on channel characteristics. Especially for broadcasting, the strong LOS component of the channel or a difference in the received signal power between two antennas caused by different signal propagation characteristics makes it difficult to get capacity gain from MIMO. The proposed MIMO encoding scheme overcomes this problem using a rotation-based pre-coding and phase randomization of one of the MIMO output signals.

MIMO encoding is intended for a 2×2 MIMO system requiring at least two antennas at both the transmitter and the receiver. Two MIMO encoding modes are defined in this proposal; full-rate spatial multiplexing (FR-SM) and full-rate full-diversity spatial multiplexing (FRFD-SM). The FR-SM encoding provides capacity increase with relatively small complexity increase at the receiver side while the FRFD-SM encoding provides capacity increase and additional diversity gain with a great complexity increase at the receiver side. The proposed MIMO encoding scheme has no restriction on the antenna polarity configuration.

MIMO processing is required for the advanced profile frame, which means all DPs in the advanced profile frame are processed by the MIMO encoder. MIMO processing is applied at DP level. Pairs of the Constellation Mapper outputs NUQ (e1,i and e2,i) are fed to the input of the MIMO Encoder. Paired MIMO Encoder output (g1,i and g2,i) is transmitted by the same carrier k and OFDM symbol l of their respective TX antennas.

The above-described blocks may be omitted or replaced by blocks having similar or identical functions.

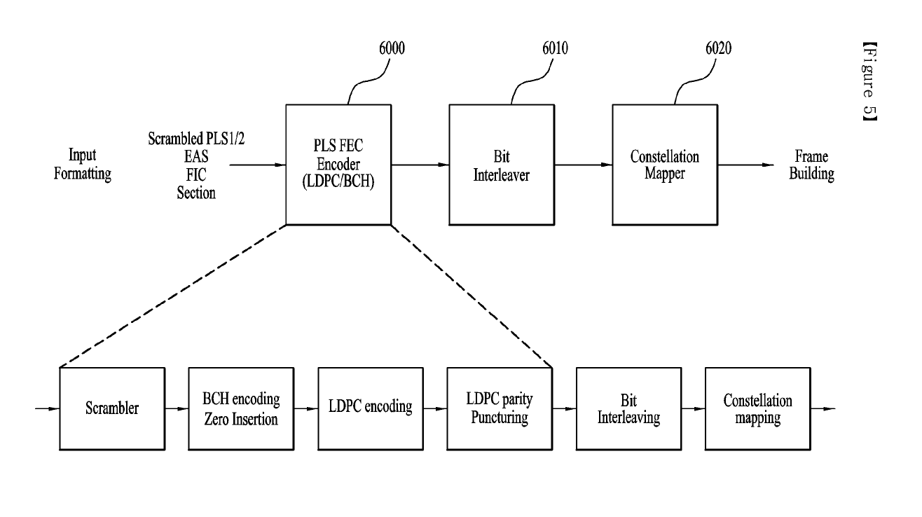

FIG. 5 illustrates a BICM block according to another embodiment of the present invention.

The BICM block illustrated in FIG. 5 corresponds to an embodiment of the BICM block 1010 described with reference to FIG. 1.

FIG. 5 illustrates a BICM block for protection of physical layer signaling (PLS), emergency alert channel (EAC) and fast information channel (FIC). EAC is a part of a frame that carries EAS information data and FIC is a logical channel in a frame that carries the mapping information between a service and the corresponding base DP. Details of the EAC and FIC will be described later.

Referring to FIG. 5, the BICM block for protection of PLS, EAC and FIC can include a PLS FEC encoder 6000, a bit interleaver 6010 and a constellation mapper 6020.

Also, the PLS FEC encoder 6000 can include a scrambler, BCH encoding/zero insertion block, LDPC encoding block and LDPC parity puncturing block. Description will be given of each block of the BICM block.

The PLS FEC encoder 6000 can encode the scrambled PLS 1/2 data, EAC and FIC section.

The scrambler can scramble PLS1 data and PLS2 data before BCH encoding and shortened and punctured LDPC encoding.

The BCH encoding/zero insertion block can perform outer encoding on the scrambled PLS 1/2 data using the shortened BCH code for PLS protection and insert zero bits after the BCH encoding. For PLS1 data only, the output bits of the zero insertion may be permutted before LDPC encoding.

The LDPC encoding block can encode the output of the BCH encoding/zero insertion block using LDPC code. To generate a complete coded block, Cldpc, parity bits, Pldpc are encoded systematically from each zero-inserted PLS information block, Ildpc and appended after it.

C_{ldpc}=[I_{ldpc}P_{ldpc}]=[i₀,i₁, . . . ,i_{K}_{_{ldpc}}₋₁,p₀,p₁, . . . ,p_{N}_{_{ldpc}}_{-K}_{_{ldpc}}₋₁] [Math Figure 1]

The LDPC code parameters for PLS1 and PLS2 are as following table 4.

TABLE 4

| Signaling | | | | K_{ldpc} | | | code | |
|---|---|---|---|---|---|---|---|---|
| Type | K_{sig} | K_{bch} | N_{bch}_{_{—}}_{parity} | (=N_{bch}) | N_{ldpc} | N_{ldpc}_{_{—}}_{parity} | rate | Q_{ldpc} |
| PLS1 | 342 | 1020 | 60 | 1080 | 4320 | 3240 | 1/4 | 36 |
| PLS2 | <1021 | | | | | | | |
| | >1020 | 2100 | | 2160 | 7200 | 5040 | 3/10 | 56 |

The LDPC parity puncturing block can perform puncturing on the PLS1 data and PLS 2 data.

When shortening is applied to the PLS1 data protection, some LDPC parity bits are punctured after LDPC encoding. Also, for the PLS2 data protection, the LDPC parity bits of PLS2 are punctured after LDPC encoding. These punctured bits are not transmitted.

The bit interleaver 6010 can interleave the each shortened and punctured PLS1 data and PLS2 data.

The constellation mapper 6020 can map the bit interleaved PLS1 data and PLS2 data onto constellations.

The above-described blocks may be omitted or replaced by blocks having similar or identical functions.

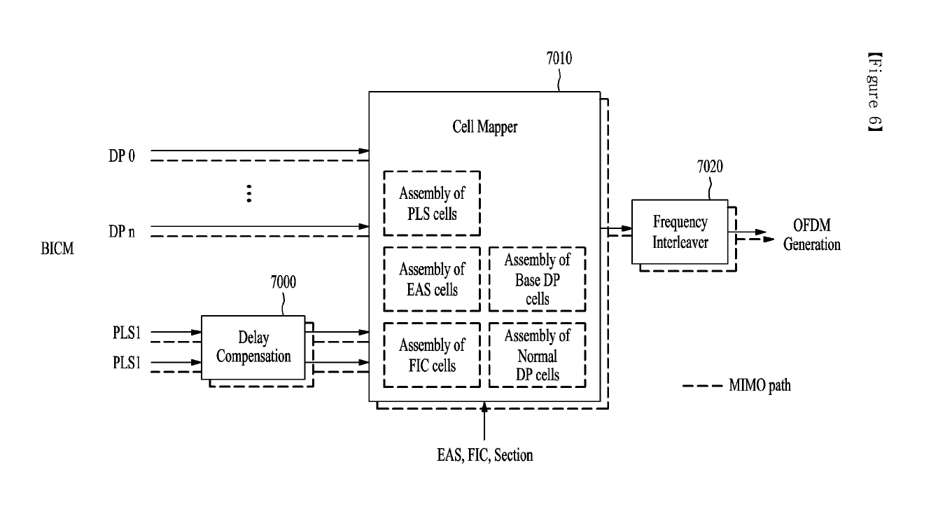

FIG. 6 illustrates a frame building block according to one embodiment of the present invention.

The frame building block illustrated in FIG. 6 corresponds to an embodiment of the frame building block 1020 described with reference to FIG. 1.

Referring to FIG. 6, the frame building block can include a delay compensation block 7000, a cell mapper 7010 and a frequency interleaver 7020. Description will be given of each block of the frame building block.

The delay compensation block 7000 can adjust the timing between the data pipes and the corresponding PLS data to ensure that they are co-timed at the transmitter end. The PLS data is delayed by the same amount as data pipes are by addressing the delays of data pipes caused by the Input Formatting block and BICM block. The delay of the BICM block is mainly due to the time interleaver. In-band signaling data carries information of the next TI group so that they are carried one frame ahead of the DPs to be signaled. The Delay Compensating block delays in-band signaling data accordingly.

The cell mapper 7010 can map PLS, EAC, FIC, DPs, auxiliary streams and dummy cells into the active carriers of the OFDM symbols in the frame. The basic function of the cell mapper 7010 is to map data cells produced by the TIs for each of the DPs, PLS cells, and EAC/FIC cells, if any, into arrays of active OFDM cells corresponding to each of the OFDM symbols within a frame. Service signaling data (such as PSI (program specific information)/SI) can be separately gathered and sent by a data pipe. The Cell Mapper operates according to the dynamic information produced by the scheduler and the configuration of the frame structure. Details of the frame will be described later.

The frequency interleaver 7020 can randomly interleave data cells received from the cell mapper 7010 to provide frequency diversity. Also, the frequency interleaver 7020 can operate on very OFDM symbol pair comprised of two sequential OFDM symbols using a different interleaving-seed order to get maximum interleaving gain in a single frame. Details of operations of the frequency interleaver 7020 will be described later.

The above-described blocks may be omitted or replaced by blocks having similar or identical functions.

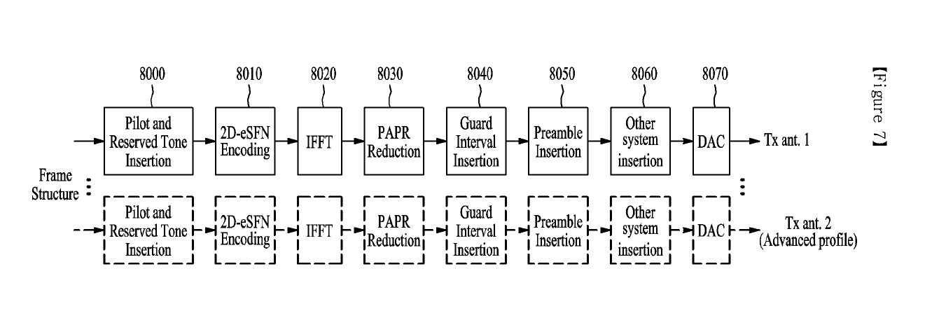

FIG. 7 illustrates an OFMD generation block according to an embodiment of the present invention.

The OFMD generation block illustrated in FIG. 7 corresponds to an embodiment of the OFMD generation block 1030 described with reference to FIG. 1.

The OFDM generation block modulates the OFDM carriers by the cells produced by the Frame Building block, inserts the pilots, and produces the time domain signal for transmission. Also, this block subsequently inserts guard intervals, and applies PAPR (Peak-to-Average Power Radio) reduction processing to produce the final RF signal.

Referring to FIG. 7, the frame building block can include a pilot and reserved tone insertion block 8000, a 2D-eSFN encoding block 8010, an IFFT (Inverse Fast Fourier Transform) block 8020, a PAPR reduction block 8030, a guard interval insertion block 8040, a preamble insertion block 8050, other system insertion block 8060 and a DAC block 8070. Description will be given of each block of the frame building block.

The other system insertion block 8060 can multiplex signals of a plurality of broadcast transmission/reception systems in the time domain such that data of two or more different broadcast transmission/reception systems providing broadcast services can be simultaneously transmitted in the same RF signal bandwidth. In this case, the two or more different broadcast transmission/reception systems refer to systems providing different broadcast services. The different broadcast services may refer to a terrestrial broadcast service, mobile broadcast service, etc.

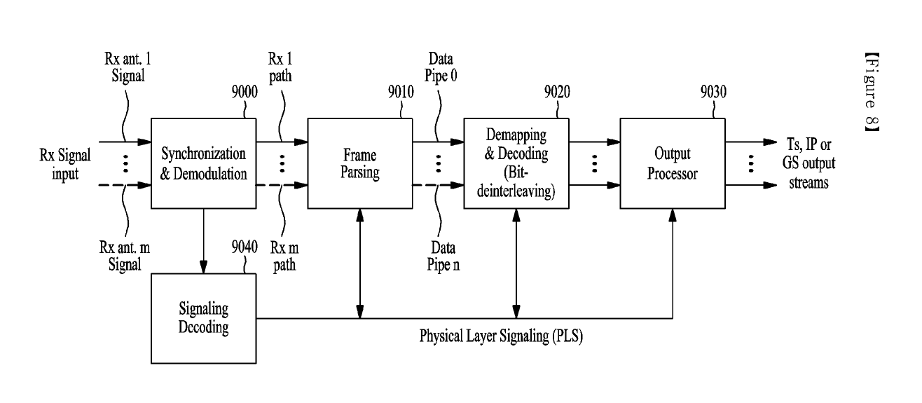

FIG. 8 illustrates a configuration of an apparatus for receiving broadcast signals for future broadcast services according to an embodiment of the present invention.

The apparatus for receiving broadcast signals for future broadcast services according to an embodiment of the present invention can correspond to the apparatus for transmitting broadcast signals for future broadcast services, described with reference to FIG. 1.

The apparatus for receiving broadcast signals for future broadcast services according to an embodiment of the present invention can include a synchronization & demodulation module 9000, a frame parsing module 9010, a demapping & decoding module 9020, an output processor 9030 and a signaling decoding module 9040. A description will be given of operation of each module of the apparatus for receiving broadcast signals.

The synchronization & demodulation module 9000 can receive input signals through m Rx antennas, perform signal detection and synchronization with respect to a system corresponding to the apparatus for receiving broadcast signals and carry out demodulation corresponding to a reverse procedure of the procedure performed by the apparatus for transmitting broadcast signals.

The frame parsing module 9100 can parse input signal frames and extract data through which a service selected by a user is transmitted. If the apparatus for transmitting broadcast signals performs interleaving, the frame parsing module 9100 can carry out deinterleaving corresponding to a reverse procedure of interleaving. In this case, the positions of a signal and data that need to be extracted can be obtained by decoding data output from the signaling decoding module 9400 to restore scheduling information generated by the apparatus for transmitting broadcast signals.

The demapping & decoding module 9020 can convert the input signals into bit domain data and then deinterleave the same as necessary. The demapping & decoding module 9020 can perform demapping for mapping applied for transmission efficiency and correct an error generated on a transmission channel through decoding. In this case, the demapping & decoding module 9020 can obtain transmission parameters necessary for demapping and decoding by decoding the data output from the signaling decoding module 9040.

The output processor 9030 can perform reverse procedures of various compression/signal processing procedures which are applied by the apparatus for transmitting broadcast signals to improve transmission efficiency. In this case, the output processor 9030 can acquire necessary control information from data output from the signaling decoding module 9040. The output of the output processor 8300 corresponds to a signal input to the apparatus for transmitting broadcast signals and may be MPEG-TSs, IP streams (v4 or v6) and generic streams.

The signaling decoding module 9040 can obtain PLS information from the signal demodulated by the synchronization & demodulation module 9000. As described above, the frame parsing module 9010, demapping & decoding module 9020 and output processor 9030 can execute functions thereof using the data output from the signaling decoding module 9040.

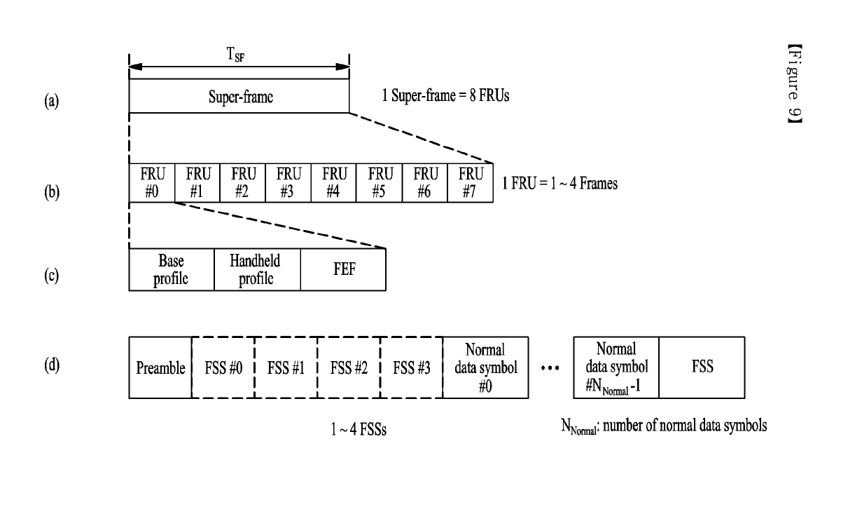

FIG. 9 illustrates a frame structure according to an embodiment of the present invention.

FIG. 9 shows an example configuration of the frame types and FRUs in a super-frame. (a) shows a super frame according to an embodiment of the present invention, (b) shows FRU (Frame Repetition Unit) according to an embodiment of the present invention, (c) shows frames of variable PHY profiles in the FRU and (d) shows a structure of a frame.

A super-frame may be composed of eight FRUs. The FRU is a basic multiplexing unit for TDM of the frames, and is repeated eight times in a super-frame.

Each frame in the FRU belongs to one of the PHY profiles, (base, handheld, advanced) or FEF. The maximum allowed number of the frames in the FRU is four and a given PHY profile can appear any number of times from zero times to four times in the FRU (e.g., base, base, handheld, advanced). PHY profile definitions can be extended using reserved values of the PHY_PROFILE in the preamble, if required.

The FEF part is inserted at the end of the FRU, if included. When the FEF is included in the FRU, the minimum number of FEFs is 8 in a super-frame. It is not recommended that FEF parts be adjacent to each other.

One frame is further divided into a number of OFDM symbols and a preamble. As shown in (d), the frame comprises a preamble, one or more frame signaling symbols (FSS), normal data symbols and a frame edge symbol (FES).

The preamble is a special symbol that enables fast Futurecast UTB system signal detection and provides a set of basic transmission parameters for efficient transmission and reception of the signal. The detailed description of the preamble will be will be described later.

The main purpose of the FSS(s) is to carry the PLS data. For fast synchronization and channel estimation, and hence fast decoding of PLS data, the FSS has more dense pilot pattern than the normal data symbol. The FES has exactly the same pilots as the FSS, which enables frequency-only interpolation within the FES and temporal interpolation, without extrapolation, for symbols immediately preceding the FES.

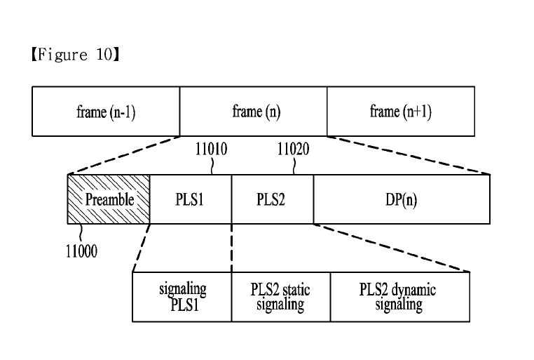

FIG. 10 illustrates a signaling hierarchy structure of the frame according to an embodiment of the present invention.

FIG. 10 illustrates the signaling hierarchy structure, which is split into three main parts: the preamble signaling data 11000, the PLS1 data 11010 and the PLS2 data 11020. The purpose of the preamble, which is carried by the preamble symbol in every frame, is to indicate the transmission type and basic transmission parameters of that frame. The PLS1 enables the receiver to access and decode the PLS2 data, which contains the parameters to access the DP of interest. The PLS2 is carried in every frame and split into two main parts: PLS2-STAT data and PLS2-DYN data. The static and dynamic portion of PLS2 data is followed by padding, if necessary.

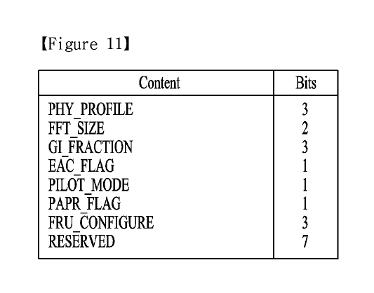

FIG. 11 illustrates preamble signaling data according to an embodiment of the present invention.

Preamble signaling data carries 21 bits of information that are needed to enable the receiver to access PLS data and trace DPs within the frame structure. Details of the preamble signaling data are as follows:

PHY_PROFILE: This 3-bit field indicates the PHY profile type of the current frame. The mapping of different PHY profile types is given in below table 5.

TABLE 5

| Value | PHY Profile |
|---|---|
| 000 | Base profile |
| 001 | Handheld profile |
| 010 | Advanced profiled |
| 011~110 | Reserved |
| 111 | FEF |

FFT_SIZE: This 2 bit field indicates the FFT size of the current frame within a frame-group, as described in below table 6.

TABLE 6

| Value | FFT size |
|---|---|
| 00 | 8K FFT |
| 01 | 16K FFT |
| 10 | 32K FFT |
| 11 | Reserved |

GI_FRACTION: This 3 bit field indicates the guard interval fraction value in the current super-frame, as described in below table 7.

TABLE 7

| Value | GI_FRACTION |
|---|---|
| 000 | ⅕ |
| 001 | 1/10 |
| 010 | 1/20 |
| 011 | 1/40 |
| 100 | 1/80 |
| 101 | 1/160 |
| 110~111 | Reserved |

EAC_FLAG: This 1 bit field indicates whether the EAC is provided in the current frame. If this field is set to ‘1’, emergency alert service (EAS) is provided in the current frame. If this field set to ‘0’, EAS is not carried in the current frame. This field can be switched dynamically within a super-frame.

PILOT_MODE: This 1-bit field indicates whether the pilot mode is mobile mode or fixed mode for the current frame in the current frame-group. If this field is set to ‘0’, mobile pilot mode is used. If the field is set to ‘1’, the fixed pilot mode is used.

PAPR_FLAG: This 1-bit field indicates whether PAPR reduction is used for the current frame in the current frame-group. If this field is set to value ‘1’, tone reservation is used for PAPR reduction. If this field is set to ‘0’, PAPR reduction is not used.

FRU_CONFIGURE: This 3-bit field indicates the PHY profile type configurations of the frame repetition units (FRU) that are present in the current super-frame. All profile types conveyed in the current super-frame are identified in this field in all preambles in the current super-frame. The 3-bit field has a different definition for each profile, as show in below table 8.

TABLE 8

| | | Current | Current | |
|---|---|---|---|---|
| | Current | PHY_PROFILE = | PHY_PROFILE = | Current |
| | PHY_PROFILE = | ‘001’ | ‘010’ | PHY_PROFILE = |
| | ‘000’ (base) | (handheld) | (advanced) | ‘111’ (FEF) |
| FRU_CONFIGURE = | Only base | Only handheld | Only advanced | Only FEF |
| 000 | profile present | profile present | profile present | present |
| FRU_CONFIGURE = | Handheld | Base profile | Base profile | Base profile |
| 1XX | profile present | present | present | present |
| FRU_CONFIGURE = | Advanced | Advanced | Handheld | Handheld |
| X1X | profile present | profile present | profile present | profile present |
| FRU_CONFIGURE = | FEF present | FEF present | FEF present | Advanced |
| XX1 | | | | profile present |

RESERVED: This 7-bit field is reserved for future use.

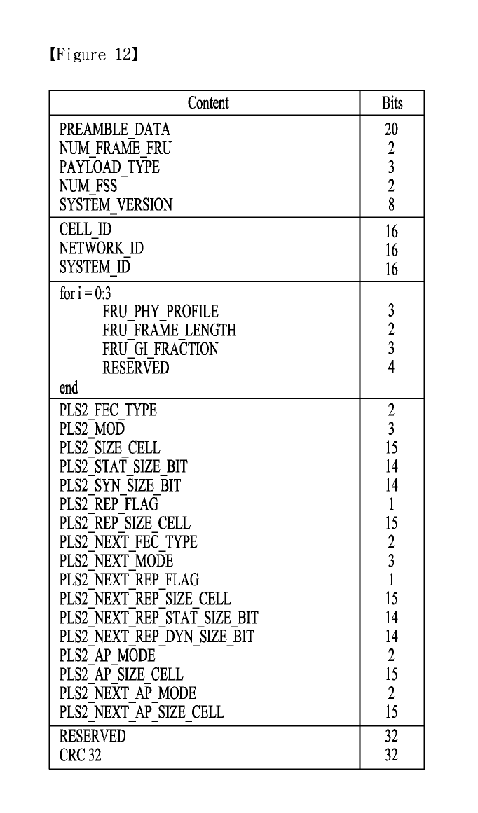

FIG. 12 illustrates PLS1 data according to an embodiment of the present invention.

PLS1 data provides basic transmission parameters including parameters required to enable the reception and decoding of the PLS2. As above mentioned, the PLS1 data remain unchanged for the entire duration of one frame-group. The detailed definition of the signaling fields of the PLS1 data are as follows:

PREAMBLE_DATA: This 20-bit field is a copy of the preamble signaling data excluding the EAC_FLAG.

NUM_FRAME_FRU: This 2-bit field indicates the number of the frames per FRU.

PAYLOAD_TYPE: This 3-bit field indicates the format of the payload data carried in the frame-group. PAYLOAD_TYPE is signaled as shown in table 9.

TABLE 9

| value | Payload type |
|---|---|
| 1XX | TS stream is transmitted |
| X1X | IP stream is transmitted |
| XX1 | GS stream is transmitted |

NUM_FSS: This 2-bit field indicates the number of FSS symbols in the current frame.

SYSTEM_VERSION: This 8-bit field indicates the version of the transmitted signal format. The SYSTEM_VERSION is divided into two 4-bit fields, which are a major version and a minor version.

Major version: The MSB four bits of SYSTEM_VERSION field indicate major version information. A change in the major version field indicates a non-backward-compatible change. The default value is ‘0000’. For the version described in this standard, the value is set to ‘0000’.

Minor version: The LSB four bits of SYSTEM_VERSION field indicate minor version information. A change in the minor version field is backward-compatible.

CELL_ID: This is a 16-bit field which uniquely identifies a geographic cell in an ATSC network. An ATSC cell coverage area may consist of one or more frequencies, depending on the number of frequencies used per Futurecast UTB system. If the value of the CELL_ID is not known or unspecified, this field is set to ‘0’.

NETWORK_ID: This is a 16-bit field which uniquely identifies the current ATSC network.

SYSTEM_ID: This 16-bit field uniquely identifies the Futurecast UTB system within the ATSC network. The Futurecast UTB system is the terrestrial broadcast system whose input is one or more input streams (TS, IP, GS) and whose output is an RF signal. The Futurecast UTB system carries one or more PHY profiles and FEF, if any. The same Futurecast UTB system may carry different input streams and use different RF frequencies in different geographical areas, allowing local service insertion. The frame structure and scheduling is controlled in one place and is identical for all transmissions within a Futurecast UTB system. One or more Futurecast UTB systems may have the same SYSTEM_ID meaning that they all have the same physical layer structure and configuration.

The following loop consists of FRU_PHY_PROFILE, FRU_FRAME_LENGTH, FRU_GI_FRACTION, and RESERVED which are used to indicate the FRU configuration and the length of each frame type. The loop size is fixed so that four PHY profiles (including a FEF) are signaled within the FRU. If NUM_FRAME_FRU is less than 4, the unused fields are filled with zeros.

FRU_PHY_PROFILE: This 3-bit field indicates the PHY profile type of the (i+1)^{th} (i is the loop index) frame of the associated FRU. This field uses the same signaling format as shown in the table 8.

FRU_FRAME_LENGTH: This 2-bit field indicates the length of the (i+1)^{th} frame of the associated FRU. Using FRU_FRAME_LENGTH together with FRU_GI_FRACTION, the exact value of the frame duration can be obtained.

FRU_GI_FRACTION: This 3-bit field indicates the guard interval fraction value of the (i+1)^{th} frame of the associated FRU. FRU_GI_FRACTION is signaled according to the table 7.

RESERVED: This 4-bit field is reserved for future use.

The following fields provide parameters for decoding the PLS2 data.

PLS2_FEC_TYPE: This 2-bit field indicates the FEC type used by the PLS2 protection. The FEC type is signaled according to table 10. The details of the LDPC codes will be described later.

TABLE 10

| Content | PLS2 FEC type |
|---|---|
| 00 | 4K-1/4 and 7K-3/10 LDPC codes |
| 01~11 | Reserved |

PLS2_MOD: This 3-bit field indicates the modulation type used by the PLS2. The modulation type is signaled according to table 11.

TABLE 11

| Value | PLS2_MODE |
|---|---|
| 000 | BPSK |
| 001 | QPSK |
| 010 | QAM-16 |
| 011 | NUQ-64 |
| 100~111 | Reserved |

PLS2_SIZE_CELL: This 15-bit field indicates Cₜₒₜₐₗ_{_}ₚₐᵣₜᵢₐₗ_{_}_{block}, the size (specified as the number of QAM cells) of the collection of full coded blocks for PLS2 that is carried in the current frame-group. This value is constant during the entire duration of the current frame-group.

PLS2_STAT_SIZE_BIT: This 14-bit field indicates the size, in bits, of the PLS2-STAT for the current frame-group. This value is constant during the entire duration of the current frame-group.

PLS2_DYN_SIZE_BIT: This 14-bit field indicates the size, in bits, of the PLS2-DYN for the current frame-group. This value is constant during the entire duration of the current frame-group.

PLS2_REP_FLAG: This 1-bit flag indicates whether the PLS2 repetition mode is used in the current frame-group. When this field is set to value ‘1’, the PLS2 repetition mode is activated. When this field is set to value ‘0’, the PLS2 repetition mode is deactivated.

PLS2_REP_SIZE_CELL: This 15-bit field indicates Cₜₒₜₐₗ_{_}ₚₐᵣₜᵢₐₗ_{_}_{block}, the size (specified as the number of QAM cells) of the collection of partial coded blocks for PLS2 carried in every frame of the current frame-group, when PLS2 repetition is used. If repetition is not used, the value of this field is equal to 0. This value is constant during the entire duration of the current frame-group.

PLS2_NEXT_FEC_TYPE: This 2-bit field indicates the FEC type used for PLS2 that is carried in every frame of the next frame-group. The FEC type is signaled according to the table 10.

PLS2_NEXT_MOD: This 3-bit field indicates the modulation type used for PLS2 that is carried in every frame of the next frame-group. The modulation type is signaled according to the table 11.

PLS2_NEXT_REP_FLAG: This 1-bit flag indicates whether the PLS2 repetition mode is used in the next frame-group. When this field is set to value ‘1’, the PLS2 repetition mode is activated. When this field is set to value ‘0’, the PLS2 repetition mode is deactivated.

PLS2_NEXT_REP_SIZE_CELL: This 15-bit field indicates Cₜₒₜₐₗ_{_}_{full}_{_}_{block}, The size (specified as the number of QAM cells) of the collection of full coded blocks for PLS2 that is carried in every frame of the next frame-group, when PLS2 repetition is used. If repetition is not used in the next frame-group, the value of this field is equal to 0. This value is constant during the entire duration of the current frame-group.

PLS2_NEXT_REP_STAT_SIZE_BIT: This 14-bit field indicates the size, in bits, of the PLS2-STAT for the next frame-group. This value is constant in the current frame-group.

PLS2_NEXT_REP_DYN_SIZE_BIT: This 14-bit field indicates the size, in bits, of the PLS2-DYN for the next frame-group. This value is constant in the current frame-group.

PLS2_AP_MODE: This 2-bit field indicates whether additional parity is provided for PLS2 in the current frame-group. This value is constant during the entire duration of the current frame-group. The below table 12 gives the values of this field. When this field is set to ‘00’, additional parity is not used for the PLS2 in the current frame-group.

TABLE 12

| Value | PLS2-AP mode |
|---|---|
| 00 | AP is not provided |
| 01 | AP1 mode |
| 10~11 | Reserved |

PLS2_AP_SIZE_CELL: This 15-bit field indicates the size (specified as the number of QAM cells) of the additional parity bits of the PLS2. This value is constant during the entire duration of the current frame-group.

PLS2_NEXT_AP_MODE: This 2-bit field indicates whether additional parity is provided for PLS2 signaling in every frame of next frame-group. This value is constant during the entire duration of the current frame-group. The table 12 defines the values of this field

PLS2_NEXT_AP_SIZE_CELL: This 15-bit field indicates the size (specified as the number of QAM cells) of the additional parity bits of the PLS2 in every frame of the next frame-group. This value is constant during the entire duration of the current frame-group.

RESERVED: This 32-bit field is reserved for future use.

CRC_32: A 32-bit error detection code, which is applied to the entire PLS1 signaling.

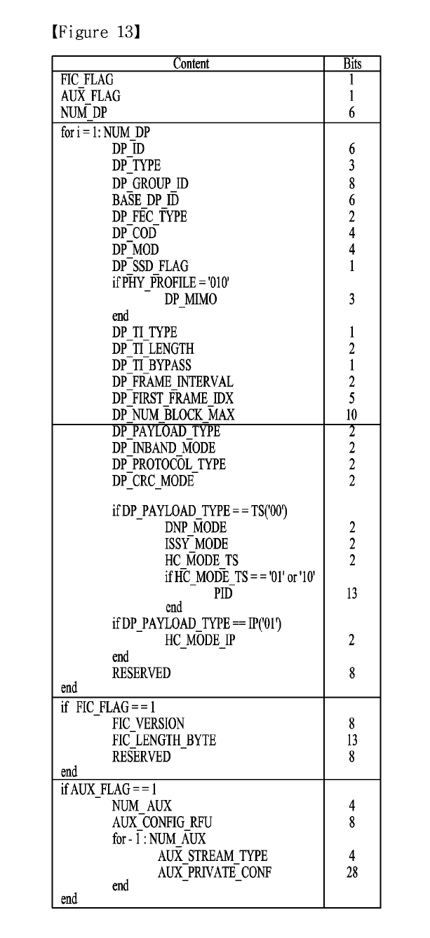

FIG. 13 illustrates PLS2 data according to an embodiment of the present invention.

FIG. 13 illustrates PLS2-STAT data of the PLS2 data. The PLS2-STAT data are the same within a frame-group, while the PLS2-DYN data provide information that is specific for the current frame.

The details of fields of the PLS2-STAT data are as follows:

FIC_FLAG: This 1-bit field indicates whether the FIC is used in the current frame-group. If this field is set to ‘1’, the FIC is provided in the current frame. If this field set to ‘0’, the FIC is not carried in the current frame. This value is constant during the entire duration of the current frame-group.

AUX_FLAG: This 1-bit field indicates whether the auxiliary stream(s) is used in the current frame-group. If this field is set to ‘1’, the auxiliary stream is provided in the current frame. If this field set to ‘0’, the auxiliary stream is not carried in the current frame. This value is constant during the entire duration of current frame-group.

NUM_DP: This 6-bit field indicates the number of DPs carried within the current frame. The value of this field ranges from 1 to 64, and the number of DPs is NUM_DP+1.

DP_ID: This 6-bit field identifies uniquely a DP within a PHY profile.

DP_TYPE: This 3-bit field indicates the type of the DP. This is signaled according to the below table 13.

TABLE 13

| Value | DP Type |
|---|---|
| 000 | DP Type 1 |
| 001 | DP Type 2 |
| 010~111 | reserved |

DP_GROUP_ID: This 8-bit field identifies the DP group with which the current DP is associated. This can be used by a receiver to access the DPs of the service components associated with a particular service, which will have the same DP_GROUP_ID.

BASE_DP_ID: This 6-bit field indicates the DP carrying service signaling data (such as PSI/SI) used in the Management layer. The DP indicated by BASE_DP_ID may be either a normal DP carrying the service signaling data along with the service data or a dedicated DP carrying only the service signaling data.

DP_FEC_TYPE: This 2-bit field indicates the FEC type used by the associated DP. The FEC type is signaled according to the below table 14.

TABLE 14

| Value | FEC_TYPE |
|---|---|
| 00 | 16K LDPC |
| 01 | 64K LDPC |
| 10~11 | Reserved |

DP_COD: This 4-bit field indicates the code rate used by the associated DP. The code rate is signaled according to the below table 15.

TABLE 15

| Value | Code rate |
|---|---|
| 0000 | 5/15 |
| 0001 | 6/15 |
| 0010 | 7/15 |
| 0011 | 8/15 |
| 0100 | 9/15 |
| 0101 | 10/15 |
| 0110 | 11/15 |
| 0111 | 12/15 |
| 1000 | 13/15 |
| 1001~1111 | Reserved |

DP_MOD: This 4-bit field indicates the modulation used by the associated DP. The modulation is signaled according to the below table 16.

TABLE 16

| Value | Modulation |
|---|---|
| 0000 | QPSK |
| 0001 | QAM-16 |
| 0010 | NUQ-64 |
| 0011 | NUQ-256 |
| 0100 | NUQ-1024 |
| 0101 | NUC-16 |
| 0110 | NUC-64 |
| 0111 | NUC-256 |
| 1000 | NUC-1024 |
| 1001~1111 | reserved |

DP_SSD_FLAG: This 1-bit field indicates whether the SSD mode is used in the associated DP. If this field is set to value ‘1’, SSD is used. If this field is set to value ‘0’, SSD is not used.

The following field appears only if PHY_PROFILE is equal to ‘010’, which indicates the advanced profile:

DP_MIMO: This 3-bit field indicates which type of MIMO encoding process is applied to the associated DP. The type of MIMO encoding process is signaled according to the table 17.

TABLE 17

| Value | MIMO encoding |
|---|---|
| 0000 | FR-SM |
| 0001 | FRFD-SM |
| 010~111 | reserved |

DP_TI_TYPE: This 1-bit field indicates the type of time-interleaving. A value of ‘0’ indicates that one TI group corresponds to one frame and contains one or more TI-blocks. A value of ‘1’ indicates that one TI group is carried in more than one frame and contains only one TI-block.

DP_TI_LENGTH: The use of this 2-bit field (the allowed values are only 1, 2, 4, 8) is determined by the values set within the DP_TI_TYPE field as follows:

If the DP_TI_TYPE is set to the value ‘1’, this field indicates P_{I}, the number of the frames to which each TI group is mapped, and there is one TI-block per TI group (N_{TI}=1). The allowed P_{I} values with 2-bit field are defined in the below table 18.

If the DP_TI_TYPE is set to the value ‘0’, this field indicates the number of TI-blocks N_{TI} per TI group, and there is one TI group per frame (P_{I}=1). The allowed P_{I} values with 2-bit field are defined in the below table 18.

TABLE 18

| 2-bit field | P_{I} | N_{TI} |
|---|---|---|
| 00 | 1 | 1 |
| 01 | 2 | 2 |
| 10 | 4 | 3 |
| 11 | 8 | 4 |

DP_FRAME_INTERVAL: This 2-bit field indicates the frame interval (I_{JUMP}) within the frame-group for the associated DP and the allowed values are 1, 2, 4, 8 (the corresponding 2-bit field is ‘00’, ‘01’, ‘10’, or ‘11’, respectively). For DPs that do not appear every frame of the frame-group, the value of this field is equal to the interval between successive frames. For example, if a DP appears on the frames 1, 5, 9, 13, etc., this field is set to ‘4’. For DPs that appear in every frame, this field is set to ‘1’.

DP_TI_BYPASS: This 1-bit field determines the availability of time interleaver. If time interleaving is not used for a DP, it is set to ‘1’. Whereas if time interleaving is used it is set to ‘0’.

DP_FIRST_FRAME_IDX: This 5-bit field indicates the index of the first frame of the super-frame in which the current DP occurs. The value of DP_FIRST_FRAME_IDX ranges from 0 to 31

DP_NUM_BLOCK_MAX: This 10-bit field indicates the maximum value of DP_NUM_BLOCKS for this DP. The value of this field has the same range as DP_NUM_BLOCKS.

DP_PAYLOAD_TYPE: This 2-bit field indicates the type of the payload data carried by the given DP. DP_PAYLOAD_TYPE is signaled according to the below table 19.

TABLE 19

| Value | Payload Type |
|---|---|
| 00 | TS. |
| 01 | IP |
| 10 | GS |
| 11 | reserved |

DP_INBAND_MODE: This 2-bit field indicates whether the current DP carries in-band signaling information. The in-band signaling type is signaled according to the below table 20.

TABLE 20

| Value | In-band mode |
|---|---|
| 00 | In-band signaling is not carried. |
| 01 | INBAND-PLS is carried only |
| 10 | INBAND-ISSY is carried only |
| 11 | INBAND-PLS and INBAND-ISSY are carried |

DP_PROTOCOL_TYPE: This 2-bit field indicates the protocol type of the payload carried by the given DP. It is signaled according to the below table 21 when input payload types are selected.

TABLE 21

| | If DP_PAYLOAD_TYPE | If DP_PAYLOAD_TYPE | If DP_PAYLOAD_TYPE |
|---|---|---|---|
| Value | Is TS | Is IP | Is GS |
| 00 | MPEG2-TS | IPv4 | (Note) |
| 01 | Reserved | IPv6 | Reserved |
| 10 | Reserved | Reserved | Reserved |
| 11 | Reserved | Reserved | Reserved |

DP_CRC_MODE: This 2-bit field indicates whether CRC encoding is used in the Input Formatting block. The CRC mode is signaled according to the below table 22.

TABLE 22

| Value | CRC mode |
|---|---|
| 00 | Not used |
| 01 | CRC-8 |
| 10 | CRC-16 |
| 11 | CRC-32 |

DNP_MODE: This 2-bit field indicates the null-packet deletion mode used by the associated DP when DP_PAYLOAD_TYPE is set to TS (‘00’). DNP_MODE is signaled according to the below table 23. If DP_PAYLOAD_TYPE is not TS (‘00’), DNP_MODE is set to the value ‘00’.

TABLE 23

| Value | Null-packet deletion mode |
|---|---|
| 00 | Not used |
| 01 | DNP-NORMAL |
| 10 | DNP-OFFSET |
| 11 | reserved |

ISSY_MODE: This 2-bit field indicates the ISSY mode used by the associated DP when DP_PAYLOAD_TYPE is set to TS (‘00’). The ISSY_MODE is signaled according to the below table 24 If DP_PAYLOAD_TYPE is not TS (‘00’), ISSY_MODE is set to the value ‘00’.

TABLE 24

| Value | ISSY mode |
|---|---|
| 00 | Not used |
| 01 | ISSY-UP |
| 10 | ISSY-BBF |
| 11 | reserved |

HC_MODE_TS: This 2-bit field indicates the TS header compression mode used by the associated DP when DP_PAYLOAD_TYPE is set to TS (‘00’). The HC_MODE_TS is signaled according to the below table 25.

TABLE 25

| Value | Header compression mode |
|---|---|
| 00 | HC_MODE_TS 1 |
| 01 | HC_MODE_TS 2 |
| 10 | HC_MODE_TS 3 |
| 11 | HC_MODE_TS 4 |

HC_MODE_IP: This 2-bit field indicates the IP header compression mode when DP_PAYLOAD_TYPE is set to IP (‘01’). The HC_MODE_IP is signaled according to the below table 26.

TABLE 26

| Value | Header compression mode |
|---|---|
| 00 | No compression |
| 01 | HC_MODE_IP 1 |
| 10~11 | reserved |

PID: This 13-bit field indicates the PID number for TS header compression when DP_PAYLOAD_TYPE is set to TS (‘00’) and HC_MODE_TS is set to ‘01’ or ‘10’.

RESERVED: This 8-bit field is reserved for future use.

The following field appears only if FIC_FLAG is equal to ‘1’:

FIC_VERSION: This 8-bit field indicates the version number of the FIC.

FIC_LENGTH_BYTE: This 13-bit field indicates the length, in bytes, of the FIC.

RESERVED: This 8-bit field is reserved for future use.

The following field appears only if AUX_FLAG is equal to ‘1’:

NUM_AUX: This 4-bit field indicates the number of auxiliary streams. Zero means no auxiliary streams are used.

AUX_CONFIG_RFU: This 8-bit field is reserved for future use.

AUX_STREAM_TYPE: This 4-bit is reserved for future use for indicating the type of the current auxiliary stream.

AUX_PRIVATE_CONFIG: This 28-bit field is reserved for future use for signaling auxiliary streams.

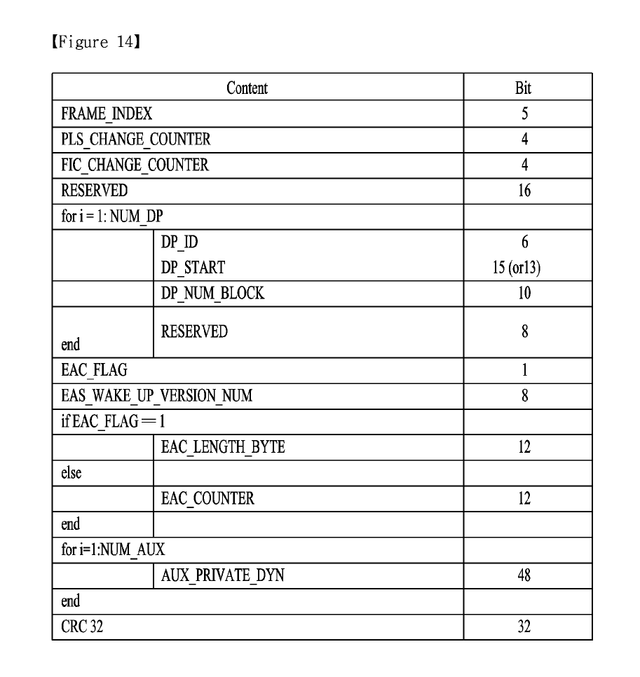

FIG. 14 illustrates PLS2 data according to another embodiment of the present invention.

FIG. 14 illustrates PLS2-DYN data of the PLS2 data. The values of the PLS2-DYN data may change during the duration of one frame-group, while the size of fields remains constant.

The details of fields of the PLS2-DYN data are as follows:

FRAME_INDEX: This 5-bit field indicates the frame index of the current frame within the super-frame. The index of the first frame of the super-frame is set to ‘0’.

PLS_CHANGE_COUNTER: This 4-bit field indicates the number of super-frames ahead where the configuration will change. The next super-frame with changes in the configuration is indicated by the value signaled within this field. If this field is set to the value ‘0000’, it means that no scheduled change is foreseen: e.g., value ‘1’ indicates that there is a change in the next super-frame.

FIC_CHANGE_COUNTER: This 4-bit field indicates the number of super-frames ahead where the configuration (i.e., the contents of the FIC) will change. The next super-frame with changes in the configuration is indicated by the value signaled within this field. If this field is set to the value ‘0000’, it means that no scheduled change is foreseen: e.g. value ‘0001’ indicates that there is a change in the next super-frame.

RESERVED: This 16-bit field is reserved for future use.

The following fields appear in the loop over NUM_DP, which describe the parameters associated with the DP carried in the current frame.

DP_ID: This 6-bit field indicates uniquely the DP within a PHY profile.

DP_START: This 15-bit (or 13-bit) field indicates the start position of the first of the DPs using the DPU addressing scheme. The DP_START field has differing length according to the PHY profile and FFT size as shown in the below table 27.

TABLE 27

DP_START field size

| PHY profile | 64K | 16K |
|---|---|---|
| Base | 13 bit | 15 bit |
| Handheld | — | 13 bit |
| Advanced | 13 bit | 15 bit |

DP_NUM_BLOCK: This 10-bit field indicates the number of FEC blocks in the current TI group for the current DP. The value of DP_NUM_BLOCK ranges from 0 to 1023

RESERVED: This 8-bit field is reserved for future use.

The following fields indicate the FIC parameters associated with the EAC.

EAC_FLAG: This 1-bit field indicates the existence of the EAC in the current frame. This bit is the same value as the EAC_FLAG in the preamble.

EAS_WAKE_UP_VERSION_NUM: This 8-bit field indicates the version number of a wake-up indication.

If the EAC_FLAG field is equal to ‘1’, the following 12 bits are allocated for EAC_LENGTH_BYTE field. If the EAC_FLAG field is equal to ‘0’, the following 12 bits are allocated for EAC_COUNTER.

EAC_LENGTH_BYTE: This 12-bit field indicates the length, in byte, of the EAC.

EAC_COUNTER: This 12-bit field indicates the number of the frames before the frame where the EAC arrives.

The following field appears only if the AUX_FLAG field is equal to ‘1’:

AUX_PRIVATE_DYN: This 48-bit field is reserved for future use for signaling auxiliary streams. The meaning of this field depends on the value of AUX_STREAM_TYPE in the configurable PLS2-STAT.

CRC_32: A 32-bit error detection code, which is applied to the entire PLS2.

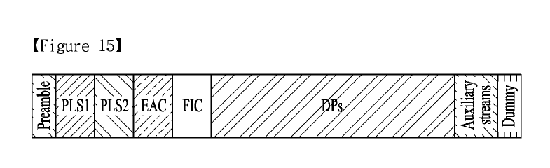

FIG. 15 illustrates a logical structure of a frame according to an embodiment of the present invention.

As above mentioned, the PLS, EAC, FIC, DPs, auxiliary streams and dummy cells are mapped into the active carriers of the OFDM symbols in the frame. The PLS1 and PLS2 are first mapped into one or more FSS(s). After that, EAC cells, if any, are mapped immediately following the PLS field, followed next by FIC cells, if any. The DPs are mapped next after the PLS or EAC, FIC, if any. Type 1 DPs follows first, and Type 2 DPs next. The details of a type of the DP will be described later. In some case, DPs may carry some special data for EAS or service signaling data. The auxiliary stream or streams, if any, follow the DPs, which in turn are followed by dummy cells. Mapping them all together in the above mentioned order, i.e. PLS, EAC, FIC, DPs, auxiliary streams and dummy data cells exactly fill the cell capacity in the frame.

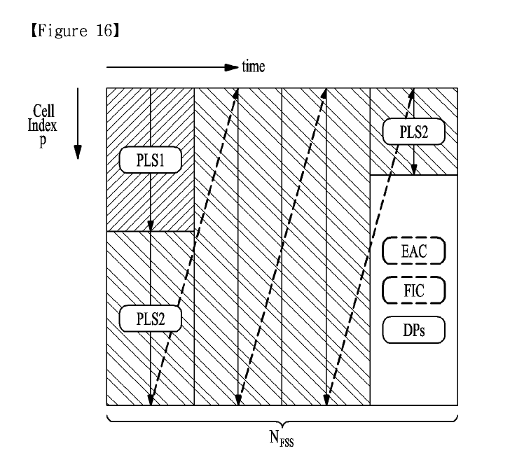

FIG. 16 illustrates PLS mapping according to an embodiment of the present invention.

PLS cells are mapped to the active carriers of FSS(s). Depending on the number of cells occupied by PLS, one or more symbols are designated as FSS(s), and the number of FSS(s) N_{FSS} is signaled by NUM_FSS in PLS1. The FSS is a special symbol for carrying PLS cells. Since robustness and latency are critical issues in the PLS, the FSS(s) has higher density of pilots allowing fast synchronization and frequency-only interpolation within the FSS.

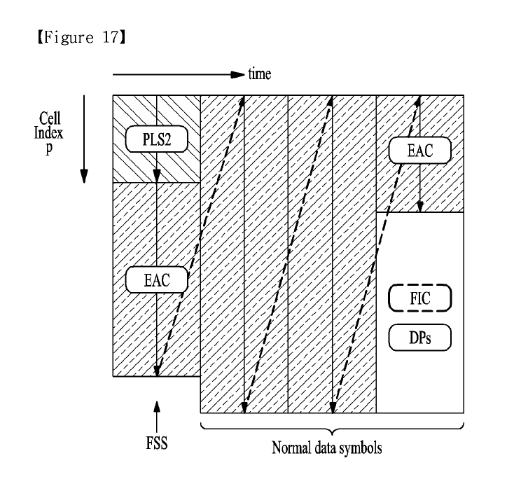

PLS cells are mapped to active carriers of the N_{FSS} FSS(s) in a top-down manner as shown in an example in FIG. 17. The PLS1 cells are mapped first from the first cell of the first FSS in an increasing order of the cell index. The PLS2 cells follow immediately after the last cell of the PLS1 and mapping continues downward until the last cell index of the first FSS. If the total number of required PLS cells exceeds the number of active carriers of one FSS, mapping proceeds to the next FSS and continues in exactly the same manner as the first FSS.

After PLS mapping is completed, DPs are carried next. If EAC, FIC or both are present in the current frame, they are placed between PLS and “normal” DPs.

FIG. 17 illustrates EAC mapping according to an embodiment of the present invention.

EAC is a dedicated channel for carrying EAS messages and links to the DPs for EAS. EAS support is provided but EAC itself may or may not be present in every frame. EAC, if any, is mapped immediately after the PLS2 cells. EAC is not preceded by any of the FIC, DPs, auxiliary streams or dummy cells other than the PLS cells. The procedure of mapping the EAC cells is exactly the same as that of the PLS.

The EAC cells are mapped from the next cell of the PLS2 in increasing order of the cell index as shown in the example in FIG. 17. Depending on the EAS message size, EAC cells may occupy a few symbols, as shown in FIG. 17.

EAC cells follow immediately after the last cell of the PLS2, and mapping continues downward until the last cell index of the last FSS. If the total number of required EAC cells exceeds the number of remaining active carriers of the last FSS mapping proceeds to the next symbol and continues in exactly the same manner as FSS(s). The next symbol for mapping in this case is the normal data symbol, which has more active carriers than a FSS.

After EAC mapping is completed, the FIC is carried next, if any exists. If FIC is not transmitted (as signaled in the PLS2 field), DPs follow immediately after the last cell of the EAC.

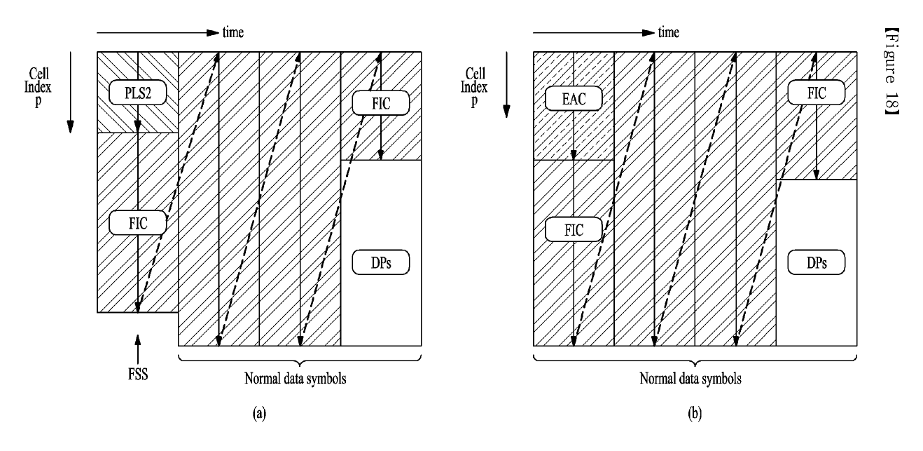

FIG. 18 illustrates FIC mapping according to an embodiment of the present invention.

(a) shows an example mapping of FIC cell without EAC and (b) shows an example mapping of FIC cell with EAC.

FIC is a dedicated channel for carrying cross-layer information to enable fast service acquisition and channel scanning. This information primarily includes channel binding information between DPs and the services of each broadcaster. For fast scan, a receiver can decode FIC and obtain information such as broadcaster ID, number of services, and BASE_DP_ID. For fast service acquisition, in addition to FIC, base DP can be decoded using BASE_DP_ID. Other than the content it carries, a base DP is encoded and mapped to a frame in exactly the same way as a normal DP. Therefore, no additional description is required for a base DP. The FIC data is generated and consumed in the Management Layer. The content of FIC data is as described in the Management Layer specification.

The FIC data is optional and the use of FIC is signaled by the FIC_FLAG parameter in the static part of the PLS2. If FIC is used, FIC_FLAG is set to ‘1’ and the signaling field for FIC is defined in the static part of PLS2. Signaled in this field are FIC_VERSION, and FIC_LENGTH_BYTE. FIC uses the same modulation, coding and time interleaving parameters as PLS2. FIC shares the same signaling parameters such as PLS2_MOD and PLS2_FEC. FIC data, if any, is mapped immediately after PLS2 or EAC if any. FIC is not preceded by any normal DPs, auxiliary streams or dummy cells. The method of mapping FIC cells is exactly the same as that of EAC which is again the same as PLS.

Without EAC after PLS, FIC cells are mapped from the next cell of the PLS2 in an increasing order of the cell index as shown in an example in (a). Depending on the FIC data size, FIC cells may be mapped over a few symbols, as shown in (b).

FIC cells follow immediately after the last cell of the PLS2, and mapping continues downward until the last cell index of the last FSS. If the total number of required FIC cells exceeds the number of remaining active carriers of the last FSS, mapping proceeds to the next symbol and continues in exactly the same manner as FSS(s). The next symbol for mapping in this case is the normal data symbol which has more active carriers than a FSS.

If EAS messages are transmitted in the current frame, EAC precedes FIC, and FIC cells are mapped from the next cell of the EAC in an increasing order of the cell index as shown in (b).

After FIC mapping is completed, one or more DPs are mapped, followed by auxiliary streams, if any, and dummy cells.

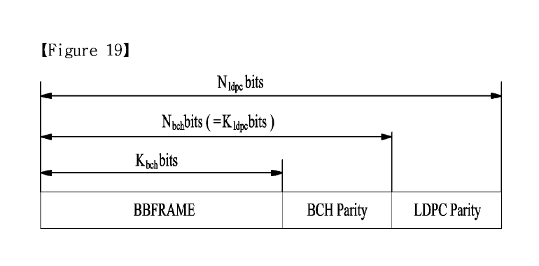

FIG. 19 illustrates an FEC structure according to an embodiment of the present invention.

FIG. 19 illustrates an FEC structure according to an embodiment of the present invention before bit interleaving. As above mentioned, Data FEC encoder may perform the FEC encoding on the input BBF to generate FECBLOCK procedure using outer coding (BCH), and inner coding (LDPC). The illustrated FEC structure corresponds to the FECBLOCK. Also, the FECBLOCK and the FEC structure have same value corresponding to a length of LDPC codeword.

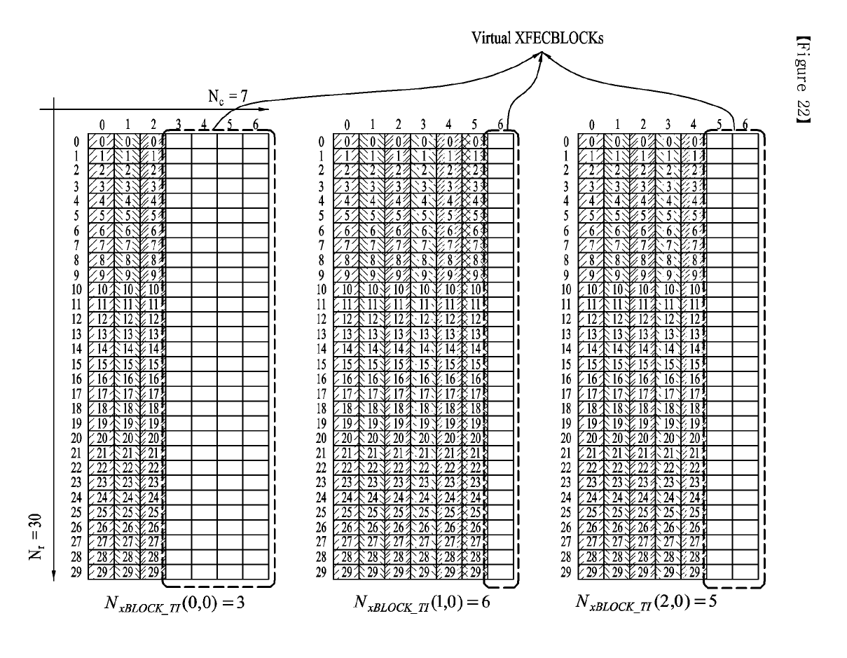

The BCH encoding is applied to each BBF (K_{bch} bits), and then LDPC encoding is applied to BCH-encoded BBF (K_{ldpc} bits=N_{bch} bits) as illustrated in FIG. 22.

The value of N_{ldpc} is either 64800 bits (long FECBLOCK) or 16200 bits (short FECBLOCK).

The below table 28 and table 29 show FEC encoding parameters for a long FECBLOCK and a short FECBLOCK, respectively.

TABLE 28

| | | | | BCH error | |
|---|---|---|---|---|---|
| LDPC | | | | correction | |
| Rate | N_{ldpc} | K_{ldpc} | K_{bch} | capability | N_{bch} − K_{bch} |
| 5/15 | 64800 | 21600 | 21408 | 12 | 192 |
| 6/15 | | 25920 | 25728 | | |
| 7/15 | | 30240 | 30048 | | |
| 8/15 | | 34560 | 34368 | | |
| 9/15 | | 38880 | 38688 | | |
| 10/15 | | 43200 | 43008 | | |
| 11/15 | | 47520 | 47328 | | |
| 12/15 | | 51840 | 51648 | | |
| 13/15 | | 56160 | 55968 | | |

TABLE 29

| | | | | BCH error | |
|---|---|---|---|---|---|
| LDPC | | | | correction | |
| Rate | N_{ldpc} | K_{ldpc} | K_{bch} | capability | N_{bch} − K_{bch} |
| 5/15 | 16200 | 5400 | 5232 | 12 | 168 |
| 6/15 | | 6480 | 6312 | | |
| 7/15 | | 7560 | 7392 | | |
| 8/15 | | 8640 | 8472 | | |
| 9/15 | | 9720 | 9552 | | |
| 10/15 | | 10800 | 10632 | | |
| 11/15 | | 11880 | 11712 | | |
| 12/15 | | 12960 | 12792 | | |
| 13/15 | | 14040 | 13872 | | |

The details of operations of the BCH encoding and LDPC encoding are as follows:

A 12-error correcting BCH code is used for outer encoding of the BBF. The BCH generator polynomial for short FECBLOCK and long FECBLOCK are obtained by multiplying together all polynomials.

LDPC code is used to encode the output of the outer BCH encoding. To generate a completed B_{ldpc} (FECBLOCK), P_{ldpc} (parity bits) is encoded systematically from each I_{ldpc} (BCH-encoded BBF), and appended to I_{ldpc}. The completed B_{ldpc}(FECBLOCK) are expressed as follow Math figure.

B_{ldpc}=[I_{ldpc}P_{ldpc}]=[i₀,i₁, . . . ,i_{K}_{_{ldpc}}₋₁,p₀,p₁, . . . ,p_{N}_{_{ldpc}}_{-K}_{_{ldpc}}₋₁] [Math Figure 3]

The parameters for long FECBLOCK and short FECBLOCK are given in the above table 28 and 29, respectively.

The detailed procedure to calculate N_{ldpc}−K_{ldpc} parity bits for long FECBLOCK, is as follows:

1) Initialize the parity bits,

p₀=p₁=p₂= . . . =p_{N}_{_{ldpc}}_{-K}_{_{ldpc}}₋₁=0 [Math Figure 4]

2) Accumulate the first information bit—i₀, at parity bit addresses specified in the first row of an addresses of parity check matrix. The details of addresses of parity check matrix will be described later. For example, for rate 13/15:

p₉₈₃=p₉₈₃⊕i₀ p₂₈₁₅=p₂₈₁₅⊕i₀

p₄₈₃₇=p₄₈₃₇⊕i₀ p₄₉₈₉=p₄₉₈₉⊕i₀

p₆₁₃₈=p₆₁₃₈⊕i₀ p₆₄₅₈=p₉₄₅₈⊕i₀

p₆₉₂₁=p₆₉₂₁⊕i₀ p₆₉₇₄=p₆₉₇₄⊕i₀

p₇₅₇₂=p₇₅₇₂⊕i₀ p₈₂₆₀=p₈₂₆₀⊕i₀

p₈₄₉₆=p₈₄₉₆⊕i₀ [Math Figure 5]

3) For the next 359 information bits, iₛ, s=1, 2, . . . , 359 accumulate iₛ at parity bit addresses using following Math figure.

{x+(s mod 360)×Q_{ldpc}} mod(N_{ldpc}−K_{ldpc}) [Math Figure 6]

where x denotes the address of the parity bit accumulator corresponding to the first bit i₀, and Q_{ldpc} is a code rate dependent constant specified in the addresses of parity check matrix. Continuing with the example, Q_{ldpc}=24 for rate 13/15, so for information bit i₁, the following operations are performed:

p₁₀₀₁=p₁₀₀₇⊕i₁ p₂₈₃₉=p₂₈₃₉⊕i₁

p₄₈₆₁=p₄₈₆₁⊕i₁ p₅₀₁₃=p₅₀₁₃⊕i₁

p₆₁₆₂=p₆₁₆₂⊕i₁ p₆₄₈₂=p₆₄₈₂⊕i₁

p₆₉₄₅=p₆₉₄₅⊕i₁ p₆₉₉₈=p₆₉₉₈⊕i₁

p₇₅₉₆=p₇₅₉₆⊕i₁ p₈₂₈₄=p₈₂₈₄⊕i₁

p₈₅₂₀=p₈₅₂₀⊕i₁ [Math Figure 7]

4) For the 361st information bit i₃₆₀, the addresses of the parity bit accumulators are given in the second row of the addresses of parity check matrix. In a similar manner the addresses of the parity bit accumulators for the following 359 information bits i₃, s=361, 362, . . . , 719 are obtained using the Math Figure 6, where x denotes the address of the parity bit accumulator corresponding to the information bit i₃₆₀, i.e., the entries in the second row of the addresses of parity check matrix.

In a similar manner, for every group of 360 new information bits, a new row from addresses of parity check matrixes used to find the addresses of the parity bit accumulators.

After all of the information bits are exhausted, the final parity bits are obtained as follows:

6) Sequentially perform the following operations starting with i=1

pᵢ=pᵢ⊕pᵢ₋₁,i=1,2, . . . ,N_{ldpc}−K_{ldpc}−1 [Math Figure 8]

where final content of pᵢ, i=0, 1, . . . N_{ldpc}−K_{ldpc}−1 is equal to the parity bit pᵢ.

TABLE 30

| Code Rate | Q_{ldpc} |
|---|---|
| 5/15 | 120 |
| 6/15 | 108 |
| 7/15 | 96 |
| 8/15 | 84 |
| 9/15 | 72 |
| 10/15 | 60 |
| 11/15 | 48 |
| 12/15 | 36 |
| 13/15 | 24 |

This LDPC encoding procedure for a short FECBLOCK is in accordance with t LDPC encoding procedure for the long FECBLOCK, except replacing the table 30 with table 31, and replacing the addresses of parity check matrix for the long FECBLOCK with the addresses of parity check matrix for the short FECBLOCK.

TABLE 31

| Code Rate | Q_{ldpc} |
|---|---|
| 5/15 | 30 |
| 6/15 | 27 |
| 7/15 | 24 |
| 8/15 | 21 |
| 9/15 | 18 |
| 10/15 | 15 |
| 11/15 | 12 |
| 12/15 | 9 |
| 13/15 | 6 |

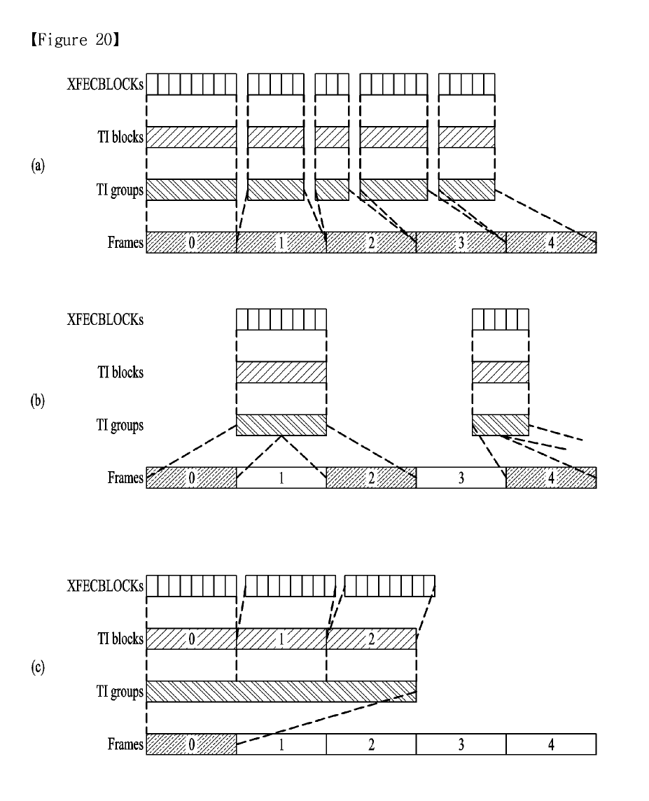

FIG. 20 illustrates a time interleaving according to an embodiment of the present invention.

(a) to (c) show examples of TI mode.

The time interleaver operates at the DP level. The parameters of time interleaving (TI) may be set differently for each DP.

The following parameters, which appear in part of the PLS2-STAT data, configure the TI:

DP_TI_TYPE (allowed values: 0 or 1): Represents the TI mode; ‘0’ indicates the mode with multiple TI blocks (more than one TI block) per TI group. In this case, one TI group is directly mapped to one frame (no inter-frame interleaving). ‘1’ indicates the mode with only one TI block per TI group. In this case, the TI block may be spread over more than one frame (inter-frame interleaving).

DP_TI_LENGTH: If DP_TI_TYPE=‘0’, this parameter is the number of TI blocks N_{TI} per TI group. For DP_TI_TYPE=‘1’, this parameter is the number of frames P_{I} spread from one TI group.

DP_NUM_BLOCK_MAX (allowed values: 0 to 1023): Represents the maximum number of XFECBLOCKs per TI group.

DP_FRAME_INTERVAL (allowed values: 1, 2, 4, 8): Represents the number of the frames I_{JUMP} between two successive frames carrying the same DP of a given PHY profile.

DP_TI_BYPASS (allowed values: 0 or 1): If time interleaving is not used for a DP, this parameter is set to ‘1’. It is set to ‘0’ if time interleaving is used.

Additionally, the parameter DP_NUM_BLOCK from the PLS2-DYN data is used to represent the number of XFECBLOCKs carried by one TI group of the DP.

When time interleaving is not used for a DP, the following TI group, time interleaving operation, and TI mode are not considered. However, the Delay Compensation block for the dynamic configuration information from the scheduler will still be required. In each DP, the XFECBLOCKs received from the SSD/MIMO encoding are grouped into TI groups. That is, each TI group is a set of an integer number of XFECBLOCKs and will contain a dynamically variable number of XFECBLOCKs. The number of XFECBLOCKs in the TI group of index n is denoted by N_{xBLOCK}_{_}_{Group}(n) and is signaled as DP_NUM_BLOCK in the PLS2-DYN data. Note that N_{xBLOCK}_{_}_{Group}(n) may vary from the minimum value of 0 to the maximum value N_{xBLOCK}_{_}_{Group}_{_}_{MAX} (corresponding to DP_NUM_BLOCK_MAX) of which the largest value is 1023.

Each TI group is either mapped directly onto one frame or spread over P_{I} frames. Each TI group is also divided into more than one TI blocks (N_{TI}), where each TI block corresponds to one usage of time interleaver memory. The TI blocks within the TI group may contain slightly different numbers of XFECBLOCKs. If the TI group is divided into multiple TI blocks, it is directly mapped to only one frame. There are three options for time interleaving (except the extra option of skipping the time interleaving) as shown in the below table 33.

TABLE 32

| Modes | Descriptions |
|---|---|
| Option-1 | Each TI group contains one TI block and is mapped directly to one |
| | frame as shown in (a). This option is signaled in the PLS2-STAT by |
| | DP_TI_TYPE = ‘0’ and DP_TI_LENGTH = ‘1’ (NTI = 1). |
| Option-2 | Each TI group contains one TI block and is mapped to more than one |
| | frame. (b) shows an example, where one TI group is mapped to two |
| | frames, i.e., DP_TI_LENGTH = ‘2’ (PI = 2) and DP_FRAME_INTERVAL |
| | (IJUMP = 2). This provides greater time diversity for low |
| | data-rate services. This option is signaled in the PLS2-STAT by |
| | DP_TI_TYPE = ‘1’. |
| Option-3 | Each TI group is divided into multiple TI blocks and is mapped |
| | directly to one frame as shown in (c). Each TI block may use full |
| | TI memory, so as to provide the maximum bit-rate for a DP. |
| | This option is signaled in the PLS2-STAT signaling by DP_TI_TYPE = |
| | ‘0’ and DP_TI_LENGTH = NTI, while PI = 1. |

Typically, the time interleaver will also act as a buffer for DP data prior to the process of frame building. This is achieved by means of two memory banks for each DP. The first TI-block is written to the first bank. The second TI-block is written to the second bank while the first bank is being read from and so on.

The TI is a twisted row-column block interleaver. For the sth TI block of the nth TI group, the number of rows Nᵣ of a TI memory is equal to the number of cells N_{cells}, i.e., Nᵣ=N_{cells} while the number of columns N_{c} is equal to the number N_{xBLOCK}_{_}_{TI}(n,s).

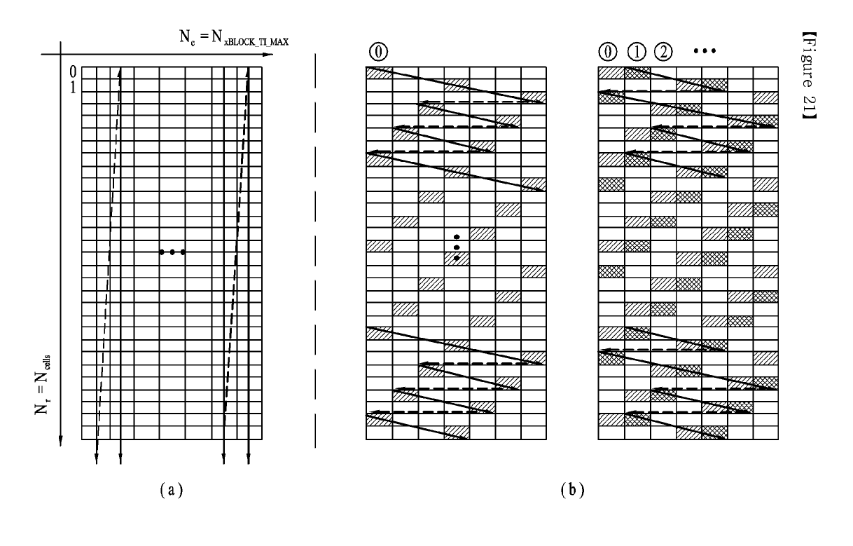

FIG. 21 illustrates the basic operation of a twisted row-column block interleaver according to an embodiment of the present invention.

shows a writing operation in the time interleaver and (b) shows a reading operation in the time interleaver The first XFECBLOCK is written column-wise into the first column of the TI memory, and the second XFECBLOCK is written into the next column, and so on as shown in (a). Then, in the interleaving array, cells are read out diagonal-wise. During diagonal-wise reading from the first row (rightwards along the row beginning with the left-most column) to the last row, Nᵣ cells are read out as shown in (b). In detail, assuming z_{n,s,i} (i=0, . . . , NᵣN_{c}) as the TI memory cell position to be read sequentially, the reading process in such an interleaving array is performed by calculating the row index R_{n,s,i}, the column index C_{n,s,i}, and the associated twisting parameter T_{n,s,i} as follows expression.

$$GENERATE ( {R}_{n , s , i} , {C}_{n , s , i} ) = \\ \{ \\ {R}_{n , s , i} = mod ( i , {N}_{r} ) , \\ {T}_{n , s , i} = mod ( {S}_{shift} \times {S}_{n , s , i} , {S}_{c} ) \\ {C}_{n , s , i} = mod ( {T}_{n , s , i} + ⌊ \frac{i}{{N}_{r}} ⌋ , {N}_{c} ) \\ \} \qquad [ Math Figure 9 ]$$

where S_{shift}, is a common shift value for the diagonal-wise reading process regardless of N_{xBLOCK}_{_}_{TI}(n,s), and it is determined by N_{xBLOCK}_{_}_{TI}_{_}_{MAX} given in the PLS2-STAT as follows expression.

$$for \\ \{ \begin{matrix}\begin{matrix}{N}_{xBLOCK \_ TI \_ MA X}^{′} = \\ {N}_{xBLOCK \_ TI \_ MA X} + 1 ,\end{matrix} & if {N}_{xBLOCK \_ TI \_ MA X} mod 2 = 0 \\ \begin{matrix}{N}_{xBLOCK \_ TI \_ MA X}^{′} = \\ {N}_{xBLOCK \_ TI \_ MA X} ,\end{matrix} & if {N}_{xBLOCK \_ TI \_ MA X} mod 2 = 1\end{matrix} , \\ {S}_{shift} = \frac{{N}_{xBLOCK \_ TI \_ MA X}^{′} - 1}{2} \qquad [ Math Figure 10 ]$$

As a result, the cell positions to be read are calculated by a coordinate as z_{n,s,i}=NᵣC_{n,s,i}+R_{n,s,i}.

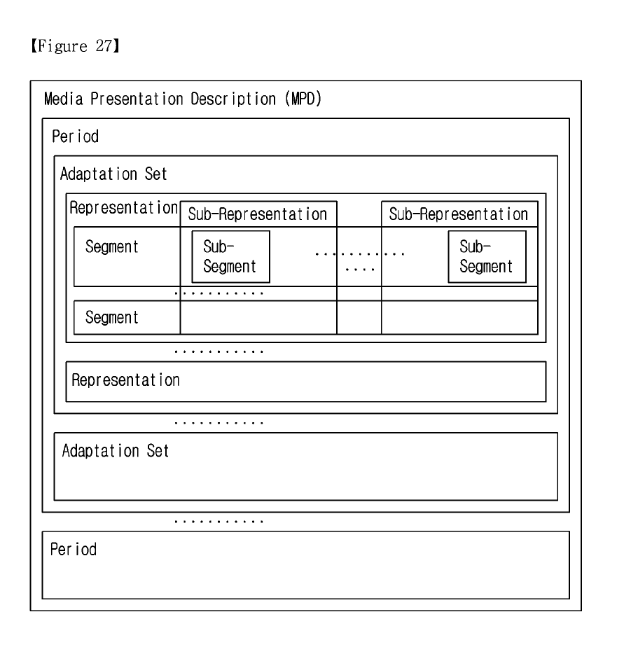

FIG. 27 illustrates an operation of a twisted row-column block interleaver according to another embodiment of the present invention.

More specifically, FIG. 22 illustrates the interleaving array in the TI memory for each TI group, including virtual XFECBLOCKs when N_{xBLOCK}_{_{−}}_{TI}(0,0)=3, N_{xBLOCK}_{_}_{TI}(1,0)=6, N_{xBLOCK}_{_{−}}_{TI}(2,0)=5.

The variable number N_{xBLOCK}_{_}_{TI}(n,s)=Nᵣ will be less than or equal to N′_{xBLOCK}_{_}_{TI}_{_}_{MAX}. Thus, in order to achieve a single-memory deinterleaving at the receiver side, regardless of N_{xBLOCK}_{_}_{TI}(n,s) the interleaving array for use in a twisted row-column block interleaver is set to the size of Nᵣ×N_{c}=N_{cells}×N′_{xBLOCK}_{_}_{TI}_{_}_{MAX} by inserting the virtual XFECBLOCKs into the TI memory and the reading process is accomplished as follow expression.

[Math FIG. 11]

p=0;
for i=0;i<N_{cells}N′_{xBLOCK}_{_{—}}_{TI}_{_{—}}_{MAX};i=i+1
{GENERATE(R_{n,s,i},C_{n,s,i});
Vᵢ=NᵣC_{n,s,j}+R_{n,s,i}

if Vᵢ<N_{cells}N_{xBLOCK}_{_{—}}_{TI}(n,s)
{
Z_{n,s,p}=Vᵢ ;p=p+1;
}

}

The number of TI groups is set to 3. The option of time interleaver is signaled in the PLS2-STAT data by DP_TI_TYPE=‘0’, DP_FRAME_INTERVAL=‘1’, and DP_TI_LENGTH=‘1’, i.e., N_{TI}=1, I_{JUMP}=1, and P_{I}=1. The number of XFECBLOCKs, each of which has N_{cells}=30 cells, per TI group is signaled in the PLS2-DYN data by N_{xBLOCK}_{_}_{TI}(0,0)=3, N_{xBLOCK}_{_}_{TI}(1,0)=6, and N_{xBLOCK}_{_}_{TI}(2,0)=5, respectively. The maximum number of XFECBLOCK is signaled in the PLS2-STAT data by N_{xBLOCK}_{_}_{Group}_{_}_{MAX}, which leads to └N_{xBLOCK}_{_{−}}_{Group}_{_{−}}_{MAX}/N_{TI}┘=N_{xBLOCK}_{_{−}}_{TI}_{_{−}}_{MAX}=6.

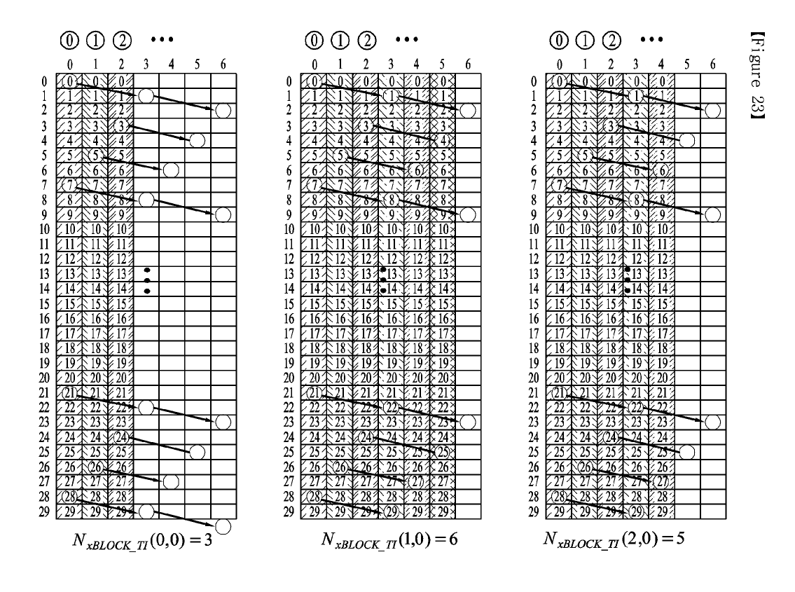

FIG. 23 illustrates a diagonal-wise reading pattern of a twisted row-column block interleaver according to an embodiment of the present invention.

More specifically FIG. 23 shows a diagonal-wise reading pattern from each interleaving array with parameters of N′_{xBLOCK}_{_{−}}_{TI}_{_}_{MAX} and S_{shift}=(7−1)/2=3. Note that in the reading process shown as pseudocode above, if Vᵢ≧N_{cells}N_{xBLOCK}_{_{−}}_{TI}(n,s), the value of Vᵢ is skipped and the next calculated value of Vᵢ is used.

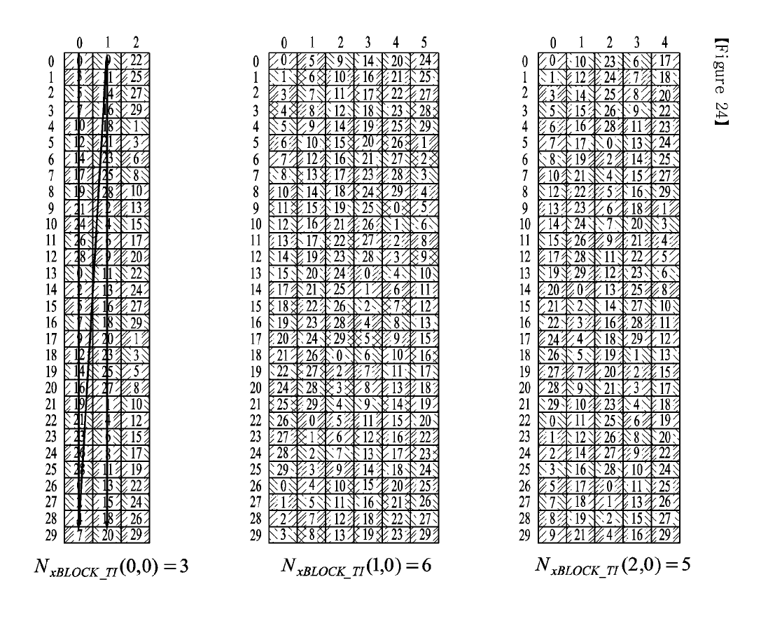

FIG. 24 illustrates interleaved XFECBLOCKs from each interleaving array according to an embodiment of the present invention.

FIG. 24 illustrates the interleaved XFECBLOCKs from each interleaving array with parameters of N′_{xBLOCK}_{_}_{TI}_{_}_{MAX}=7 and S_{shift}=3.

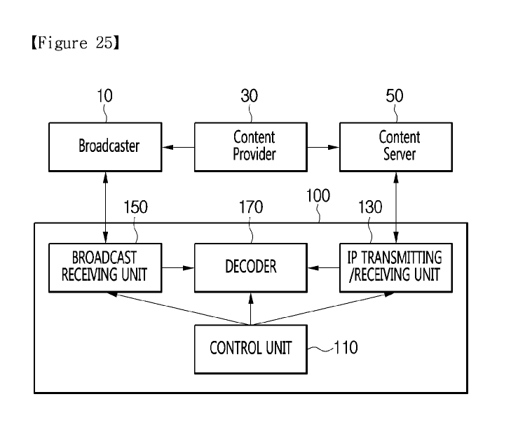

FIG. 25 is a block diagram illustrating a media content transmission/reception system according to an embodiment.

The media content transmission/reception system includes a broadcaster 10, a content provider 30, a content server 50, and a broadcast reception apparatus 100.

The content provider 30 provides media content to the broadcaster and the content server 50.

The broadcaster 10 transmits a broadcast stream including media content using at least one of a satellite, terrestrial or cable broadcasting network.

The content server 50 transmits media content on the basis of a request of the broadcast reception apparatus 100.

The broadcast reception apparatus 100 includes a control unit 150, an IP transmission/reception unit 130, a broadcast reception unit 150, and a decoder 170. The broadcast reception apparatus 100 controls operation of the IP transmission/reception unit 130, the broadcast reception unit 110, and the decoder 170 via the control unit 150. The broadcast reception apparatus 100 receives a broadcast stream including media content via the broadcast reception unit 110. Here, the broadcast stream may be transmitted using at least one of a satellite, terrestrial or cable broadcasting network. Therefore, the broadcast reception unit 110 may include at least one of a satellite tuner, a terrestrial tuner, or a cable tuner to receive the broadcast stream. The broadcast reception apparatus 100 requests media content from the content server 50 via the IP transmission/reception unit 130. The broadcast reception apparatus 100 receives the media content from the content server 50 via the IP transmission/reception unit 130. The broadcast reception apparatus 100 decodes the media content via the decoder 170.

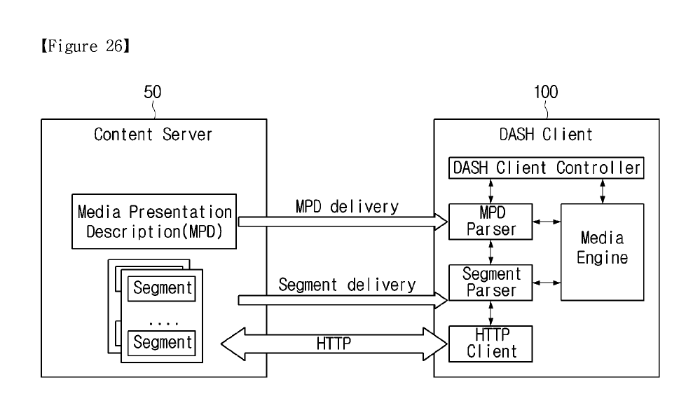

Media content transmission/reception via a broadband according to an embodiment will be described with reference to FIGS. 26 to 30.

FIG. 26 is a diagram illustrating a system for transmitting/receiving media content via a broadband according to an embodiment.

The media content transmission/reception via an IP network according to an embodiment is divided into transmission/reception of a transmission packet including actual media content and transmission/reception of media content presentation information. The broadcast reception apparatus 100 receives the media content presentation information, and receives the transmission packet including media content. The media content presentation information represents information required for presenting the media content. The media content presentation information includes at least one of spatial information or temporal information required for presenting the media content. The broadcast reception apparatus 100 presents the media content on the basis of the media content presentation information.

In a specific embodiment, media content may be transmitted/received via an IP network according to an MPEG Media Transport (MMT) standard. The content server 50 transmits a presentation information (PI) document including the media content presentation information. Furthermore, the content server 50 transmits an MMT protocol (MMTP) packet including media content on the basis of a request of the broadcast reception apparatus 100. The broadcast reception apparatus 100 receives the PI document. The broadcast reception apparatus 100 receives a transmission packet including media content. The broadcast reception apparatus 100 extracts the media content from the transmission packet including the media content. The broadcast reception apparatus 100 presents the media content on the basis of the PI document.

In another specific embodiment, as illustrated in FIG. 26, media content may be transmitted/received via an IP network according to an MPEG-Dynamic Adaptive Streaming over HTTP (DASH) standard. In FIG. 26, the content server 50 transmits a media presentation description (MPD) including the media content presentation information. However, depending on a specific embodiment, the MPD may be transmitted by another external server instead of the content server 50. Furthermore, the content server 50 transmits a segment including media content on the basis of a request of the broadcast reception apparatus 100. The broadcast reception apparatus 100 receives the MPD. The broadcast reception apparatus 100 requests media content from the content server 50 on the basis of the MPD. The broadcast reception apparatus 100 receives a transmission packet including media content on the basis of a request. The broadcast reception apparatus 100 presents the media content on the basis of the MPD. To this end, the broadcast reception apparatus 100 may include a DASH client in the control unit 150. The DASH client may include an MPD parser for parsing the MPD, a segment parser for parsing the segment, an HTTP client for transmitting an HTTP request message and receiving an HTTP response message via the IP transmission/reception unit 130, and a media engine for presenting media. The MPD will be described in detail with reference to FIGS. 27 to 29.

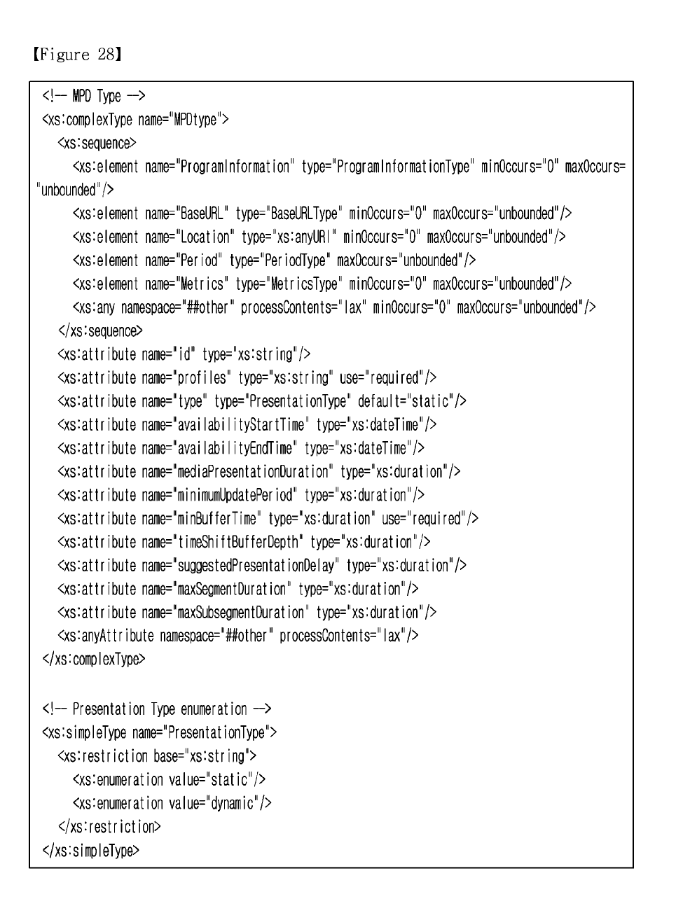

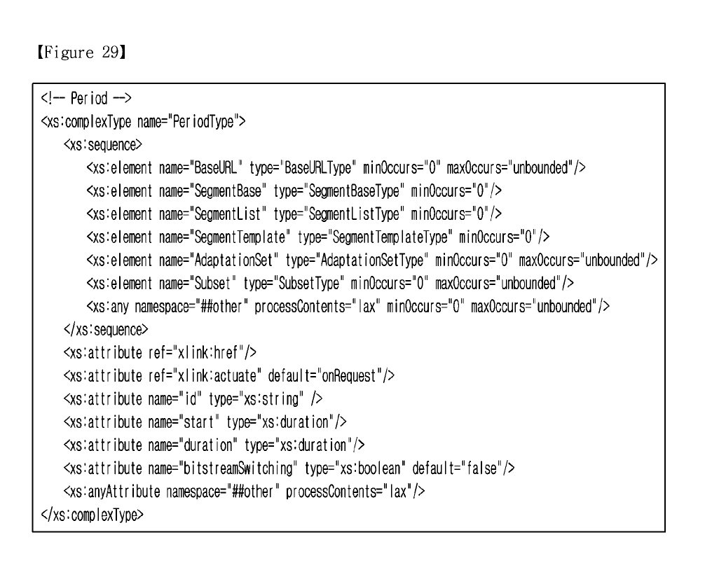

FIG. 27 illustrates a structure of the MPD according to an embodiment. FIG. 28 illustrates a syntax of the MPD according to an embodiment. FIG. 29 illustrates an XML syntax of a period element of the MPD according to an embodiment.

The MPD may include a period element, an adaptation set element, and a representation element.

The period element includes information about a period. The MPD may include information about a plurality of periods. The period represents a continuous time interval of media content presentation.

The adaptation set element includes information about an adaptation set. The MPD may include information about a plurality of adaptation sets. The adaptation set is a set of media components including one or more interconvertible media content components. The adaptation set may include one or more representations. The adaptation sets may respectively include audios of different languages or subtitles of different languages.

The representation element includes information about a representation. The MPD may include information about a plurality of representations. The representation is a structured set of one or more media components. There may exist a plurality of representations differently encoded for the same media content component. In the case where bitstream switching is allowed, the broadcast reception apparatus 100 may switch a received representation to another representation on the basis of information updated during presentation of media content. In particular, the broadcast reception apparatus 100 may switch a received representation to another representation according to conditions of a bandwidth. The representation is divided into a plurality of segments.

The segment is a unit of media content data. The representation may be transmitted as the segment or a part of the segment according to a request of the media content receiver 30 using the HTTP GET or HTTP partial GET method defined in the HTTP 1.1 (RFC 2616) protocol.

Furthermore, the segment may include a plurality of sub-segments. The sub-segment may represent a smallest unit able to be indexed at a segment level. The segment may include an initialization segment, a media segment, an index segment, and a bitstream switching segment.

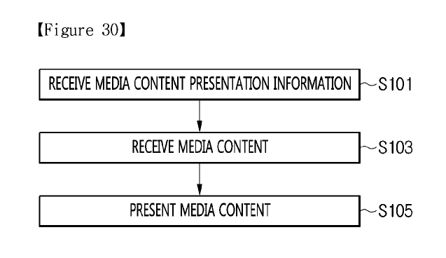

FIG. 30 is a flowchart of an operation of receiving, by a broadcast reception apparatus, media content via an IP network according to an embodiment.

The broadcast reception apparatus 100 receives the media content presentation information via the IP transmission/reception unit 130 (S101). In a specific embodiment, the media content presentation information may be the MPD according to the MPEG-DASH standard. Here, the broadcast reception apparatus 100 may receive the MPD via the IP transmission/reception unit 130. In another specific embodiment, the media content presentation information may be the PI document according to the MMT standard. Here, the broadcast reception apparatus 100 may receive the PI document via the IP transmission/reception unit 130.

The broadcast reception apparatus 100 receives media content via the IP transmission/reception unit 130 on the basis of the media content presentation information (S103).

The broadcast reception apparatus 100 presents the media content via the control unit 150 (S105). In detail, the broadcast reception apparatus 100 may present the media content on the basis of the media content presentation information via the control unit 150.

As described above, the broadcast reception apparatus 100 that receives a broadcast stream via a satellite, cable or terrestrial broadcasting network is required to receive the media content presentation information in order to receive media content via an IP network. In particular, the media content presentation information is required to be transmitted or received via a broadcast stream in order to efficiently interwork with content transmitted via a broadcasting network. This is because a content provider or a broadcaster may integrally manage content information provided via a broadcasting network and information about media content transmitted via an IP network in the case where the media content presentation information is transmitted via a broadcast stream. Furthermore, this is because the broadcast reception apparatus 100 may quickly determine whether the media content presentation information is updated without an additional information request message in the case where the media content presentation information is transmitted via a broadcast stream since the broadcast reception apparatus 100 continually receives a broadcast stream.

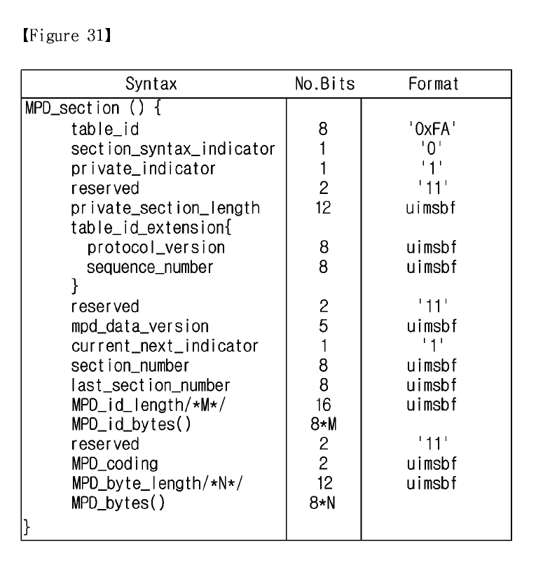

Described below with reference to FIGS. 31 to 63 is a method of transmitting/receiving the media content presentation information using a broadcast stream transmitted via a broadcasting network instead of an IP network.

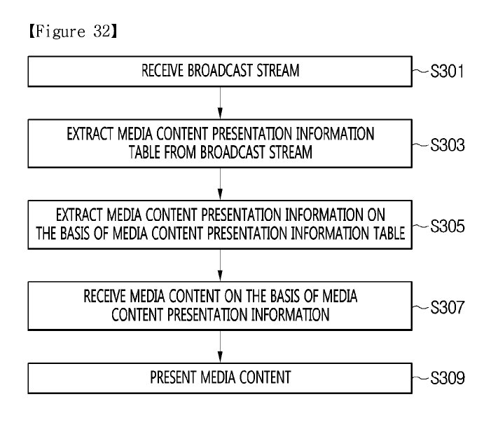

A content provider or a broadcaster may add the media content presentation information to a media content presentation information table to transmit the media content presentation information. This operation of adding the media content presentation information to the media content presentation information table to transmit the media content presentation information is described below with reference to FIGS. 31 and 32.

In the case where the media content presentation information is added to the media content presentation information table so as to be transmitted, the broadcast reception apparatus 100 may receive the media content presentation information on the basis of the media content presentation information table. In detail, the broadcast reception apparatus 100 may extract the media content presentation information from the media content presentation information table to receive the media content presentation information.

Here, the media content presentation information table may include an id element for identifying the media content presentation information table among various information tables.

Furthermore, the media content presentation information table may include an id_extension element. The id_extension element may indicate an identifier for identifying a media content presentation information table instance. Here, an id_extension field may include a protocol_version field indicating a protocol version of the media content presentation information table. The id_extension field may also include a sequence_number field for identifying each of a plurality of media content presentation information tables including different pieces of media content presentation information. The id_extension element may indicate a service identifier for identifying a broadcasting service associated with the media content presentation information table. Here, the id_extension element may indicate any one of a program number, a service id, and a source id.

Furthermore, the media content presentation information table may include a version element indicating a version of the media content presentation information table. Here, the broadcast reception apparatus 100 may determine whether the media content presentation information table is updated on the basis of the version element. In detail, the broadcast reception apparatus 100 may determine that the media content presentation information table has been updated, upon receiving the media content presentation information table having a version element value different from that of a previously received media content presentation information table. Here, the broadcast reception apparatus 100 may extract the media content presentation information from the media content presentation information table. Furthermore, the broadcast reception apparatus 100 may determine that the media content presentation information table has not been updated, upon receiving the media content presentation information table having the same version element value as that of a previously received media content presentation information table. In this case, the broadcast reception apparatus 100 does not extract the media content presentation information from the media content presentation information table. In a specific embodiment, the version element may have the same value as that of the version element included in the media content presentation information.

Furthermore, the media content presentation information table may include a media content presentation information id element indicating an identifier for identifying the media content presentation information.

Here, the media content presentation information table may include a media content presentation information id_length element indicating a length of the identifier for identifying the media content presentation information.

Furthermore, the media content presentation information table may include a coding element indicating an encoding method of the media content presentation information. Here, the coding element that indicates the encoding method may indicate that the media content presentation information table includes the media content presentation information without particularly compressing the media content presentation information. Furthermore, the coding element that indicates the encoding method may indicate that the media content presentation information table includes the media content presentation information compressed by a specific algorithm. Here, the specific algorithm may be a gzip algorithm.

Furthermore, the media content presentation information table may include a byte_length element indicating a length of the media content presentation information.

Furthermore, the media content presentation information table may include a byte( ) element that is the media content presentation information itself.

Here, the media content presentation information table may have an XML, HTML5 or bitstream format.

FIG. 31 illustrates a bitstream syntax for the case where the MPD is transmitted in a format of an MPD information table according to an embodiment.

FIG. 31 illustrates the case where the media content presentation information table has a bitstream format, and the media content presentation information is included in the MPD. Therefore, with respect to FIG. 31, the media content presentation information table is referred to as an MPD information table.

The MPD information table includes a table_id field, a section_syntax_indicator field, a private_indicator field, a private_section_length field, a table_id_extension field, an MPD_data_version field, a section_number field, a last_section_number field, an MPD_id_length field, an MPD_id_bytes field, an MPD_coding field, an MPD_byte_length field, and an MPD_byte field.

In the example of FIG. 31, the table_id field indicates an identifier of the MPD information table. Here, the table_id field may be 0xFA that is one of reserved id values defined in ATSC A/65.

The section_syntax_indicator field indicates whether the MPD information table is a long-type private section table of an MPEG-2 TS standard. Since the MPD information table is not a long-type table, the section_syntax_indicator field has a value of 0.

The private_indicator field indicates whether a current table corresponds to a private section. Since the MPD information table corresponds to the private section, the private_indicator field has a value of 1.

The private_section_length field indicates a length of a section following the private_section_length field.

The table_id_extension field indicates an identifier for identifying a broadcasting service associated with the MPD transmitted via the MPD information table. Here, the table_id_extension field may indicate any one of a program number, a service id, and a source id. In another embodiment, the table_id_extension field may indicate an identifier for identifying the MPD. In detail, the table_id_extension field may include a protocol_version field indicating a protocol version of the MPD information table. Furthermore, the table_id_extension field may include a sequence_number field for identifying each of a plurality of MPD information tables including different MPDs.

The MPD_data_version field indicates a version of the MPD information table. Here, the broadcast reception apparatus 100 may determine whether the MPD information table is updated on the basis of the MPD_data_version field. The MPD_data_version field may have the same value as that of the version element included in the MPD.

The section_number field indicates a number of a current section.

The last_section_number field indicates a number of a last section. In the case where the MPD information table has a large size, the MPD information table may be divided into a plurality of sections so as to be transmitted. Here, the broadcast reception apparatus 100 determines whether all sections required for the MPD information table are received on the basis of the section_number field and the last_section_number field.

The MPD_id_bytes field indicates an identifier for identifying the MPD.

The MPD_id_length field indicates a length of the identifier for identifying the MPD.

The MPD_coding field indicates an encoding method for the MPD. Here, the MPD_coding field that indicates the encoding method may indicate that the MPD information table includes the media content presentation information without particularly compressing the media content presentation information. Furthermore, the MPD_coding field may indicate that the MPD information table includes the MPD compressed by a specific algorithm. Here, the specific algorithm may be a gzip algorithm. In a specific embodiment, a value of the MPD_coding field may be defined as shown in Table 33.

TABLE 33

| Value | Designation |
|---|---|
| 0x00 | Plain text |
| 0x01 | Compressed by gzip |
| 0x02-0x03 | Reserved for future use |

In the example of Table 33, in the case where the MPD_coding field has a value of 0x00, the MPD_coding field indicates that the MPD information table includes the media content presentation information without particularly compressing the media content presentation information. In the case where the MPD_coding field has a value of 0x01, the MPD_coding field indicates that the MPD information table includes the MPD compressed by a gzip algorithm.

The MPD_byte_length field indicates a length of the MPD.

The MPD_byte( ) field includes actual data of the MPD included in the MPD information table.

FIG. 32 is a flowchart of an operation of extracting, by a broadcast reception apparatus, the MPD on the basis of an information table including the MPD according to an embodiment.

The broadcast reception apparatus 100 receives a broadcast stream via the broadcast reception unit 110 (S301).

The broadcast reception apparatus 100 extracts the media content presentation information table from the broadcast stream via the control unit 150 (S303). In a specific embodiment, the broadcast reception apparatus 100 may extract the media content presentation information table from the broadcast stream on the basis of the id element via the control unit 150. In detail, the broadcast reception apparatus 100 may extract the media content presentation information table from the broadcast stream on the basis of information in which the id element is combined with the id_extension element via the control unit 150. For example, the broadcast reception apparatus 100 may identify the media content presentation information table using a value of the id element via the control unit 150 so as to extract the media content presentation information table from the broadcast stream. Here, the broadcast reception apparatus 100 may identify the media content presentation information table using a value obtained by combining the value of the id element and the value of the id_extension element via the control unit 150 so as to extract the media content presentation information table from the broadcast stream.

The broadcast reception apparatus 100 extracts the media content presentation information on the basis of the media content presentation information table via the control unit 150 (S305). Here, in the case where the media content presentation information is compressed, the broadcast reception apparatus 100 may decompress the media content presentation information via the control unit 150 so as to extract the media content presentation information.

The broadcast reception apparatus 100 receives media content via the IP transmission/reception unit 130 on the basis of the media content presentation information (S307).

The broadcast reception apparatus 100 presents the media content via the control unit 150 (S309). In detail, the broadcast reception apparatus 100 may present the media content on the basis of the media content presentation information via the control unit 150.

A content provider or a broadcaster may add the media content presentation information to an IP datagram to transmit the media content presentation information via a broadcasting network instead of an IP network. Here, the content provider or the broadcaster may add the media content presentation information table including the media content presentation information to the IP datagram to transmit the media content presentation information table. This operation of adding the media content presentation information to the IP datagram to transmit the media content presentation information is described below with reference to FIGS. 9 to 12.

In the case where the media content presentation information is added to the IP datagram so as to be transmitted, the broadcast reception apparatus 100 may receive the media content presentation information on the basis of a media IP datagram. In a specific embodiment, the broadcast reception apparatus 100 may extract the media content presentation information from the IP datagram to receive the media content presentation information. In another specific embodiment, the broadcast reception apparatus 100 may extract the media content presentation information table from the IP datagram to receive the media content presentation information.

Here, the media content presentation information may be added to a UDP payload. The UDP payload may include a payload_type field and a payload field. The payload_type field indicates a data type of the media content presentation information included in the payload field. Here, a value of the payload_type field may indicate that the media content presentation information included in the payload field is a file itself. In a specific embodiment, in the case where the media content presentation information is included in the MPD, the value of the payload_type field may indicate that the payload field includes the MPD as it is. In another specific embodiment, in the case where the media content presentation information is included in the PI document, the value of the payload_type field may indicate that the payload field includes the PI document as it is. Furthermore, the value of the payload_type field may indicate that the media content presentation information is included in a specific syntax format. Furthermore, the value of the payload_type field may indicate that the media content presentation information is included in the form of the above-mentioned media content presentation information table.

The payload field may include the media content presentation information.

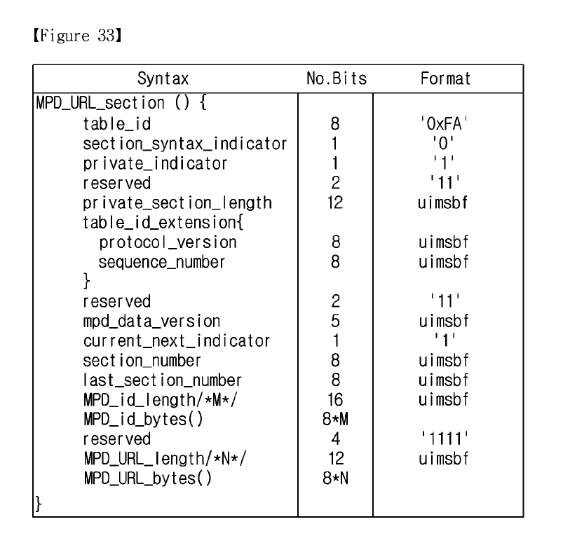

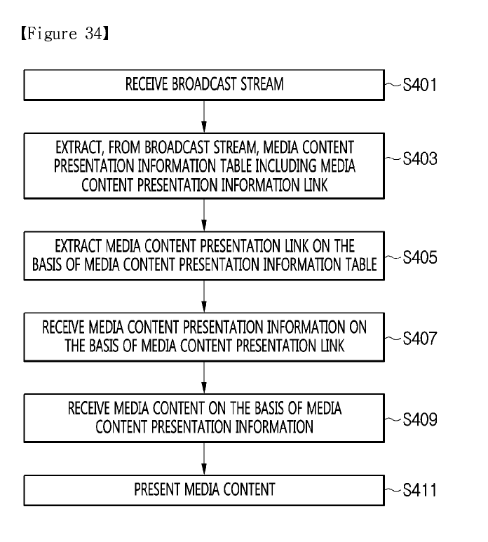

The content provider or the broadcaster may add a media content presentation information link to the media content presentation information table to transmit the media content presentation information link. Here, the media content presentation information link may provide a link to the media content presentation information so that the media content presentation information is received. Here, the media content presentation information link may have a format of a uniform resource locator (URL). This operation of adding the media content presentation information link to the media content presentation information table to transmit the media content presentation information link is described below with reference to FIGS. 33 and 34.

In the case where the media content presentation information link is added to the media content presentation information table so as to be transmitted, the broadcast reception apparatus 100 may receive the media content presentation information on the basis of the media content presentation information table. In detail, the broadcast reception apparatus 100 may extract the media content presentation information link from the media content presentation information table. Here, the broadcast reception apparatus 100 may receive the media content presentation information from the media content presentation information link.

Here, the media content presentation information table may include an id element for identifying the media content presentation information table among various information tables.

Furthermore, the media content presentation information table may include an id_extension element. The id_extension element may indicate an identifier for identifying a media content presentation information table instance. Here, an id_extension field may include a protocol_version field indicating a protocol version of the media content presentation information table. The id_extension field may also include a sequence_number field for identifying each of a plurality of media content presentation information tables including different pieces of media content presentation information. The id_extension element may indicate a service identifier for identifying a broadcasting service associated with the media content presentation information table. Here, the id_extension element may indicate any one of a program number, a service id, and a source id.

Furthermore, the media content presentation information table may include a version element indicating a version of the media content presentation information table. Here, the broadcast reception apparatus 100 may determine whether the media content presentation information table is updated on the basis of the version element. In detail, the broadcast reception apparatus 100 may determine that the media content presentation information table has been updated, upon receiving the media content presentation information table having a version element value different from that of a previously received media content presentation information table. Here, the broadcast reception apparatus 100 may extract the media content presentation information from the media content presentation information table. Furthermore, the broadcast reception apparatus 100 may determine that the media content presentation information table has not been updated, upon receiving the media content presentation information table having the same version element value as that of a previously received media content presentation information table. In this case, the broadcast reception apparatus 100 does not extract the media content presentation information from the media content presentation information table. In a specific embodiment, the version element may have the same value as that of the version element included in the media content presentation information.

Furthermore, the media content presentation information table may include a media content presentation information id element indicating an identifier for identifying the media content presentation information.

Here, the media content presentation information table may include a media content presentation information id_length element indicating a length of the identifier for identifying the media content presentation information.

Furthermore, the media content presentation information table may include a byte_length element indicating a length of the media content presentation information link.

Furthermore, the media content presentation information table may include a byte( ) element that is the media content presentation information link itself. Here, the media content presentation information link may have a URL format.

Here, the media content presentation information table may have an XML, HTML5 or bitstream format.

FIG. 33 illustrates an MPD link table including an MPD link according to an embodiment.

FIG. 33 illustrates the case where the media content presentation information table has a bitstream format, and the media content presentation information is included in the MPD. Therefore, with respect to FIG. 33, the media content presentation information table is referred to as an MPD information table. The media content presentation information link has a URL format. Therefore, the media content presentation information link is referred to as an MPD_URL.

The MPD information table includes a table_id field, a section_syntax_indicator field, a private_indicator field, a private_section_length field, a table_id_extension field, an MPD_data_version field, a section_number field, a last_section_number field, an MPD_id_length field, an MPD_id_byte field, an MPD_URL_length field, and an MPD_URL_bytes field.

In the example of FIG. 33, the table_id field indicates an identifier of the MPD information table. Here, the table_id field may be 0xFA that is one of reserved id values defined in ATSC A/65.

The section_syntax_indicator field indicates whether the MPD information table is a long-type private section table of the MPEG-2 TS standard. Since the MPD information table is not a long-type table, the section_syntax_indicator field has a value of 0.

The private_indicator field indicates whether a current table corresponds to a private section. Since the MPD information table corresponds to the private section, the private_indicator field has a value of 1.

The private_section_length field indicates a length of a section following the private_section_length field.

The table_id_extension field indicates an identifier for identifying a broadcasting service associated with the MPD transmitted via the MPD information table. Here, the table_id_extension field may indicate any one of a program number, a service id, and a source id. In another embodiment, the table_id_extension field may indicate an identifier for identifying the MPD. In detail, the table_id_extension field may include a protocol_version field indicating a protocol version of the MPD information table. Furthermore, the table_id_extension field may include a sequence_number field for identifying each of a plurality of MPD information tables including different MPDs.

The MPD_data_version field indicates a version of the MPD information table. Here, the broadcast reception apparatus 100 may determine whether the MPD information table is updated on the basis of the MPD_data_version field. The MPD_data_version field may have the same value as that of the version element included in the MPD.

The section_number field indicates a number of a current section.

The last_section_number field indicates a number of a last section. In the case where the MPD information table has a large size, the MPD information table may be divided into a plurality of sections so as to be transmitted. Here, the broadcast reception apparatus 100 determines whether all sections required for the MPD information table are received on the basis of the section_number field and the last_section_number field.

The MPD_id_bytes field indicates an identifier for identifying the MPD.

The MPD_id_length field indicates a length of the identifier for identifying the MPD.

The MPD_URL_length field indicates a length of the MPD_URL.

The MPD_URL_bytes( ) field indicates the MPD_URL itself.

FIG. 34 is a flowchart of an operation of receiving, by a broadcast reception apparatus, the MPD on the basis of the media content presentation information table including the media content presentation information link according to an embodiment.

The broadcast reception apparatus 100 receives a broadcast stream via the broadcast reception unit 150 (S401).

The broadcast reception apparatus 100 extracts the media content presentation information table including the media content presentation information link from the broadcast stream via the control unit 150 (S403). In a specific embodiment, the broadcast reception apparatus 100 may extract the media content presentation information table from the broadcast stream on the basis of the id element via the control unit 150. In detail, the broadcast reception apparatus 100 may extract the media content presentation information table from the broadcast stream on the basis of information in which the id element is combined with the id_extension element via the control unit 150. For example, the broadcast reception apparatus 100 may identify the media content presentation information table using a value of the id element via the control unit 150 so as to extract the media content presentation information table from the broadcast stream. Here, the broadcast reception apparatus 100 may identify the media content presentation information table using a value obtained by combining the value of the id element and the value of the id_extension element via the control unit 150 so as to extract the media content presentation information table from the broadcast stream.

The broadcast reception apparatus 100 extracts the media content presentation information link on the basis of the media content presentation information table via the control unit 150 (S405). Here, the media content presentation information link may have a URL format.

The broadcast reception apparatus 100 receives the media content presentation information on the basis of the media content presentation information link via the IP transmission/reception unit 130 (S407).

The broadcast reception apparatus 100 receives media content via the IP transmission/reception unit 130 on the basis of the media content presentation information (S409).

The broadcast reception apparatus 100 presents the media content via the control unit 150 (S411). In detail, the broadcast reception apparatus 100 may present the media content on the basis of the media content presentation information via the control unit 150.

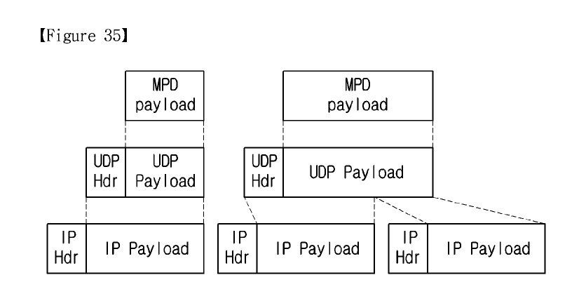

FIGS. 35 to 37 illustrate the case where the media content presentation information is included in the MPD. FIG. 35 illustrates that the MPD or the MPD information table is added to an IP datagram so as to be transmitted according to an embodiment.

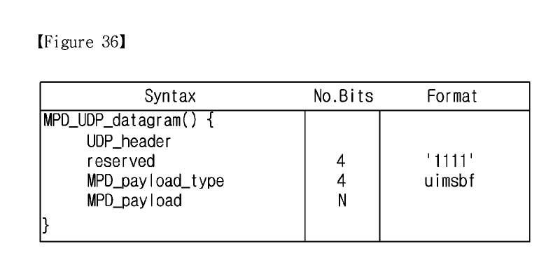

As exemplified by the data structure of FIG. 11, the IP datagram includes a UDP datagram in an IP payload in the examples of FIGS. 11 to 13. The UDP datagram includes the MPD or the MPD information table in a UDP payload. A syntax of the IP datagram will be described in detail with reference to FIG. 36.

FIG. 36 illustrates the syntax of the IP datagram for the case where the MPD or the MPD information table is added to the IP datagram so as to be transmitted according to an embodiment.

The UDP payload includes an MPD_payload_type field and a payload field. The MPD_payload_type field indicates a data type of the MPD included in the MPD_payload field. A value of the MPD_payload_type field may indicate that the MPD_payload field includes the MPD itself. Furthermore, the value of the MPD_payload_type field may indicate that the MPD_payload field includes the MPD in a specific syntax format. In detail, the value of the MPD_payload_type field may be defined as shown in Table 34 below.

TABLE 34

| Value | Designation |
|---|---|
| 0x00 | Not Specified |
| 0x01 | Syntax |
| 0x02 | MPD file at it is |
| 0x03 | MPD section |
| 0x03 | Reserved for future use |

In the example of Table 34, in the case where the value of the MPD_payload_type field is 0x01, the MPD_payload_type field indicates that the MPD_payload field includes the MPD in a specific syntax format. In the case where the value of the MPD_payload_type field is 0x02, the MPD_payload_type field indicates that the MPD_payload field includes the MPD as it is. In the case where the value of the MPD_payload_type field is 0x03, the MPD_payload_type field indicates that the MPD_payload field includes the MPD in the form of the above-mentioned MPD information table.

The MPD_payload field includes the MPD.

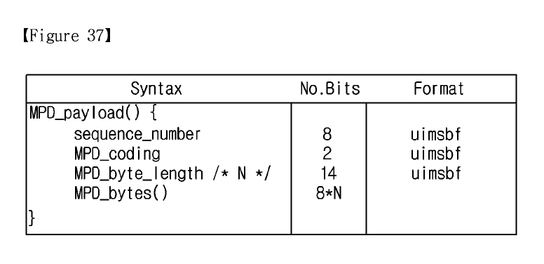

FIG. 37 illustrates a syntax of an MPD payload included in the IP datagram for the case where the MPD or the MPD information table is added to the IP datagram so as to be transmitted according to an embodiment.

An MPD_coding field indicates an encoding method for the MPD or the MPD information table. Here, the MPD_coding field that indicates the encoding method may indicate that the MPD payload includes the MPD or the MPD information table without particularly compressing the MPD or the MPD information table. Furthermore, the MPD_coding field may indicate that the MPD payload includes the MPD or the MPD information table compressed by a specific algorithm. Here, the specific algorithm may be a gzip algorithm. In a specific embodiment, a value of the MPD_coding field may be defined as shown in Table 35.

TABLE 35

| Value | Designation |
|---|---|
| 0x00 | Plain text |
| 0x01 | Compressed by gzip |
| 0x02-0x03 | Reserved for future use |

In the example of Table 35, in the case where the MPD_coding field has a value of 0x00, the MPD_coding field indicates that the MPD payload includes the MPD or the MPD information table without particularly compressing the MPD or the MPD information table. In the case where the MPD_coding field has a value of 0x01, the MPD_coding field indicates that the MPD payload includes the MPD or the MPD information table compressed by a gzip algorithm.

An MPD_byte_length field indicates a length of the MPD or the MPD information table.

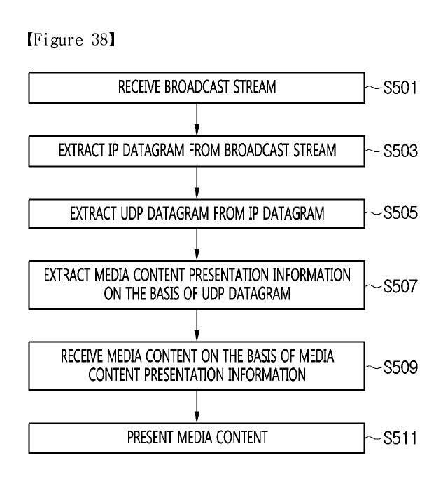

FIG. 38 is a flowchart of an operation of extracting, by a broadcast reception apparatus, the media content presentation information or the media content presentation information table on the basis of the IP datagram including the media content presentation information or the media content presentation information table according to an embodiment.

The broadcast reception apparatus 100 receives a broadcast stream via the broadcast reception unit 150 (S501).

The broadcast reception apparatus 100 extracts the IP datagram from the broadcast stream via the control unit 150 (S503).

The broadcast reception apparatus 100 extracts the UDP datagram from the IP datagram via the control unit 150 (S505). In detail, the broadcast reception apparatus 100 extracts the UDP datagram from a payload of the IP datagram.

The broadcast reception apparatus 100 extracts the media content presentation information on the basis of the UDP datagram via the control unit 150 (S507). In detail, the broadcast reception apparatus 100 extracts the media content presentation information or the media content presentation information table from the payload of the UDP datagram. In a specific embodiment, in the case where the media content presentation information or the media content presentation information table is compressed, the broadcast reception apparatus 100 may decompress the media content presentation information or the media content presentation information table via the control unit 150 so as to extract the media content presentation information or the media content presentation information table. Here, the broadcast reception apparatus 100 may decompress the media content presentation information or the media content presentation information table on the basis of a coding field included in the UDP datagram. Here, the broadcast reception apparatus 100 may extract the media content presentation information from the media content presentation information table via the control unit 150.

The broadcast reception apparatus 100 receives media content via the IP transmission/reception unit 130 on the basis of the media content presentation information (S507).

The broadcast reception apparatus 100 presents the media content via the control unit 150 (S509). In detail, the broadcast reception apparatus 100 may present the media content on the basis of the media content presentation information via the control unit 150.

A content provider or a broadcaster may add a method of transmitting the media content presentation information to a broadcast information signaling table to transmit the method of transmitting the media content presentation information. This operation of adding the method of transmitting the media content presentation information to the broadcast information signaling table to transmit the method of transmitting the media content presentation information is described below with reference to FIGS. 15 to 23. Here, the broadcast information signaling table may have an XML, HTML5 or bitstream format.

In a specific embodiment, the content provider or the broadcaster may add a descriptor including the method of transmitting the media content presentation information to the broadcast information signaling table to transmit the descriptor.

Here, the broadcast information signaling information table may be one of a program specific information (PSI) table defined in an ISO/IEC 13818-1 standard, a system information (SI) table defined in an ETSI EN 300 468 standard, and a program and system information protocol (PSIP) table defined in an ATSC standard. In particular, the signaling information table may be an information table for signaling information about broadcast content. Here, the information about broadcast content may be one of information about a broadcasting service, information about an elementary stream, and information about an event. In detail, the information table may be one of a terrestrial virtual channel table (TVCT) and an event information table (EIT) among tables defined in A/65 that is one of ATSC standards, a service map table (SMT) among tables defined in A/153, a service description table (SDT) and an EIT defined in an ETSI EN 300 468 standard, and a program map table (PMT) defined in an ISO/IEC 13818-1 standard.

The descriptor may include a tag element for identifying the descriptor.

Furthermore, the descriptor may include a length element indicating a length of the descriptor.

The descriptor may include a simulcast_flag indicating that broadcast content specified by the descriptor is simultaneously transmitted via not only a broadcasting network but also an IP network. Here, the broadcast content may be one of an elementary stream specified by the descriptor, a service specified by the descriptor, and an event specified by the descriptor. In the case where the simulcast_flag has a value of 1 and transmission of a broadcast stream via the broadcasting network is unstable, the broadcast reception apparatus 100 may receive the broadcast content specified by the descriptor via the IP network. In detail, in the case where the simulcast_flag has a value of 1 and a strength of a signal of the broadcast stream transmitted via the broadcasting network is lower than a certain reference level or presentation interruption of the broadcast content occurs, the broadcast reception apparatus 100 may receive the broadcast content specified by the descriptor via the IP network. Here, the broadcast reception apparatus 100 may notify a user that the broadcast content specified by the descriptor is able to be received. Furthermore, the broadcast reception apparatus 100 may receive the broadcast content specified by the descriptor on the basis of an input from the user. In detail, the broadcast reception apparatus 100 may receive the broadcast content specified by the descriptor via the IP network, upon receiving an input from the user.

Furthermore, the descriptor may include a version element indicating a version of the media content presentation information.

Moreover, the descriptor may include a transport_mode element indicating a specific method of transmitting the media content presentation information or the media content presentation information table. Here, a value of the transport_mode element may indicate that the descriptor directly includes the media content presentation information or the media content presentation information table. Furthermore, the value of the transport_mode element may indicate that the media content presentation information or the media content presentation information table may be downloaded via a link address included in the descriptor. The value of the transport_mode element may indicate that an information table included in a packet that is different from a packet that includes the descriptor includes the media content presentation information. The value of the transport_mode element may indicate that an additional broadcast stream includes the media content presentation information. The value of the transport_mode element may indicate that an IP datagram includes the media content presentation information or the media content presentation information table. The value of the transport_mode element may indicate that the media content presentation information or the media content presentation information table is transmitted using a session-based transport protocol. Here, the session-based transport protocol may be File Delivery over Unidirectional Transport (FLUTE). The session-based transport protocol may be Asynchronous Layered Coding (ALC)/Layered Coding Transport (LCT).

The descriptor may include a bootstrap_data element including specific transmission information corresponding to a method of transmitting the media content presentation information or the media content presentation information table. Here, in the case where the descriptor directly includes the media content presentation information, the bootstrap_data element may include the media content presentation information itself. In this case, the broadcast reception apparatus 100 may extract the media content presentation information from the descriptor.

In the case where the media content presentation information or the media content presentation information table is able to be received via a link included in the descriptor, the bootstrap_data element may include a link for downloading the media content presentation information or the media content presentation information table. In a specific embodiment, the broadcast reception apparatus 100 may access the link to download the media content presentation information or the media content presentation information table. Here, the link may be provided in plurality. Furthermore, there may be a priority order for the plurality of links. In this case, the broadcast reception apparatus 100 may attempt to download the media content presentation information or the media content presentation information table in descending order of priorities of the links. Here, the links may have a URL format.

In the case where an information table included in a packet that is different from a packet that includes the descriptor includes the media content presentation information or the media content presentation information link for providing a link to the media content presentation information, the bootstrap_data element may include an identifier of a packet that includes the media content presentation information or the media content presentation information link. Here, a table ID of the information table may be predetermined. However, in the case where the table ID of the information table is not predetermined, the bootstrap_data element may include the table ID of the information table. Here, the information table may be the above-mentioned media content presentation information table.

In the case where an additional broadcast stream includes the media content presentation information or the media content presentation information link, the bootstrap_data element may include an identifier of a packet and an identifier of the broadcast stream including the media content presentation information or the media content presentation information link. Here, in the case where the broadcast stream complies with the MPEG-2 TS standard, the identifier of the broadcast stream may be a TS ID and the packet identifier may be a PID. In detail, the information table included in the packet may include the media content presentation information or the media content presentation information link. Here, the table ID of the information table may be predetermined. However, in the case where the table ID of the information table is not predetermined, the bootstrap_data element may include the table ID of the information table. Here, the information table including the media content presentation information may be the above-mentioned media content presentation information table.

In the case where an IP datagram includes the media content presentation information or the media content presentation information table, the bootstrap_data element may include an identifier of a data transmission channel of a physical layer for downloading the IP datagram including the media content presentation information, an IP address, a port number, a flag indicating whether a source IP address is included, the source IP address, and a version of an IP address format.

In the case where the media content presentation information or the media content presentation information table is transmitted via a session-based transport protocol session, the bootstrap_data element may include an identifier of a data transmission channel of a physical layer for downloading the media content presentation information or the media content presentation information table, an identifier of a session, an IP address of the session, a port number of the session, a flag indicating whether a source IP address of the session is included, the source IP address of the session, and a version of an IP address format. As described above, the session-based transport protocol may be FLUTE. The session-based transport protocol may be ALC/LCT. In the case where the session-based transport protocol is FLUTE, the identifier of the session may be TSI that is a FLUTE session identifier.

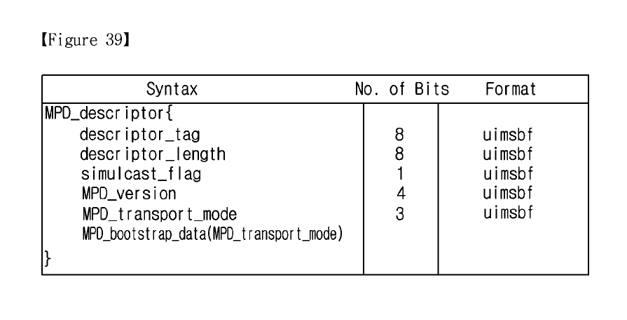

In the examples of FIGS. 39 to 45, the MPD includes the media content presentation information. Therefore, with respect to the examples of FIGS. 39 to 45, a descriptor including a method of transmitting the media content presentation information or the media content presentation information table is referred to as an MPD descriptor. Here, the MPD descriptor is included in a bitstream-type broadcast information signaling information table.

FIG. 39 illustrates a syntax of the MPD descriptor for transmitting the MPD according to an embodiment.

The MPD descriptor includes a descriptor_tag field, a descriptor_length field, an MPD_version field, a simulcast_flag field, an MPD_transport mode field, and an MPD_bootstrap_data field.

The descriptor_tag field indicates an identifier of the MPD descriptor.

The descriptor_length field indicates a length of the MPD descriptor.

The MPD_version field indicates a version of the MPD.

The simulcast_flag field indicates that broadcast content specified by the MPD descriptor is simultaneously transmitted via not only a broadcasting network but also an IP network. Here, the broadcast content may be one of an elementary stream specified by the MPD descriptor, a service specified by the MPD descriptor, and an event specified by the MPD descriptor. In the case where the simulcast_flag has a value of 1 and transmission of a broadcast stream via the broadcasting network is unstable, the broadcast reception apparatus 100 may receive the broadcast content specified by the descriptor via the IP network. In detail, in the case where the simulcast_flag has a value of 1 and a strength of a signal of the broadcast stream transmitted via the broadcasting network is lower than a certain reference level or presentation interruption of the broadcast content occurs, the broadcast reception apparatus 100 may receive the broadcast content specified by the descriptor via the IP network. Here, the broadcast reception apparatus 100 may notify the user that the broadcast content specified by the MPD descriptor is able to be received. Furthermore, the broadcast reception apparatus 100 may receive the broadcast content specified by the MPD descriptor on the basis of an input from the user. In detail, the broadcast reception apparatus 100 may receive the broadcast content specified by the MPD descriptor via the IP network, upon receiving an input from the user.

The MPD_transport mode field indicates a specific method of transmitting the MPD, the MPD information table (MPD_Section) or the MPD link table (MPD_URL_Section). Here, a value of the MPD_transport mode field may indicate that the MPD descriptor directly includes the MPD. Furthermore, the value of the MPD_transport mode field may indicate that the MPD, the MPD information table, or the MPD link table is able to be downloaded via a link address included in the MPD descriptor. The value of the MPD_transport mode field may indicate that an information table included in a packet that is different from a packet that includes the MPD descriptor includes the MPD or the MPD_URL. Here, the MPD_URL indicates a URL for downloading the MPD. Here, the information table may be the above-mentioned MPD information table. The information table may be the above-mentioned MPD link information table. The value of the MPD_transport mode field may indicate that an additional broadcast stream includes the MPD or the MPD_URL. Here, the information table may be the above-mentioned MPD information table. The information table may be the above-mentioned MPD link information table. Furthermore, the value of the MPD_transport mode field may indicate that an IP datagram includes the MPD, the MPD information table, or the MPD link table. Furthermore, the value of the MPD_transport mode field may indicate that the MPD, the MPD information table, or the MPD link table is transmitted via a session-based transport protocol session such as FLUTE or ALC/LCT. In detail, the MPD_transport mode field may be assigned values as shown in Table 36 below.

TABLE 36

| Value | Designation |
|---|---|
| 0x00 | The MPD is delivered in MPD_data_bytes( ) |
| 0x01 | The location of MPD, MPD_Section or |
| | MPD_URL_Section is identified in the URL carried |
| | in the MPD_URL. |
| 0x02 | The MPD or MPD_URL is delivered by section as |
| | separate tables (e.g., MPEG-2 private section) in |
| | same broadcast network |
| 0x03 | The MPD or MPD_URL is delivered by section as |
| | separate tables (e.g., MPEG-2 private section) in |
| | different broadcast network |
| 0x04 | The MPD, MPD_Section or MPD_URL_Section is |
| | delivered in IP datagrams |
| 0x05 | The MPD. MPD_Section or MPD_URL is delivered in |
| | sessions(e, g FLUTE, ALC/LCT etc) |
| 0x06-0x07 | Reserved for future use |

In the example of Table 36, in the case where the value of the MPD_transport mode field is 0x00, the MPD_transport mode field indicates that the MPD descriptor directly includes the MPD. In the case where the value of the MPD_transport mode field is 0x01, the MPD_transport mode field indicates that the MPD, the MPD information table, or the MPD link table is able to be downloaded via a link address included in the MPD descriptor. In the case where the value of the MPD_transport mode field is 0x02, the MPD_transport mode field indicates that an information table included in a packet that is different from a packet that includes the MPD descriptor includes the MPD or the MPD_URL. In the case where the value of the MPD_transport mode field is 0x03, the MPD_transport mode field indicates that an additional broadcast stream includes the MPD. In the case where the value of the MPD_transport mode field is 0x04, the MPD_transport mode field indicates that an IP datagram includes the MPD, the MPD information table or the MPD link table. In the case where the value of the MPD_transport mode field is 0x05, the MPD_transport mode field indicates that the MPD, the MPD information table or the MPD link table is transmitted via a transport protocol session. Here, the transport protocol may be FLUTE. Alternatively, the transport protocol may be ALC/LCT.

The MPD_bootstrap_data field includes specific transmission information according to a method of transmitting the MPD or the MPD information table. This configuration will be described in detail with reference to FIGS. 38 to 43.

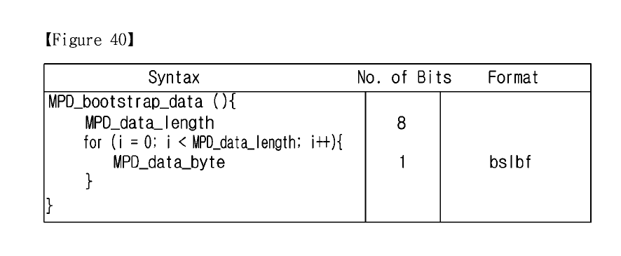

FIG. 40 illustrates a syntax of MPD bootstrap_data in the case where the MPD descriptor directly includes the MPD.

In the case where the MPD descriptor directly includes the media content presentation information, the bootstrap_data includes an MPD_data_length field and an MPD_data_byte field. The MPD_data_length field indicates a size of MPD data. The MPD_data_byte field indicates actual data of the MPD. In this case, the broadcast reception apparatus 100 may extract the MPD from the MPD descriptor.

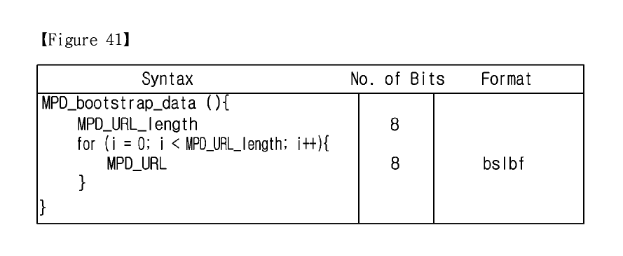

FIG. 41 illustrates the syntax of the MPD bootstrap_data in the case where the MPD descriptor includes a link address indicating a storage place of the MPD, the MPD information table or the MPD link table.

In the case where the MPD is downloadable via the link address included in the MPD descriptor, the bootstrap_data includes an MPD_URL_length field and an MPD_URL field. The MPD_URL_length field indicates a length of a URL. The MPD_URL field indicates a URL for downloading the MPD, the MPD information table or the MPD link table.

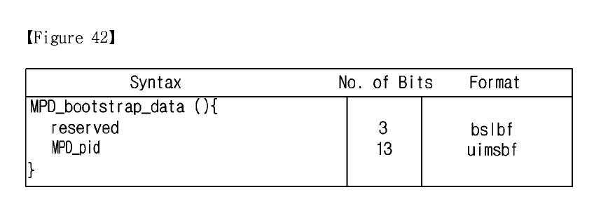

FIG. 42 illustrates the syntax of the MPD bootstrap_data in the case where the MPD descriptor includes an identifier of a data packet including the MPD.

In the case where an information table included in a packet that is different from a packet that includes the MPD descriptor includes the MPD and the MPD_URL, the bootstrap_data includes an MPD_pid field. Here, the information table may be the MPD information table as described above. Alternatively, the information table may be the MPD link information table as described above. The MPD_pid field indicates an identifier of a packet including the MPD. Here, in the case where a broadcast stream complies with the MPEG-2 TS standard, the packet identifier may be a PID. The broadcast reception apparatus 100 may extract the MPD on the basis of the MPD_pid field. The broadcast reception apparatus 100 may identify a packet including the MPD or the MPD_URL using a value of the MPD_pid field, and may extract the MPD or the MPD_URL from the packet including the MPD or the MPD_URL. Here, the table ID of the information table may be predetermined. However, in the case where the table ID of the information table is not predetermined, the bootstrap_data may include a table_id field indicating the table ID of the information table.

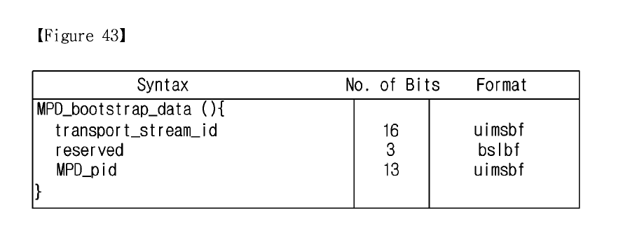

FIG. 43 illustrates the syntax of the MPD bootstrap_data in the case where the MPD descriptor includes an identifier of an additional broadcast stream including the MPD.

In the case where the additional broadcast stream includes the MPD or the MPD_URL, the bootstrap_data includes a transport_stream_id field and an MPD_pid field. The transport_stream_id field indicates an identifier of a broadcast stream including the MPD. The MPD_pid field indicates an identifier of a packet including the MPD or the MPD_URL. Here, in the case where the broadcast stream complies with the MPEG-2 TS standard, the identifier of the broadcast stream may be a TS ID and the packet identifier may be a PID. The broadcast reception apparatus 100 may extract the MPD or the MPD_URL on the basis of the transport_stream_id field and the MPD_pid field. The broadcast reception apparatus 100 may identify the broadcast stream including the MPD or the MPD_URL using the transport_stream_id field, and may identify the packet including the MPD using the MPD_pid field. Thereafter, the broadcast reception apparatus 100 may extract the MPD or the MPD_URL from the packet including the MPD or the MPD_URL. In a specific embodiment, the packet including the MPD may include the MPD information table. In another specific embodiment, the packet including the MPD_URL may include the MPD link information table. Here, the table ID of the information table may be predetermined. However, in the case where the table ID of the information table is not predetermined, the bootstrap_data may include a table_id field indicating the table ID of the information table.

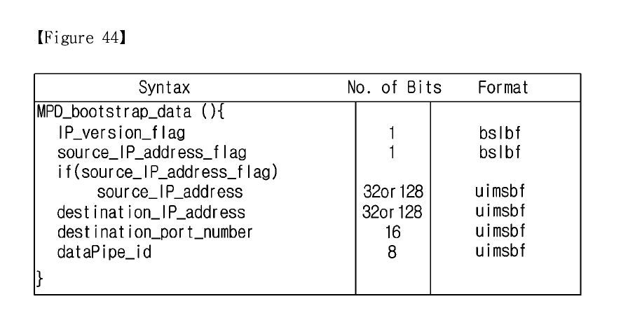

FIG. 44 illustrates the syntax of the MPD bootstrap_data in the case where the MPD descriptor includes information about an IP datagram including the MPD, the MPD information table or the MPD link information table.

In the case where the MPD descriptor includes information about an IP datagram including the MPD, the MPD information table or the MPD link information table, the bootstrap_data includes an IP_version_flag field, a source_IP_address_flag field, a source_IP_address field, a destination_IP_address field, a destination_port_number field, and a dataPipe_id field. The dataPipe_id field indicates an identifier of a data transmission channel of a physical layer. In detail, the broadcast reception apparatus 100 may obtain a specific IP datagram via a corresponding transmission channel. The IP_version_flag field indicates a version of an IP address format. The source_IP_address_flag field indicates whether a source IP address of the IP datagram including the MPD, the MPD information table or the MPD link information table is included. The destination_IP_address field indicates an IP address for downloading the IP datagram including the MPD, the MPD information table or the MPD link information table. The destination_port_number field indicates a port number for downloading the IP datagram including the MPD, the MPD information table or the MPD link information table. The broadcast reception apparatus 100 may extract the MPD, the MPD information table or the MPD link information table on the basis of the dataPipe_id field, the destination_IP_address field, and the destination_port_number field. The broadcast reception apparatus 100 may identify the data channel of the physical layer that transmits the IP datagram on the basis of the dataPipe_id field, and may extract the IP datagram including the MPD, the MPD information table or the MPD link information table on the basis of the destination_IP_address field and the destination_port_number field. Thereafter, the broadcast reception apparatus 100 may extract the MPD, the MPD information table or the MPD link information table from the IP datagram including the MPD, the MPD information table or the MPD link information table.

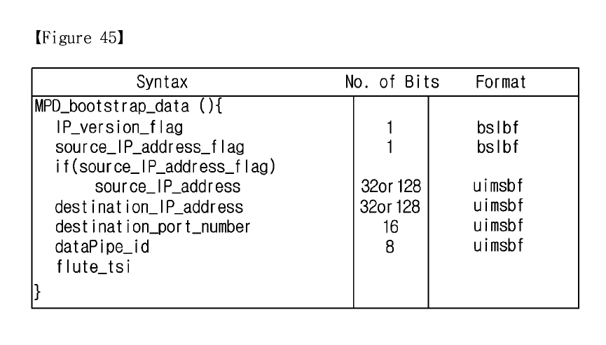

FIG. 45 illustrates the syntax of the MPD bootstrap_data in the case where the MPD descriptor includes information about a session-based transport protocol session such as FLUTE or ALC/LCT for transmitting the MPD.

In the case where the media content presentation information is transmitted via a session-based transport protocol session such as FLUTE or ACL/LCT, the bootstrap_data includes an IP_version_flag field, a source_IP_address_flag field, a source_IP_address field, a destination_IP_address field, a destination_port_number field, a dataPipe_id field, and a flute_tsi field. The IP_version_flag field indicates a version of an IP address format. The source_IP_address_flag field indicates whether a source IP address of a FLUTE session for transmitting the MPD is included. The destination_IP_address field indicates an IP address of the FLUTE session for transmitting the MPD. The destination_port_number field indicates a port number of the FLUTE session for transmitting the MPD. The dataPipe_id field indicates an identifier of a data transmission channel of a physical layer. The flute_tsi field indicates an identifier of the FLUTE session for transmitting the MPD. The broadcast reception apparatus 100 may extract the MPD, the MPD information table or the MPD link information table using the dataPipe_id field, the destination_IP_address field, and the destination_port_number field, and the flute_tsi field. In detail, the broadcast reception apparatus 100 may identify the data transmission channel of the physical channel according to a value of the dataPipe_id field, and may extract the MPD, the MPD information table or the MPD link information table using the flute_tsi field, the destination_IP_address field, and the destination_port_number field.

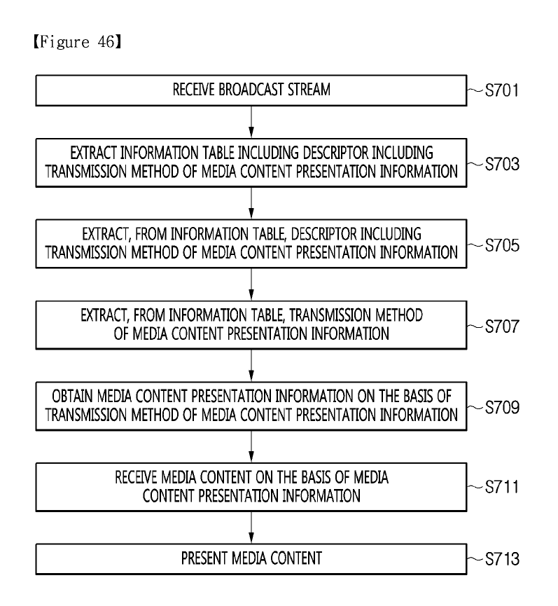

FIG. 46 is a flowchart of an operation of receiving, by a broadcast reception apparatus, the media content presentation information in the case where a method of transmitting the media content presentation information is added to the broadcast information signaling information table so as to be transmitted.

The broadcast reception apparatus 100 receives a broadcast stream via the broadcast reception unit 150 (S701).

The broadcast reception apparatus 100 extracts, via the control unit, an information table including a descriptor including the method of transmitting the media content presentation information (S703). As described above, the information table may be one of a program specific information (PSI) table defined in the ISO/IEC 13818-1 standard, a system information (SI) table defined in the ETSI EN 300 468 standard, and a program and system information protocol (PSIP) table defined in the ATSC standard. In particular, the information table may be an information table for signaling information about broadcast content. The information about broadcast content may be information about a broadcasting service, information about an elementary stream, or information about an event. In detail, the information table may be one of a terrestrial virtual channel table (TVCT) and an event information table (EIT) among tables defined in A/65 that is one of ATSC standards, a service map table (SMT) among tables defined in A/153, a service description table (SDT) and an EIT defined in the ETSI EN 300 468 standard, and a program map table (PMT) defined in the ISO/IEC 13818-1 standard.

The broadcast reception apparatus 100 extracts, via the control unit 150, the descriptor including the method of transmitting the media content presentation information from the information table (S705).

The broadcast reception apparatus 100 extracts, via the control unit 150, the method of transmitting the media content presentation information from the information table (S707). The descriptor may include a transport_mode element indicating a specific method of transmitting the media content presentation information or the media content presentation information table. The descriptor may include a bootstrap_data element including specific transmission information according to the method of transmitting the media content presentation information or the media content presentation information table. Here, the broadcast reception apparatus 100 may identify the method of transmitting the media content presentation information or the media content presentation information table on the basis of the transport_mode element, and may extract transmission information of the media content presentation information or the media content presentation information table on the basis of the bootstrap_data element. Here, as described above, the method of transmitting the media content presentation information may correspond to one of the case where the descriptor directly includes the media content presentation information, the case where the descriptor directly includes the media content presentation information table, the case where the media content presentation information or the media content presentation information table is downloadable via a link included in the descriptor, the case where a packet that is different from a packet that includes the descriptor includes the media content presentation information or the media content presentation information link, the case where an additional broadcast stream includes the media content presentation information or the media content presentation information link, the case where the bootstrap_data element includes an identifier of a broadcast stream including the media content presentation information and a packet identifier, the case where an IP datagram includes the media content presentation information or the media content presentation information table, and the case where the media content presentation information is transmitted via a session-based transport protocol.

The broadcast reception apparatus 100 obtains, via the control unit 150, the media content presentation information on the basis of the method of transmitting the media content presentation information or the media content presentation information table (S709). Here, the broadcast reception apparatus 100 may obtain the media content presentation information table via the control unit 150. The broadcast reception apparatus 100 may extract the media content presentation information from the media content presentation information table via the control unit 150.

The broadcast reception apparatus 100 receives media content via the IP transmission/reception unit 130 on the basis of the media content presentation information (S711).

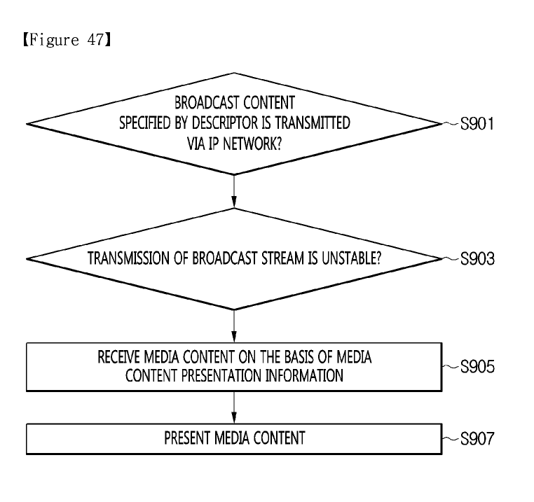

The broadcast reception apparatus 100 presents the media content via the control unit 150 (S713). In detail, the broadcast reception apparatus 100 may present the media content on the basis of the media content presentation information via the control unit 150. Here, in the case where broadcast content is transmitted via not only a broadcasting network but also an IP network, the media content may be presented on the basis of whether transmission of a broadcast stream is stable. This configuration will be described with reference to FIG. 47.

FIG. 47 is a flowchart of an operation of presenting, by a broadcast reception apparatus, media content on the basis of whether transmission of a broadcast stream is stable in the case where broadcast content is transmitted via not only a broadcasting network but also an IP network.

The broadcast reception apparatus 100 determines, via the control unit 150, whether broadcast content specified by a descriptor is transmitted via not only a broadcasting network but also an IP network (S901). In detail, the broadcast reception apparatus 100 may determine, via the control unit 150, whether a value of the simulcast_flag element included in the descriptor is 1.

In the case where the broadcast content specified by the descriptor is transmitted via the IP network, the broadcast reception apparatus 100 determines, via the control unit 150, whether transmission of a broadcast stream is stable (S903). In detail, the broadcast reception apparatus 100 may determine, via the control unit 150, whether a strength of a signal of the broadcast stream transmitted via the broadcasting network is lower than a certain reference level. In another specific embodiment, the broadcast reception apparatus 100 may determine, via the control unit 150, whether presentation interruption of the broadcast content occurs.

If the transmission of the broadcast stream is unstable, the broadcast reception apparatus 100 receives the media content via the IP transmission/reception unit 130 on the basis of the media content presentation information (S905).

The broadcast reception apparatus 100 presents the media content via the control unit 150 (S907). In detail, the broadcast reception apparatus 100 may present the media content on the basis of the media content presentation information via the control unit 150.

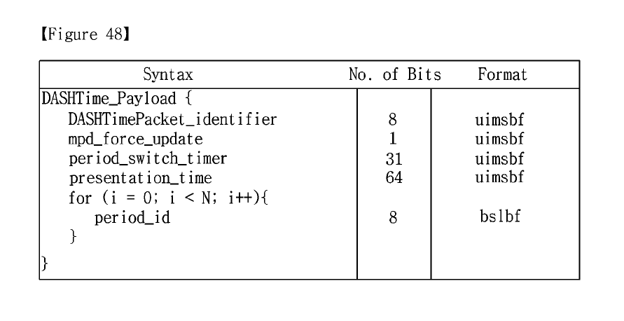

FIG. 48 illustrates a syntax of a broadcast stream packet including synchronization information of media content transmitted via a communication network according to an MPEG-DASH standard.

In the embodiment of FIG. 48, the media content may be transmitted according to the MPEG-DASH standard. Therefore, the synchronization information packet may be referred to as a DASHTime packet.

The DASHTime packet includes a DASHTimePacket_identifier field, an mpd_force_update field, a period_switch_timer field, a presentation_time field, and a period_id field.

The DASHTimePacket_identifier field indicates an identifier for identifying the DASHTime packet.

The mpd_force_update field indicates that the MPD is required to be updated prior to presentation time synchronization.

The period_switch_timer field indicates a remaining time from the broadcast stream reference time of the DASHTime packet to a start time of the period element of the MPD to be synchronized. In the case where a value of the switch_timer field is 0, the switch_timer field may indicate that a period identified by the period_id field is currently active and media content is required to be synchronized immediately. In the case where the value of the switch_timer field is not 0, the switch_timer field may indicate that the period identified by the period_id field is not in an active state currently.

The presentation_time field indicates an own presentation time of media content transmitted via an IP network which is to be synchronized with broadcast content. Here, by sing a value of the presentation_time field, it is possible to acquire a synchronized presentation time of broadcast content received before a new DASHTime packet is received. This acquisition is performed using the following equation.

MPT=(PT−PT0)/RC+(presentation_time−TimeOffset)/SegmentBase.timescale

In the equation, MPT denotes the synchronized presentation time of broadcast content received before a new DASHTime packet is received, PT0 denotes the broadcast stream reference time of the synchronization information packet, PT denotes the broadcast stream reference time of the broadcast content received before the new DASHTime packet is received, RC denotes the reference clock of a broadcast stream, presentation_time denotes the own presentation time of media content which is a value of the presentation_time field, TimeOffset denotes a media content presentation start time of a presentation interval of the media content to be synchronized by the DASHTime packet, and SegmentBase.timescale denotes a value of the timescale element of the MPD.

The period_id field enables identification of the period element of the MPD, and includes an ID of the period element of the MPD and a URL of the MPD. The broadcast reception apparatus 100 may identify media content to be synchronized and the Period element that is a presentation interval of the media content, through the period_id.

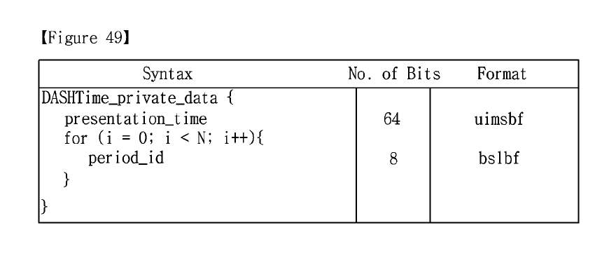

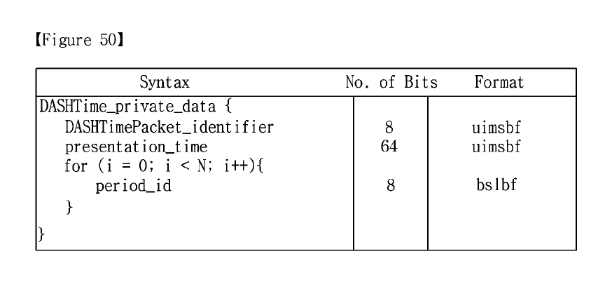

In the case where synchronization information is transmitted via an additional synchronization information packet as in the embodiment of FIG. 48, the broadcast reception apparatus 100 is required to receive an additional packet to synchronize media content with broadcast content. In general, to overcome this limitation, a header of a packet including broadcast content such as a video or an audio includes a broadcast content reference time for synchronization between elementary streams. For example, the header of a packet of a broadcast stream according to the MPEG-2 TS standard includes a PTS. Therefore, if the synchronization information is added to the header of a packet including broadcast content such as video or audio so as to be transmitted, the broadcast reception apparatus 100 may efficiently synchronize media content with broadcast content. Details will be described below with reference to FIGS. 49 and 50.

The header of a packet including broadcast content such as a video or an audio may include a presentation_time element indicating an own presentation time of media content to be synchronized with the broadcast content. Furthermore, the header may include a period_id element indicating an identifier of a presentation interval of media content to be synchronized. The header may also include an id element indicating that information for synchronization between media content and broadcast content is included.

FIG. 49 illustrates a syntax of synchronization information added to the header of a packet including broadcast content such as a video or an audio according to an embodiment of the present invention.

FIG. 50 illustrates the syntax of synchronization information added to the header of a packet including broadcast content such as a video or an audio according to another embodiment of the present invention.

In the examples of FIGS. 49 and 50, the header of a packet including broadcast content, such as video or audio, includes information for synchronization with media content transmitted according to the MPEG-DASH standard. In this case, the information for synchronization is referred to as DASHTime_private_data. The DASHTime_private_data includes a presentation_time field and a period_id field. The presentation_time field represents a presentation time of media content itself, which is synchronized with broadcast content. The period_id field enables identification of the Period element of MPD and includes an id of the Period element of the MPD and a URL of the MPD. In the embodiment of FIG. 48, the DASHTime_private_data further includes an id element indicating that the DASHTime_private_data includes information for synchronization between media content and broadcast content.

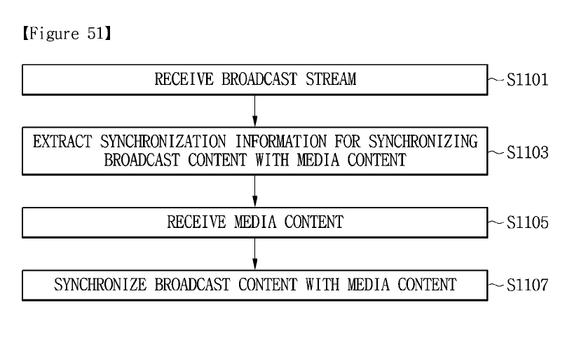

FIG. 51 is a flowchart of an operation of synchronizing, by a broadcast reception apparatus, broadcast content with media content according to an embodiment.

The broadcast reception apparatus 100 receives a broadcast steam through the broadcast reception unit 110 (S1101).

The broadcast reception apparatus 100 extracts synchronization information for synchronization between broadcast content and media content transmitted through an IP network through the control unit 150 (S1103). In a specific embodiment, the broadcast reception apparatus 100 may extract the synchronization information from a synchronization information packet through the control unit 150. In another specific embodiment, the broadcast reception apparatus 100 may extract the synchronization information from the header of a packet including broadcast content, such as video or audio, through the control unit 150.

The broadcast reception apparatus 100 receives media content through the IP transmission/reception unit 130 (S1105).

The broadcast reception apparatus 100 synchronizes the broadcast content and the media content through the control unit (S1107).

When the broadcast reception apparatus 100 receives the media content through an IP network as well as the broadcast content, it is necessary for the broadcast reception apparatus 100 to access the broadcast content based on the media content presentation information in order to enhance efficiency of interworking between broadcast content and media content.

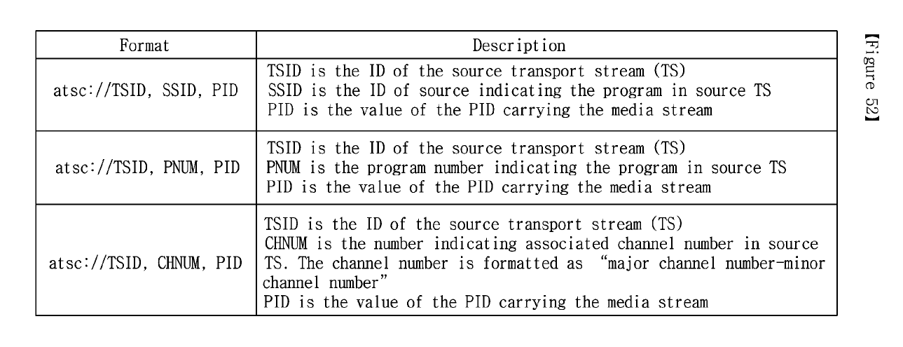

A method of including information about broadcast content in the media content presentation information and transmitting the media content presentation information will be described with reference to FIGS. 52 to 54.

The media content presentation information may include information for identifying broadcast content such that the broadcast reception apparatus 100 accesses broadcast content based on the media content presentation information. Specifically, an identifier for identifying a broadcast stream including broadcast content may be included therein. For example, when the broadcast content is transmitted according to the MPEG-2 TS standard, the media content presentation information may include a TSID. Also, an identifier for identifying a broadcast service including broadcast content may be included therein. For example, when the broadcast content is transmitted according to the MPEG-2 TS standard, the media content presentation information may include a program number. Also, when the broadcast content is transmitted according to the ATSC standard, a source id and a channel number of a virtual channel may be included therein. Also, when the broadcast content is transmitted according to the DVB standard, a service id may be included therein. Also, an identifier for identifying a packet including broadcast content may be included therein. For example, when the broadcast content is transmitted according to the MPEG-2 TS standard, the media content presentation information may include a packet ID (PID).

In a specific embodiment, the media content presentation information may include an identifier generated by combining an identifier for identifying a broadcast stream including broadcast content, an identifier for identifying a broadcast service including broadcast content, and an identifier for identifying a packet including broadcast content.

FIG. 52 illustrate a format of information for identifying broadcast content included in media content presentation information when broadcast content is transmitted according to the ATSC standard.

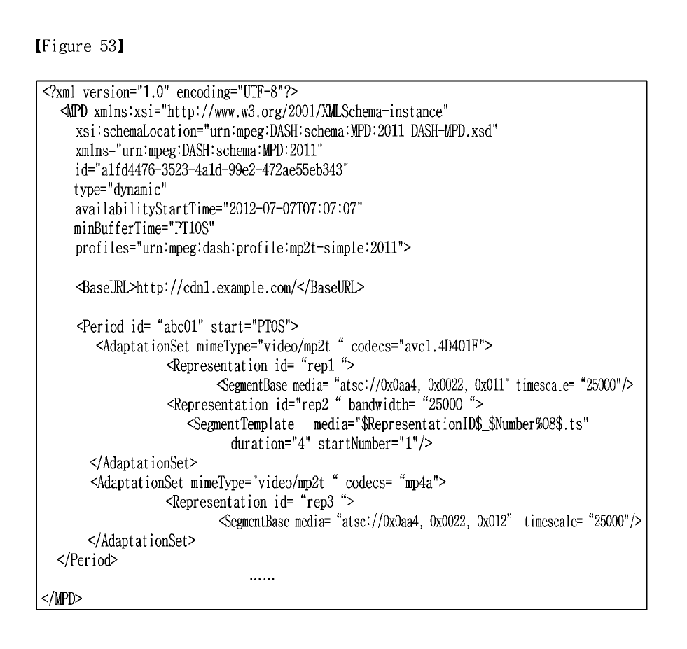

FIG. 53 illustrates an example of an MPD of MPEG-DASH including information for identifying broadcast content transmitted according to the ATSC standard.

In the embodiments of FIGS. 52 and 53, the information for identifying broadcast content may be a combination of a TSID for identifying a transport stream, an SSID for identifying a source of an elementary stream, and a PID for identifying a packet.

Also, the information for identifying broadcast content may be a combination of a TSID for identifying a transport stream, a PNUM for identifying a program stream, and a PID for identifying a packet.

Also, the information for identifying broadcast content may be a combination of a TSID for identifying a transport stream, a CHNUM for identifying a virtual channel, and a PID for identifying a packet. In this case, the CHUM for identifying a virtual channel may have a format i which a major channel number and a minor channel number are connected through symbol “-”.

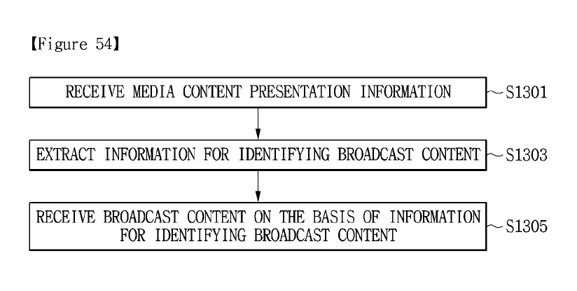

FIG. 54 is a flowchart of an operation of, by a broadcast reception apparatus, receiving broadcast content based on media content presentation information.

The broadcast reception apparatus 100 receives media content presentation information through the IP transmission/reception unit 130 (S1303).

The broadcast reception apparatus 100 extracts information for identifying broadcast content through the control unit 150 (S1303).

The broadcast reception apparatus 100 receives broadcast content based on the information for identifying broadcast content through the broadcast reception unit 110 and the control unit 150 (S1305). Specifically, the broadcast reception apparatus 100 receives a broadcast stream through the broadcast reception unit 110. In this case, the broadcast reception apparatus 100 may receive a broadcast stream based on an identifier of a broadcast stream included in the information for identifying the broadcast content. The broadcast reception apparatus 100 extracts the broadcast content based on the information for identifying broadcast content from the broadcast stream. In this case, the broadcast reception apparatus 100 may extract broadcast content based on an identifier of a broadcast service included in the information for identifying the broadcast content from the broadcast stream.

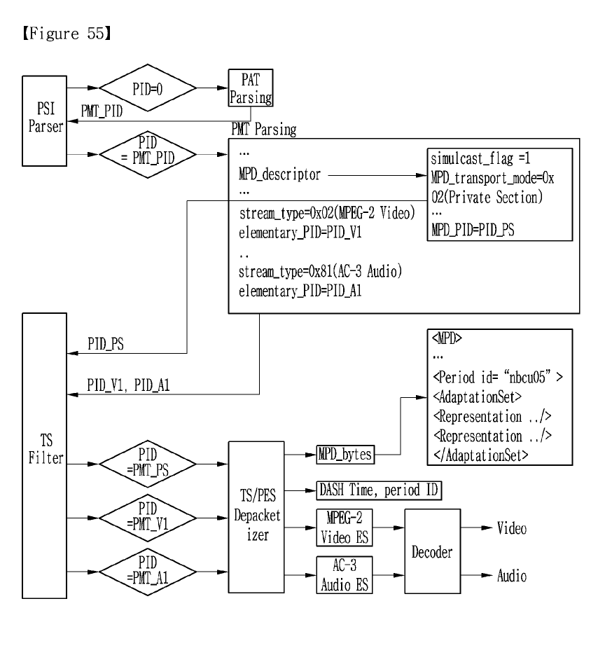

A method of receiving media content presentation information through a broadcast network by which the broadcast reception apparatus according to the above-described embodiments will be described with reference to FIGS. 55 to 57. Also, a case where the broadcast reception apparatus synchronizes broadcast content with media content will be described in detail.

FIG. 55 illustrates a block diagram for describing an example in which a broadcast reception apparatus receives an MPD of MPEG-DASH via a broadcast network for transmitting a broadcast stream according to the MPEG-2 TS standard.

According to the embodiment of FIG. 55, the control unit 150 of the broadcast reception apparatus 100 includes a PSI parser, a TS filter, a TS/PES depacketizer, and a decoder.

The TS filer extracts a packet having a specific PID from a broadcast stream.

The PSI parser extracts signaling information by parsing a PSI table, such as a program association table (PAT) or a program MAP table (PMT). In a specific embodiment, the PSI parser may extract an MPD_descriptor included in the PMT.

The TS/PES depacketizer extracts payload data from a TS/PES packet. In a specific embodiment, when the MPD is transmitted as a separate information table in the broadcast stream, the TS/PES depacketizer may extract the MPD from the separate information table based on the MPD_descriptor. Specifically, the TS/PES depacketizer may extract the MPD from an information table included in a packet corresponding to a PID included in the MPD_descriptor. Also, the TS/PES depacketizer extracts a video elementary stream and an audio elementary stream from the TS/PES packet.

The decoder decodes video and audio.

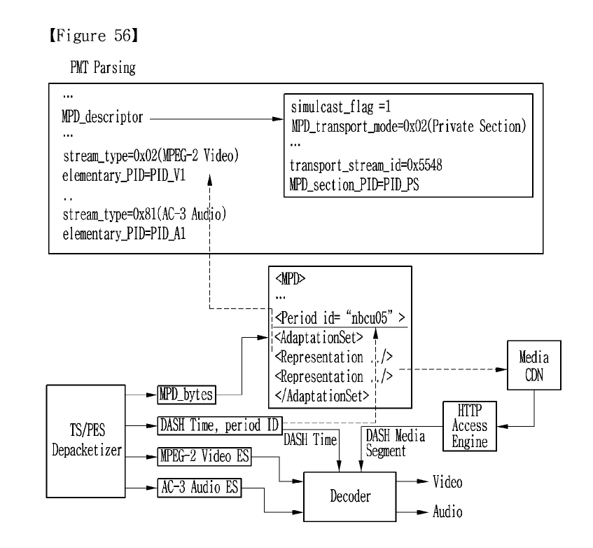

FIG. 56 is a block diagram for describing an example in which a broadcast reception apparatus synchronizes broadcast content of a broadcast stream transmitted according to the MPEG-2 TS standard with media content transmitted via a communication network.

According to the embodiment of FIG. 56, the control unit 150 of the broadcast reception apparatus 100 includes a TS/PES depacketizer and a decoder.

The TS/PES depacketizer extracts payload data from a TS/PES packet. In a specific embodiment, when the MPD is transmitted as a separate information table in the broadcast stream, the TS/PES depacketizer may extract the MPD from the separate information table based on the MPD_descriptor. Specifically, the TS/PES depacketizer may extract the MPD from an information table included in a packet corresponding to a PID included in the MPD_descriptor. Also, the TS/PES depacketizer extracts synchronization information for synchronization between media content and broadcast content from the TS/PES packet. In this case, the synchronization information may include a presentation time of the media content, an identifier form identifying, and a period element of the MPD, and an MPD URL. Also, the TS/PES depacketizer extracts a video elementary stream and an audio elementary stream from the TS/PES packet.

The IP transmission/reception unit 130 receives the media content from a media CDN server based on the MPD.

The decoder performs synchronization of the received media content based on the synchronization information and decodes the media content.

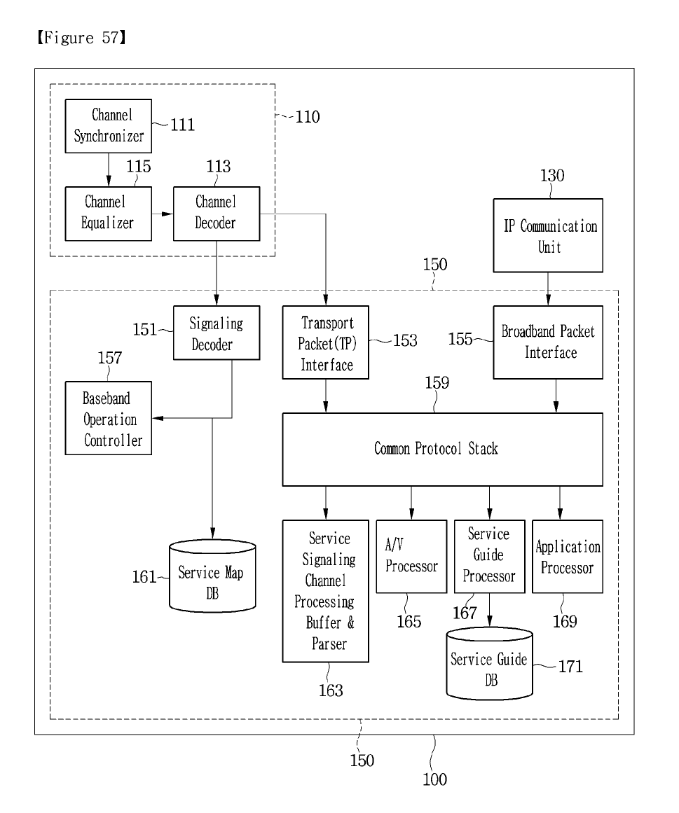

FIG. 57 illustrates a configuration of a broadcast reception apparatus according to an embodiment.

According to the embodiment of FIG. 57, the broadcast reception apparatus 100 includes a broadcast reception unit 110, an Internet protocol (IP) transmission/reception unit 130, and a control unit 150.

The broadcast reception unit 110 includes a channel synchronizer 111, a channel equalizer 113, and a channel decoder 115.

The channel synchronizer 111 synchronizes a symbol frequency and timing such that decoding is possible in a baseband in which it is possible to receive a broadcast signal.

The channel equalizer 113 compensates for a distortion in the synchronized broadcast signal. Specifically, the channel equalizer 113 compensates for a distortion in the synchronized broadcast signal due to multipath, the Doppler effect, or the like.

The channel decoder 115 decodes the distortion-compensated broadcast signal. Specifically, the channel decoder 115 extracts a transport frame from the distortion-compensated broadcast signal. In this case, the channel decoder 115 may perform forward error correction (FEC).

The IP transmission/reception unit 130 receives and transmits data through the Internet network.

The control unit 150 includes a signaling decoder 151, a transport packet interface 153, a broadband packet interface 155, a baseband operation controller 157, a common protocol stack 159, a service map database 161, a service signaling channel processing buffer and parser 163, an A/V processor 165, a broadcast service guide processor 167, an application processor 169, and a service guide database 171.

The signaling decoder 151 decodes signaling information of a broadcast signal.

The transport packet interface 153 extracts a transport packet from the broadcast signal. In this case, the transport packet interface 153 may extract signaling information and data, such as IP datagram, from the extracted transport packet.

The broadband packet interface 155 extracts an IP packet from data received from the Internet network. In this case, the broadband packet interface 155 may extract signaling data or IP datagram from the IP packet.

The baseband operation controller 157 controls an operation associated with reception of broadcast information reception information from a baseband.

The common protocol stack 159 extracts audio or video from the transport packet.

The A/V processor 547 processes audio or video.

The service signaling channel processing buffer and parser 163 parses and buffers the signaling information for signaling a broadcast service. Specifically, the service signaling channel processing buffer and parser 163 may parse and buffer the signaling information for signaling a broadcast service from the IP datagram.

The service MAP database 165 stores a broadcast service list including information about broadcast services.

The service guide processor 167 processes terrestrial broadcast service guide data for guiding programs of a terrestrial broadcast service.

The application processor 169 extracts and processes application-related information from the broadcast signal.

The service guide database 171 stores program information of the broadcast service.

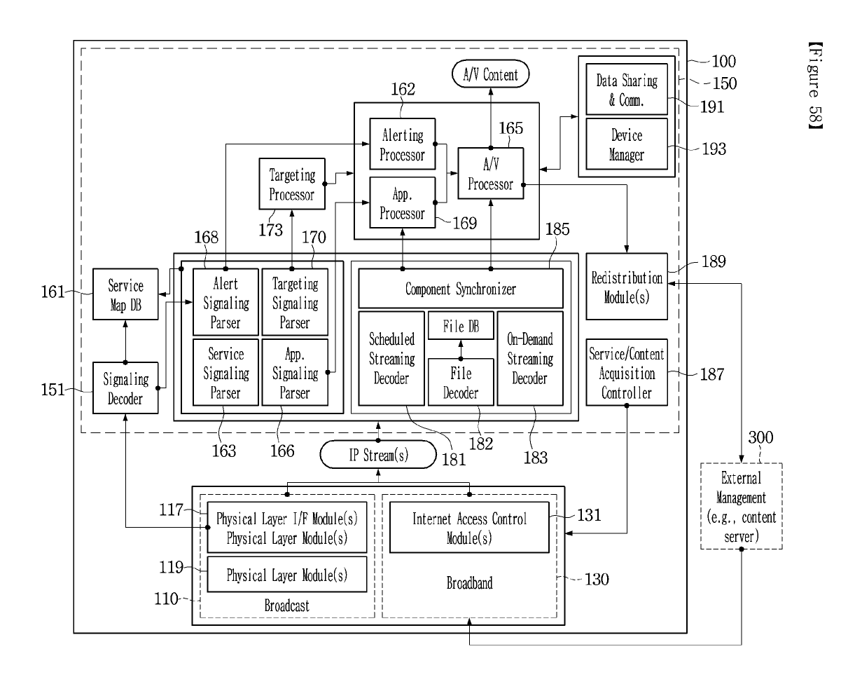

The schematic configuration and operation of the broadcast reception apparatus 100 have been described above. It is noted that the above description is focused on the operation of the conventional broadcast reception apparatus 100 and the transport protocol. Also, it is noted that the broadcast reception apparatus 100 is required to process data of various transport protocols in order to receive a hybrid broadcast service. A detailed configuration and operation of the broadcast reception apparatus 100 for receiving a hybrid broadcast will be described with reference to FIGS. 58 to 63.

FIG. 58 illustrates a configuration of a broadcast reception apparatus according to another embodiment of the present invention.

According to the embodiment of FIG. 58, the broadcast reception apparatus 100 includes a broadcast reception unit 110, an Internet protocol (IP) transmission/reception unit 130, and a control unit 150.

The broadcast reception unit 110 may include a processor or processors which respectively perform a plurality of functions to be performed by the broadcast reception unit 110, a circuit or circuits, and a hardware modules or hardware modules. Specifically, the broadcast reception unit 110 may be a system on chip (SOC) into which several semiconductor parts are integrated. In this case, the SOC may be a semiconductor into which various multimedia components, such as graphics, audio, video, and modem, a processor, and a semiconductor, such as DRAM, are integrated. The broadcast reception unit 110 may include a physical layer module 119 and a physical layer IP frame module 117. The physical layer module 119 receives and processes a broadcast-related signal through a broadcast channel of a broadcast network. The physical layer IP frame module 117 may convert a data packet, such as IP datagram acquired from the physical layer module 119, into a specific frame. For example, the physical layer module 119 may convert the IP datagram or the like into a RS frame, a GSE, or the like.

The IP transmission/reception unit 130 may include a processor or processors which respectively perform a plurality of functions to be performed by the IP transmission/reception unit 130, a circuit or circuits, and a hardware module or hardware modules. Specifically, the IP transmission/reception unit 130 may be a system on chip (SOC) into which several semiconductor parts are integrated. In this case, the SOC may be a semiconductor into which various multimedia components, such as graphics, audio, video, and modem, a processor, and a semiconductor, such as DRAM, are integrated. The IP transmission/reception unit 130 may include an Internet access control module 131. The Internet access control module 131 controls an operation of the broadcast reception apparatus 100 for acquiring at least one of a service, content, and signaling data, through a communication network (broadband).

The control unit 150 may include a processor or processors which respectively perform a plurality of functions to be performed by the control unit 150, a circuit or circuits, and a hardware module or hardware modules. Specifically, the control unit 150 may be a system on chip (SOC) into which several semiconductor parts are integrated. In this case, the SOC may be a semiconductor into which various multimedia components, such as graphics, audio, video, and modem, a processor, and a semiconductor, such as DRAM, are integrated. The control unit 150 may include at least one of a signaling decoder, a service map database 161, a service signaling channel parser 163, an application signaling parser 166, an alert signaling parser 168, a targeting signaling parser 170, a targeting processor 173, an A/V processor 165, an alerting processor 162, an application processor 169, a scheduled streaming decoder 181, a file decoder 182, a user request streaming decoder 183, a file database 184, a component synchronizer 185, a service/content acquisition controller 187, a redistribution module 189, a device manager 193, a data sharing unit 191.

The service/content acquisition controller 187 controls an operation of a receiver for acquiring the service, the content, or the signaling data associated with the content, which is acquired through a broadcast network or a communication network.

The signaling decoder 151 decodes signaling information.

The service signaling parser 163 parses service signaling information.

The application signaling parser 166 extracts and parses service-related signaling information. In this case, the service-related signaling information may be signaling information related to service scan. Also, the service-related signaling information may be signaling information related to content provided through the service.

The alert signaling parser 168 extracts and parses alerting-related signaling information.

The targeting signaling parser 170 extracts and parses information for personalization of a service and content or information for signaling targeting information.

The targeting processor 173 processes information for personalization of a service and content.

The alert signaling parser 168 processes alerting-related signaling information.

The application processor 169 controls application-related information and execution of an application. Specifically, the application processor 169 processes a state of a downloaded application and a display parameter.

The A/V processor 165 processes an audio/video rendering-related operation based on decoded audio or video, or application data.

The scheduled streaming decoder 181 decodes scheduled streaming which is content to be streamed according to a schedule determined by a content provider, such as a broadcaster.

The file decoder 182 decodes the downloaded file. In particular, the file decoder 182 decodes a file downloaded through a communication network.

The user request streaming decoder 183 decodes content provided according to a user request (on demand content).

The file database 184 stores a file. Specifically, the file database 184 may store a file downloaded through a communication network.

The component synchronizer 185 synchronizes the content or the service. Specifically, the component synchronizer 185 synchronizes content which is decoded by at least one of the scheduled streaming decoder 181, the file decoder 182, and the user request streaming decoder 183.

The service/content acquisition controller 187 controls an operation of a receiver for acquiring at least one of the service, the content, or the signaling data associated with the service or the content.

When a service or content is not received through the broadcast network, the redistribution module 189 performs an operation of supporting acquisition of at least one of the service, the content, service-related information and content-related information. Specifically, it is possible to request at least one of the content, the service-related information and the content-related information from an external management device 300. In this case, the external management device 300 may be a content server 50.

The device manager 193 manages an external device which operates in connection therewith. Specifically, the device manager 193 may perform at least one of addition, deletion and update of an external device. Also, the external device may be connected to and perform data exchange with the broadcast reception apparatus 100.

The data sharing unit 191 performs an operation of transmitting data between the broadcast reception apparatus 100 and an external device, and processes exchange-related information. Specifically, the data sharing unit 191 may transmit A/V data or the signaling information to the external device. Also, the data sharing unit 191 may receive A/V data or the signaling information from the external device.

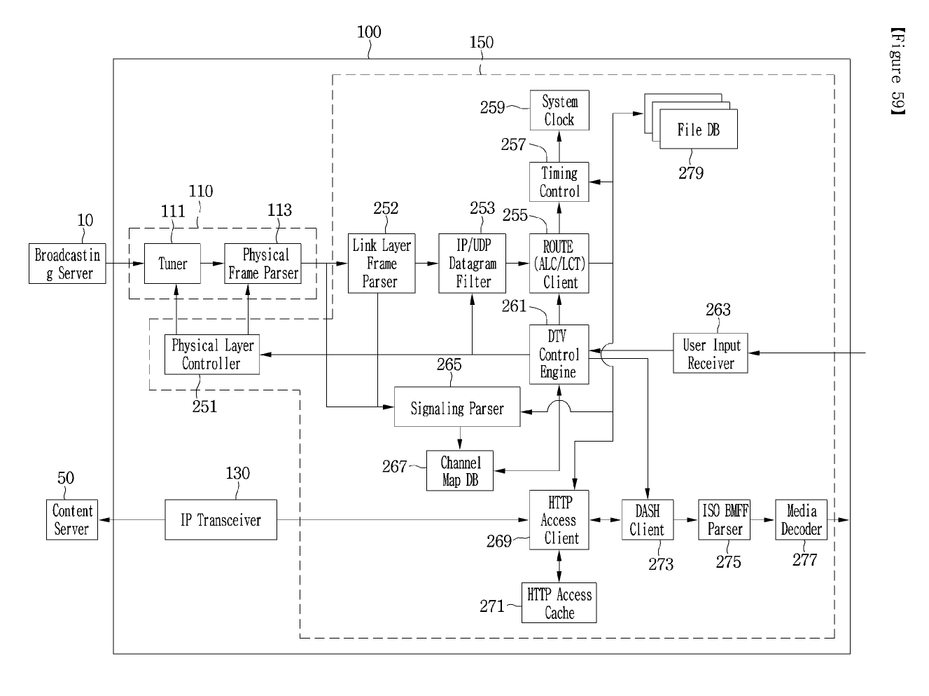

FIG. 59 illustrates a configuration of a broadcast reception apparatus according to another embodiment of the present invention.

According to the embodiment of FIG. 59, the broadcast reception apparatus 100 includes a broadcast reception unit 110, an Internet protocol (IP) transmission/reception unit 130, and a control unit 150.

The broadcast reception unit 110 may include at least one of a tuner 111 and a physical frame parser 113.

The tuner 111 receives a broadcast signal transmitted through a broadcast network. Also, the tuner 111 may convert a received broadcast signal into a physical frame form.

The physical frame parser 113 extracts a linklayer frame from a physical frame of the received broadcast signal.

The IP transmission/reception unit 130 receives and transmits IP data.

The control unit 150 may include at least one of a physical layer controller 251, a link layer frame parser 252, an IP/UDP datagram filter 253, a Route (AL/LCT) client 255, a timing control 257, a system clock 259, a DTV control engine 261, a user input receiver 263, a signaling parser 265, a channel map database 267, an HTTP access client 269, an HTTP access cache 271, a DASH client 273, an ISO BMFF parser 275, a media decoder 277, and a file database 279.

The physical layer controller 251 controls an operation of the broadcast reception unit 110. Specifically, the physical layer controller 251 may selectively receive a broadcast signal by controlling transport parameters of a broadcast signal received by the broadcast reception unit 110. For example, the physical layer controller 251 may control a frequency of a broadcast signal received by the tuner 111. Also, the physical layer controller 251 may extract a link layer frame from a broadcast signal by controlling the physical frame parser 113.

The link layer frame parser 252 extracts data corresponding to the payload of a link layer frame from the link layer frame of the broadcast signal. Specifically, the link layer frame parser 252 may extract a link layer signaling from the link layer frame. The link layer signaling signals a broadcast service through a link layer. Due to this, the broadcast reception apparatus 100 may acquire information about a broadcast service without extracting an application layer. Therefore, the broadcast reception apparatus 100 may rapidly scan broadcast services and change the broadcast services. Also, the link layer frame parser 252 may extract IP/UDP datagram from the link layer frame.

The IP/UDP datagram filter 253 extracts a specific IP/UDP datagram from the IP/UDP datagram. Since data transmission through a broadcast network or multicast through a communication network is a unidirectional communication, the broadcast reception apparatus 100 receives data other than data required by the broadcast reception apparatus 100 itself. Therefore, the broadcast reception apparatus 100 is required to extract the data required by the broadcast reception apparatus 100 itself from a data stream. The IP/UDP datagram filter 253 extracts IP/UDP datagram required by the broadcast reception apparatus 100 from an IP/UDP datagram stream. Specifically, the IP/UDP datagram filter 253 extracts IP/UDP datagram corresponding to a designated IP address and UDP port number. In this case, the IP address may include one of a source address and a destination address.

The ROUTE (AL/LCT) client 255 processes an ALC/LCT packet based on Real-time Objective delivery over Unidirectional Transport (ROUTE). The ROUTE protocol is a protocol for transmitting data in real time by using the ALC/LCT packet as an application layer protocol. The broadcast reception apparatus 100 may extract at least one of broadcast service signaling information, NRT data, and media content, from the ALC/LCT packet. In this case, the media content may be of the MPEG-DASH format. Specifically, the media content may be encapsulated with an ISO base media file format (IOS BMFF), and may be transmitted through the MPEG-DASH protocol. The broadcast reception apparatus 100 may extract the MPEG-DASH segment from the ROUTE packet. Also, the broadcast reception apparatus 100 may extract the ISO BMFF file from the MPEG-DASH segment.

The timing control 257 processes a packet including system time information which is a reference of the presentation of media content. Also, the timing control 257 may control a system clock based on the system time information.

The system clock 259 provides a reference clock that is a reference of the operation of the broadcast reception apparatus 100.

The DTV control engine 261 functions as an interface between the components. Specifically, the DTV control engine 261 may transfer a parameter for controlling an operation of each component.

The user input receiver 263 receives a user input. Specifically, the user input receiver 263 may receive at least one of a remote control input, and a key input of a user.

The signaling parser 265 extracts information about a broadcast service by transferring the information about the broadcast service and parsing broadcast service singling information for signaling a broadcast service. Specifically, the signaling parser 265 may extract the information about the broadcast service by parsing the broadcast service singling information extracted from the application layer. In another embodiment, the signaling parser 265 may extract the information about the broadcast service by parsing the broadcast service singling information extracted from a link layer.

The channel map database 267 stores information about a channel map of the broadcast service. Specifically, the signaling parser 265 may extract the information about the broadcast service and store the information about the channel map in the channel map database 267. Also, the DTV control engine 261 may acquire the information about the channel map of the broadcast service from the channel map database. In this case, the information about the channel map may include at least one of a channel number representing the broadcast service and a name of the broadcast service representing the broadcast service.

The HTTP access client 269 processes HTTP data. Specifically, the HTTP access client 269 may transmit a request to the content server 50 using HTTP and receive a response to the request from the content server 50.

The HTTP access cache 271 caches the HTTP data to improve a processing speed of the HTTP data.

The DASH client 273 processes the MPEG-DASH segment. Specifically, the DASH client 273 may process the MPEG-DASH segment received through a communication network. Also, the DASH client 273 may process an MPEG-DASH segment extracted from an application layer of a broadcast signal received through a broadcast network.

The ISO BMFF parser 275 processes an ISO BMFF packet. Specifically, the ISO BMFF parser 275 may extract media content from the ISO BMFF packet.

The media decoder 277 decodes media content. Specifically, the media decoder 277 may present the media content by decoding the media content.

The file database 279 stores a file necessary for the broadcast service. Specifically, the file database 279 may store a file extracted from the application layer of the broadcast signal.

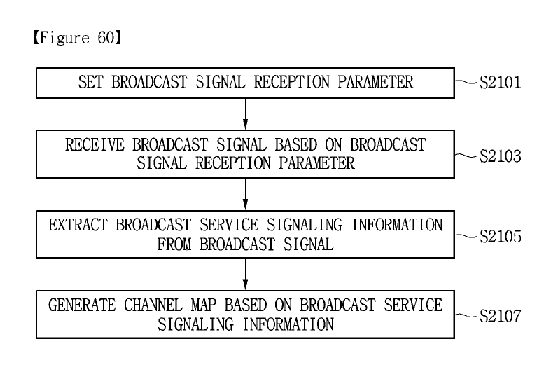

A specific operation of the broadcast reception apparatus 100 will be described with reference to FIGS. 60 to 62.

FIG. 60 is a flowchart of an operation of scanning a broadcast service and generating a channel map in the broadcast reception apparatus 100.

The control unit 150 sets a broadcast signal reception parameter. Specifically, the control unit 150 may set at least one of a frequency, a bandwidth, a symbol rate, and a physical layer pipe (PLP) identifier for broadcast signal reception. In this case, the physical layer pipe is a logical data transport channel for identifying a single radio frequency (RF) channel. The single RF channel may include a physical layer pipe or physical layer pipes. The physical layer pipe may be referred to as a data pipe (DP). In a specific embodiment, the control unit 150 may set the broadcast reception parameter based on a frequency table storing a plurality of broadcast signal reception parameters. For example, the broadcast reception apparatus 100 sequentially sets the broadcast signal reception parameters stored in the frequency table and sequentially receives broadcast signals corresponding to the broadcast signal reception parameters. In this case, the frequency table may be set according to regional standards or regional broadcast environments

The broadcast reception unit 110 receives a broadcast signal based on the broadcast signal reception parameter (S2103). Specifically, the broadcast reception unit 110 receives a broadcast signal corresponding to the broadcast signal reception parameter. The broadcast reception unit 110 may extract a physical frame of the broadcast signal by demodulating the broadcast signal.

The control unit 150 extracts broadcast service signaling information from the broadcast signal (S2105). Specifically, the control unit 150 may extract the broadcast service signaling information for signaling information about the broadcast signal from the broadcast signal. The information about the broadcast signal may include information for identifying the broadcast service. The information for identifying the broadcast service may include a channel number representing the broadcast service. Also, the information about the broadcast signal may include a broadcast service identifier for identifying the broadcast service. The information for identifying the broadcast service may include a channel number representing the broadcast service. The information for identifying the broadcast service may include a broadcast service name representing the broadcast service. The information about the broadcast service may include information for reception of the broadcast service. The information for reception of the broadcast service may include a broadcast signal reception parameter necessary for settings of the broadcast reception unit in order to receive the broadcast service. The information for reception of the broadcast service may include a broadcast stream identifier for identifying a broadcast stream through which the broadcast service is transmitted. The information for reception of the broadcast service may include a UDP port number and an IP address for identifying IP/UDP datagram through which the broadcast service is transmitted. The information for reception of the broadcast service may include a session identifier for identifying a session of a session-based transport protocol. The information for reception of the broadcast service may include a packet identifier for identifying a packet of a packet-based transport protocol. Specifically, the control unit 150 may extract the broadcast service signaling information of the link layer signaling extracted from the link layer. In another embodiment, the control unit 150 may extract the broadcast service signaling information from the application layer. As described above, when the control unit 150 receives the broadcast service signaling information from the link layer, it is possible to reduce a time taken to scan broadcast services.

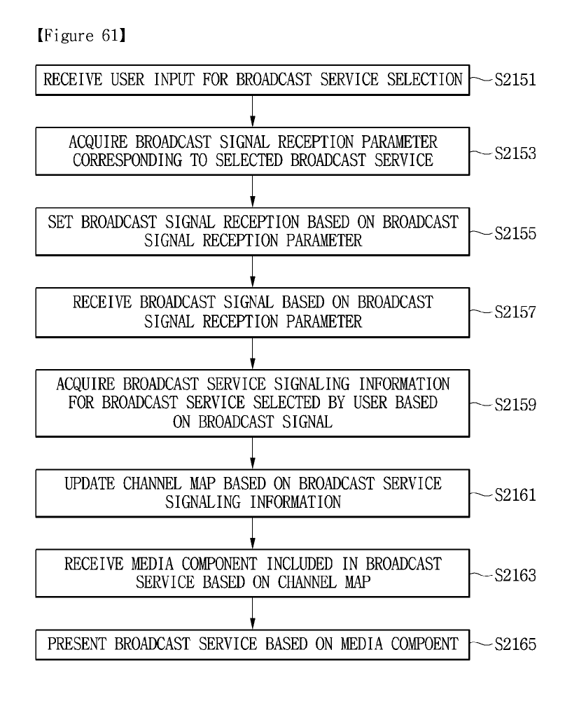

The control unit 150 generates a channel map storing information about broadcast services based on the broadcast service signaling information (S2107). Specifically, the control unit 150 generates a channel map according to information about a broadcast service provided by the broadcast service signaling information. The channel map may include at least one of information for identifying each broadcast service as described above, and information for receiving each broadcast service. Also, the control unit 150 may store the generated channel map in a channel map database 267. The broadcast reception apparatus 100 may receive a broadcast service based on the channel map. Details will be described below with reference to FIG. 61.

FIG. 61 is a flowchart of an operation of receiving, by a broadcast reception apparatus, a broadcast service.

The control unit 150 receives a user input for selection of a broadcast service (S2151). The control unit 150 may receive user input for selection of a broadcast service through the user input receiver 263. Specifically, the control unit 150 may receive an input made by a user to select any one broadcast service from a broadcast service list showing broadcast services. Also, the control unit 150 may receive a user input for a channel number, which is made by the user, through a remote control.

The control unit 150 acquires a broadcast signal reception parameter corresponding to a broadcast service selected by the user (S2153). Specifically, the control unit 150 may acquire a broadcast signal reception parameter corresponding to a broadcast service selected by the user, from the channel map. As described above, a broadcast signal reception parameter may include any one of a frequency, a bandwidth, a symbol rate, and a physical layer pipe identifier for broadcast signal reception.

The control unit 150 sets broadcast signal reception based on the broadcast signal reception parameter (S2103). Specifically, the control unit 150 may set the broadcast reception unit 110 according to broadcast signal reception parameter. For example, the control unit 150 may set at least one of the broadcast signal reception frequency, bandwidth, symbol rate, and physical layer pipe identifier of the broadcast reception unit 110. When the broadcast signal reception parameter of a broadcast signal which is being received currently is identical to an acquired broadcast signal reception parameter, the above operation may be omitted.

The broadcast reception unit 110 receives a broadcast signal based on broadcast signal reception settings (S2157). Specifically, the broadcast reception unit 110 receives and demodulates the broadcast signal.

The control unit 150 acquires signaling information for the broadcast service selected by the user based on the broadcast signal (S2159). As described above, when the control unit 150 may acquire the broadcast service signaling information from the link layer. Also, the control unit 150 may acquire the broadcast service signaling information from the link layer. The reason why the broadcast service signaling information is again acquired although the channel map includes information about broadcast services which is extracted from the broadcast service signaling information is that information about broadcast services may be changed after the generation of the channel map. Also, the reason for this is that there may be a case where basic information for generation of the channel map is acquired and information about a component included in the broadcast service or information for presentation of the broadcast service is not acquired.

The control unit 150 updates the channel map based on the broadcast service signaling information. Specifically, the control unit 150 may update the channel map when the broadcast service signaling information is changed. In a specific embodiment, the control unit 150 may update the channel map when previously-acquired broadcast service signaling information is different from the broadcast service signaling information. In a specific embodiment, the control unit 150 may compare version information previously-acquired broadcast service signaling information with version information of the broadcast service signaling information and, when the broadcast service signaling information is changed, update the channel map.

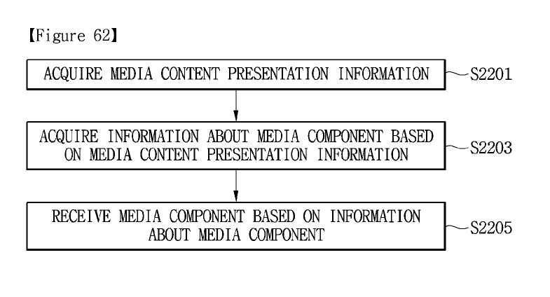

The control unit 150 receives a media component whom the broadcast service includes, based on the channel map (S2163). The channel map may include information about media component reception. Specifically, the channel map may include information for receiving a media component. The control unit 150 may acquire information for receiving a media component from the channel map, and receive the media component. For example, the control unit 150 may acquire information for identifying IP/UDP datagram for transmitting the media component from the channel map and information for identifying a session-based transport protocol packet for transmitting the media component and receive the media component. The information for identifying the IP/UDP datagram may include at least one of an IP address and a UDP port number. In this case, the IP address may include at least one of a source address and a destination address. The information for identifying the session-based transport protocol packet may include a session identifier for identifying a session. Specifically, the session identifier may be a TSI of an ALC/LCT session. In another specific embodiment, the control unit 150 may acquire information for identifying IP/UDP datagram for transmitting the media component from the channel map and information for identifying a packet-based transport protocol packet for transmitting the media component and receive the media component. The broadcast reception apparatus 100 may receive a media component based on the media content presentation information. Details will be described below with reference to FIG. 62.

FIG. 62 is a flowchart of an operation of acquiring, by a broadcast reception apparatus, a media component based on media content presentation information.

The broadcast reception apparatus 100 acquires media content presentation information (S2201). As described above, the broadcast reception apparatus 100 may acquire media content presentation information through a signaling message of a broadcast signal.

The broadcast reception apparatus 100 acquires information about the media component based on the media content presentation information (S2203). The information about the media component may include the information for media component reception described above. Also, the media content presentation information related to a broadcast service may include information about presentation of media content associated with the broadcast service.

The broadcast reception apparatus 100 may receive the media component based on the information about the media component (S2205). The broadcast reception apparatus 100 may receive the media component through a broadcast network. Also, the broadcast reception apparatus 100 may receive the media component through a communication network. Also, the broadcast reception apparatus 100 may receive any one of a plurality of media components through the broadcast network and receive another of the plurality of media components through the communication network. For example, the broadcast reception apparatus 100 may receive a video component through the broadcast network and receive an audio component through the communication network.

Again, the operation of the broadcast reception apparatus 100 is described with reference to FIG. 61.

The control unit 150 presents a broadcast service based on the media component (S2165).

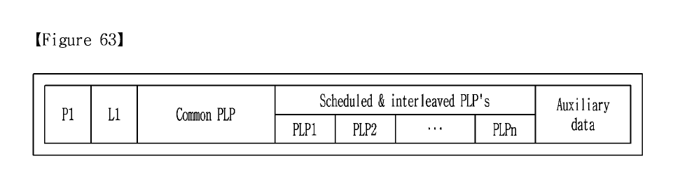

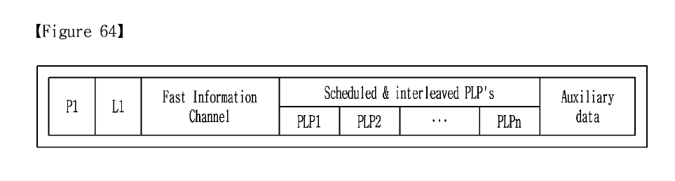

A transport frame used in a hybrid broadcast will be described with reference to FIGS. 63 and 64.

FIG. 63 illustrates a broadcast transport frame according to an embodiment of the present invention.

In the embodiment of FIG. 63, the broadcast transport frame includes a P1 part, an L1 part, a common PLP part, a scheduled and interleaved PLP part, and an auxiliary data part.

In the embodiment of FIG. 63, the broadcast transmission apparatus transmits information for transport signal detection through the P1 part of the broadcast transport frame. Also, the broadcast transmission apparatus may transmit tuning information for broadcast signal tuning through the P1 part.

In the embodiment of FIG. 63, the broadcast transmission apparatus transmits a configuration of the broadcast transport frame and characteristics of each PLP through the L1 part. In this case, the broadcast reception apparatus 100 may acquire the configuration of the broadcast transport frame and the characteristics of each PLP by decoding the L1 part based on the P1.

In the embodiment of FIG. 63, the broadcast transmission apparatus may transmit information to be applied commonly to PLPs through the common PLP part. In the specific embodiment, the broadcast transport frame may not include the common PLP part.

In the embodiment of FIG. 63, the broadcast transmission apparatus may transmit a plurality of components included in the broadcast service through the scheduled and interleaved PLP part. In this case, the scheduled and interleaved PLP part includes a plurality of PLPs.

In the embodiment of FIG. 63, the broadcast transmission apparatus may signal to which PLP each component constituting the broadcast service is transmitted, through the L1 part or the common PLP part. It is noted that the broadcast reception apparatus 100 is required to decode all of the plurality of PLPs of the scheduled and interleaved PLP part in order to acquire specific broadcast service information for scanning of broadcast services.

Unlike the embodiment of FIG. 63, the broadcast transmission apparatus may transmit a broadcast transport frame including a separate part including information about a broadcast service transmitted through the broadcast transport frame and a component included in the broadcast service. In this case, the broadcast reception apparatus 100 may rapidly receive information about the broadcast service and components included in the broadcast service, through the separate part. Details will be described below with reference to FIG. 64.

FIG. 64 illustrates a broadcast transport frame according to another embodiment of the present invention.

In the embodiment of FIG. 64, the broadcast transport frame includes a P1 part, an L1 part, a fast information channel (FIC) part, a common PLP part, a scheduled & interleaved PLP part, and an auxiliary data part.

The parts other than the FIC part are the same as the embodiment of FIG. 63.

The broadcast transmission apparatus transmits fast information through the FIC part. The fast information may include configuration information of a broadcast stream transmitted through the transport frame, simple broadcast service information, and component information. The broadcast reception apparatus 100 may scan a broadcast service based on the FIC part. Specifically, the broadcast reception apparatus 100 may extract information about a broadcast service from the FIC part. The fast information may be referred to as link layer signaling. The broadcast reception apparatus 100 may acquire broadcast service information and component information by parsing only the link layer, without parsing an application layer.

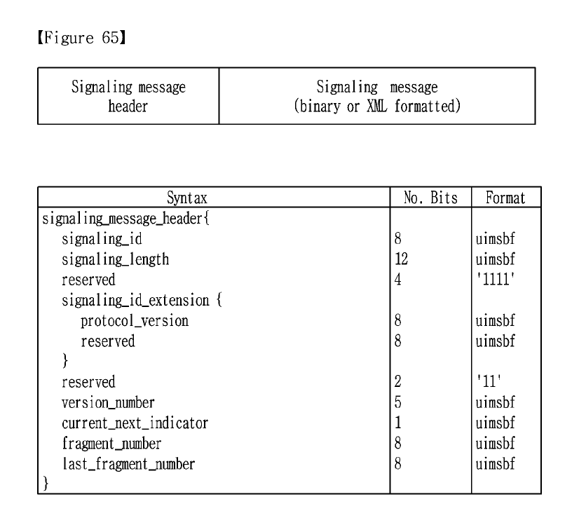

FIG. 65 illustrates a configuration of a service signaling message, according to an embodiment of the present invention. Specifically, FIG. 65 may illustrate a syntax of a header of a service signaling message according to an embodiment of the present invention. The service signaling message according to the present embodiment of the present invention may include a signaling message header and a signaling message. In this case, the signaling message may be expressed in a binary format or an XML format. Also, the service signaling message may be included in the payload of a transport protocol packet.

The signaling message header according to the embodiment of FIG. 65 may include identification information for identifying the signaling message. For example, the signaling message may have the form of a session. In this case, the identification information of the signaling message may indicate an identifier (ID) of a signaling table session. A field indicating the identification information of the signaling message may be a signaling_id field. In a specific embodiment, the signaling_id field may be eight bits.

Also, the signaling message header according to the embodiment of FIG. 65 may include length information indicating a length of the signaling message. A field indicating the length information of the signaling message may be a signaling_length field. In a specific embodiment, the signaling_length field may be 12 bits.

Also, the signaling message header according to the embodiment of FIG. 65 may include identifier extension information for extending the identifier of the signaling message. In this case, the identifier extension information may be information for identifying signaling along with the signaling identifier information. The field indicating the identifier extension information of the signaling message may be a signaling_id_extension field.

The identifier extension information may include protocol version information of the signaling message. A field indicating the protocol version information of the signaling message may be a protocol_version field. In a specific embodiment, the protocol_version field may be 8 bits.

Also, the signaling message header according to the embodiment of FIG. 65 may include version information of the signaling message. The version information of the signaling message may be changed when content included in the signaling message is changed. A field indicating the version information of the signaling message may be a version_number field. In a specific embodiment, the version_number field may be 5 bits.

Also, the signaling message header according to the embodiment of FIG. 65 may include information indicating whether the signaling message is currently available. A field indicating whether the signaling message is currently available may be a current_next_indicator field. In a specific example, when the current_next_indicator field is 1, the current_next_indicator field may indicate that the signaling message is available. In another example, when the current_next_indicator field is 0, the current_next_indicator field may indicate that the signaling message is unavailable, and another signaling message is available, the another signaling message including the same signaling identifier information, signaling identifier extension information, or fragment number information.

Also, the signaling message header according to the embodiment of FIG. 65 may include fragment number information of the signaling message. One signaling message may be divided into a plurality of fragments and then transmitted. Therefore, information for identifying, by a receiver, the plurality of fragments resulting from division may be fragment number information. A field indicating the fragment number information may be a fragment_number field. In a specific embodiment, the fragment_number field may be 8 bits.

Also, when one signaling message is divided into a plurality of fragments and then transmitted, the signaling message header according to the embodiment of FIG. 65 may include information about the last fragment number. When the information about the last fragment number indicates 3, it may represent that the signaling message is divided into three fragments and then transmitted. Also, it is possible to indicate that a fragment including the fragment number of 3 includes the last data of the signaling message. A field indicating information about the last fragment number may be a last_fragment_number field. In a specific embodiment, the last_fragment_number field may be 8 bits.

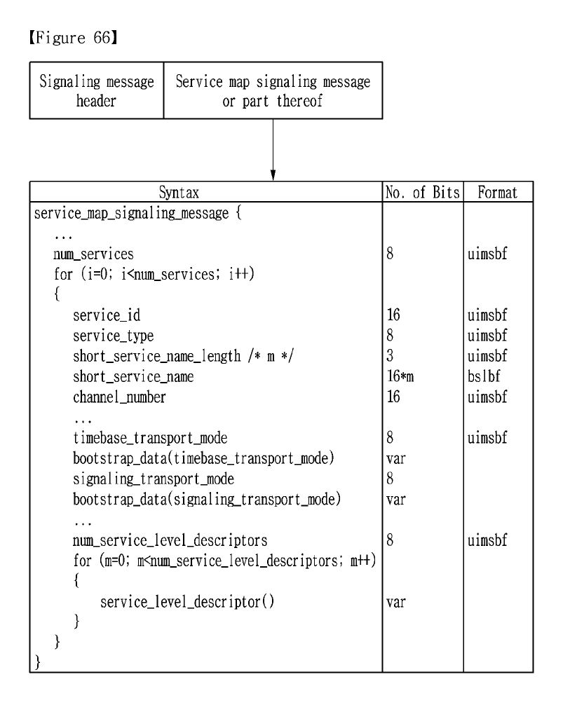

FIG. 66 illustrates a configuration of a broadcast service signaling message in a future broadcast system, according to an embodiment of the present invention. The broadcast service signaling message according to the present embodiment of the present invention is a broadcast service signaling method for allowing the broadcasting receiving apparatus 100 to receive at least one of a broadcast service and content from the future broadcasting system.

The broadcast service signaling method according to the embodiment of FIG. 66 may be based on the configuration of the signaling message illustrated in FIG. 65. The broadcast service signaling message according to the embodiment of FIG. 66 may be transmitted via a service signaling channel. In this case, the service signaling channel may be a sort of physical layer pipe for directly transmitting service signaling information for broadcast service scan without passing through another layer. In a specific embodiment, the service signaling channel may be referred to as at least one of a fast information channel (FIC), a low layer signaling (LLS), and an application layer transport session. Also, a broadcast service signaling message header according to the embodiment of FIG. 66 may have an XML format.

Also, the service signaling message according to the embodiment of FIG. 66 may include information about the number of services included therein. Specifically, a single service signaling message may include a plurality of services and include information indicating the number of services included therein. The information about the number of services may be a num_services field. In a specific embodiment, the num_services field may be 8 bits.

Also, the service signaling message according to the embodiment of FIG. 66 may include identifier information of services. The identifier information may be a service_id field. In a specific embodiment, the service_id field may be 16 bits.

Also, the service signaling message according to the embodiment of FIG. 66 may include service type information. The service type information may be a service_type field. In a specific embodiment, the service_type field has a value of 0x00, a service type indicated by the signaling message may be a scheduled audio service.

In another embodiment, the service_type field has a value of 0x01, a service type indicated by the signaling message may be a scheduled audio/video service. In this case, the scheduled audio/video service may be an audio/video service to be broadcast according to a predetermined schedule.

In another embodiment, the service_type field has a value of 0x02, a service type indicated by the signaling message may be a on-demand service. In this case, the on-demand service may be an audio/video service to be presented in response to a user request. Also, the on-demand service may be a service opposite to the scheduled audio/video service.

In another embodiment, the service_type field has a value of 0x03, a service type indicated by the signaling message may be an app-based service. In this case, the app-based service is a non-realtime service, not a realtime broadcast service, and may be a service to be provided through an application. The app-based service may include at least one of a service associated with a realtime broadcast service and a service not associated with a realtime broadcast service. The broadcasting receiving apparatus 100 may download an application and provide an app-based service.

In another embodiment, the service_type field has a value of 0x04, a service type indicated by the signaling message may be a right issuer service. In this case, the right issuer service may be a service to be provided to a person who is issued a right to receive a service.

In another embodiment, the service_type field has a value of 0x05, a service type indicated by the signaling message may be a service guide service. In this case, the service guide service may be a service for providing information about services to be provided. For example, the information about services to be provided may be a broadcast schedule.

Also, the service signaling message according to the embodiment of FIG. 66 may include service name information. The service name information of services may be a short_service_name field.

Also, the service signaling message according to the embodiment of FIG. 66 may include length information of the short_service_name field. The length information of the short_service_name field may be a short_service_name_length field.

Also, the service signaling message according to the embodiment of FIG. 66 may include broadcast service channel number information associated with a service which is signaled. The associated broadcast service channel number information may be a channel_number field.

Also, the service signaling message according to the embodiment of FIG. 66 may include data necessary for the broadcasting receiving apparatus to acquire a timebase or a signaling message according to transport modes to be described below. The data for acquiring the timebase or the signaling message may be a bootstrap( ) field.

The above-described transport mode may be at least one of a timebase transport mode and a signaling transport mode. The timebase transport mode may be a transport mode for a timebase including metadata for a timeline used by a broadcast service. The timeline is a series of time information for media content. Specifically, the timeline may be a series of reference time which are references for media content presentation. The information for the timebase transport mode may be a timebase_transport_mode field.

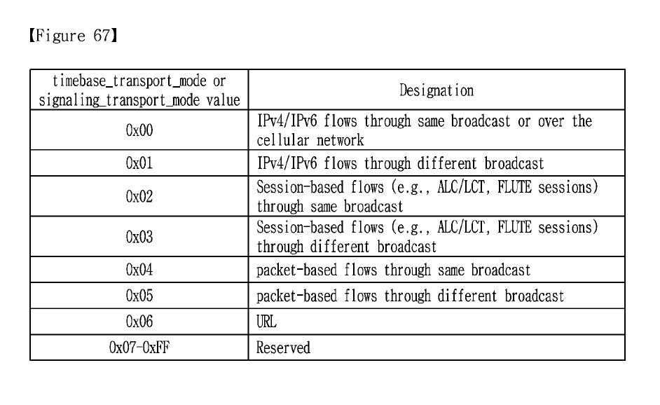

Also, the signaling transport mode may be a mode for transmitting a signaling message used in a broadcast service. The information for the signaling transport mode may be a signaling_transport_mode mode. Content indicated by a value possessed by each of the fields in FIG. 67 will be described below.

FIG. 67 illustrates content meant by a value indicated by a timebase_transport_mode field and a signaling_transport_mode field in a service signaling message, according to an embodiment of the present invention.

The timebase transport mode may include a mode in which the broadcasting receiving apparatus 100 acquires a timebase of a broadcast service through an IP datagram in the same broadcast stream. According to the embodiment of FIG. 67, when the timebase_transport_mode field has a value of 0x00, the timebase_transport_mode field may indicate that the broadcasting receiving apparatus can acquire a timebase of a broadcast service through IP datagram in the same broadcast stream.

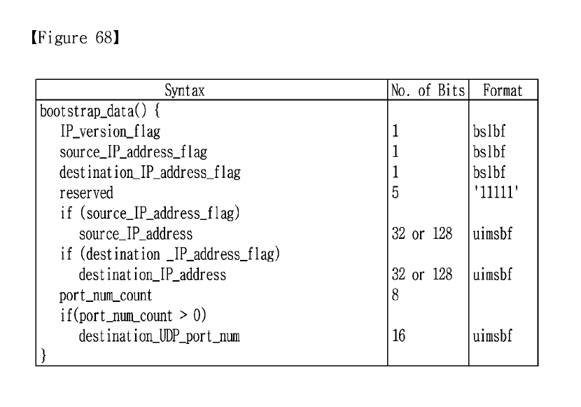

Also, the signaling transport mode may include a mode in which the broadcasting receiving apparatus 100 acquires a signaling message used in a broadcast service through an IP datagram in the same broadcast stream. According to another embodiment of FIG. 67, when the signaling_transport_mode field has a value of 0x00, the signaling_transport_mode field may indicate that the broadcasting receiving apparatus can acquire a signaling message used in a broadcast service through an IP datagram in the same broadcast stream. The same broadcast stream may be the same broadcast stream as a broadcast stream through which the broadcasting receiving apparatus currently receives a service signaling message. Also, the IP datagram may be a transmission unit which is formed by encapsulating a component constituting a broadcast service or content according to the Internet protocol. In this case, the bootstrap( ) field for the timebase and the signaling message may comply with the syntax illustrated in FIG. 68. The syntax illustrated in FIG. 68 may be expressed in the format of XML.

FIG. 68 illustrates a syntax of the bootstrap( ) field when the timebase_transport_mode field and the signaling_transport_mode field have a value of 0x00, according to an embodiment of the present invention.

In the embodiment of FIG. 68, bootstrap data may include information about an IP address format of an IP datagram including a timebase or a signaling message. The information about the IP address format may be an IP_version_flag field. The information about the IP address format may indicate that the IP address format of the IP datagram is IPv4. According to an embodiment, when the information about the IP address format is 0, the information about the IP address format may indicate that the IP address format of the IP datagram is IPv4. The information about the IP address format may indicate that the IP address format of the IP datagram is IPv6. According to another embodiment, when the information about the IP address format is 0, the information about the IP address format may indicate that the IP address format of the IP datagram is IPv6.

In the embodiment of FIG. 68, the bootstrap data may include information indicating whether an IP datagram including a timebase or a signaling message includes a source IP address. In this case, the source IP address may be a source address of the IP datagram. The information indicating whether the IP datagram includes a source IP address may be a source_IP_address_flag field. In an embodiment, when the source_IP_address_flag field is 1, it may indicate that the IP datagram includes a source IP address.

In the embodiment of FIG. 68, the bootstrap data may include information indicating whether an IP datagram including a timebase or a signaling message includes a destination IP address. In this case, the destination IP address may be a destination address of the IP datagram. The information indicating whether the IP datagram includes a destination IP address may be a destination_IP_address_flag field. In an embodiment, when the destination_IP_address_flag field is 1, it may indicate that the IP datagram includes a destination IP address.

In the embodiment of FIG. 68, bootstrap data may include source IP address information of an IP datagram including a timebase or a signaling message. The source IP address information may be a source_IP_address field.

In the embodiment of FIG. 68, bootstrap data may include destination IP address information of an IP datagram including a timebase or a signaling message. The destination IP address information may be a destination_IP_address field.

In the embodiment of FIG. 68, bootstrap data may include information indicating the number of flow ports of an IP datagram including a timebase or a signaling message. In this case, the ports may be channels for receiving the flows of the IP datagram. The information indicating the number of user datagram protocol (UDP) ports of the IP datagram may be a port_num_count field.

In the embodiment of FIG. 68, the bootstrap data may include information indicating a UDP port number of an IP datagram including a timebase or a signaling message. The UDP is a communication protocol using a unidirectional communication scheme in which information is transmitted via Internet uni-directionally, not bi-directionally.

Referring back to FIG. 67, details will be described.

The timebase transport mode may be a mode for acquiring a timebase of a broadcast service through an IP datagram in another broadcast stream. According to another embodiment of FIG. 67, when the timebase_transport_mode field has a value of 0x01, the timebase_transport_mode field may indicate that it is possible to acquire a timebase of a broadcast service through an IP datagram in another broadcast stream The another broadcast stream may be a broadcast stream different from a broadcast stream through which a current service signaling message is received.

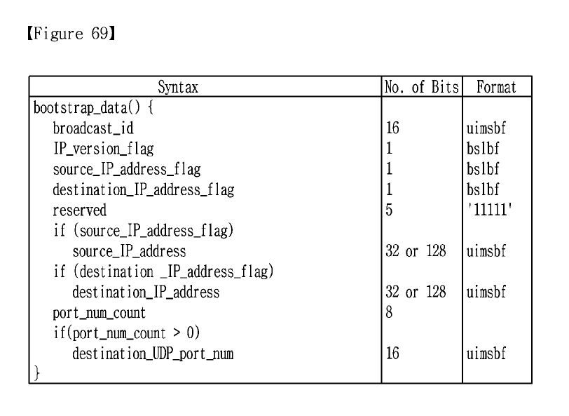

Also, the signaling transport mode may include a mode in which the broadcasting receiving apparatus 100 acquires a signaling message used in a broadcast service through an IP datagram in another broadcast stream. According to another embodiment of FIG. 67, when the signaling_transport_mode field has a value of 0x01, the signaling_transport_mode field may indicate that it is possible to acquire a signaling message used in a broadcast service through an IP datagram in another broadcast stream. In this case, the bootstrap( ) field for the timebase and the signaling message may comply with the syntax illustrated in FIG. 69. The syntax illustrated in FIG. 69 may be expressed in the format of XML.

Also, bootstrap data according to the embodiment of FIG. 69 may include identifier information of a broadcaster which transmits the signaling message. Specifically, the bootstrap data may include unique identifier information of a specific broadcaster which transmits a signaling message through a specific frequency or a transmission frame. The identifier information of a broadcaster may be a broadcasting_id field. Also, the identifier information of a broadcaster may be identifier information of a transport stream for transmitting a broadcast service.

Referring back to FIG. 67, details will be described.

The timebase transport mode may include a mode in which the broadcasting receiving apparatus 100 acquires a timebase through a session-based flow in the same broadcast stream.

According to the embodiment of FIG. 67, when the timebase_transport_mode field has a value of 0x02, it may indicate that it is possible to acquire a timebase of a broadcast service through a session-based flow in the same broadcast stream. Furthermore, the signaling transport mode may include a mode in which the broadcasting receiving apparatus 100 acquires a signaling message through a session-based flow in the same broadcast stream. When the signaling_transport_mode field has a value of 0x02, it may indicate that it is possible to acquire a signaling message used in a broadcast service through an application layer transport session-based flow in the same broadcast stream. In this case, the application layer transport session-based flow may be one of an Asynchronous Layered Coding (ALC)/Layered Coding Transport (LCT) session and a File Delivery over Unidirectional Transport (FLUTE) session.

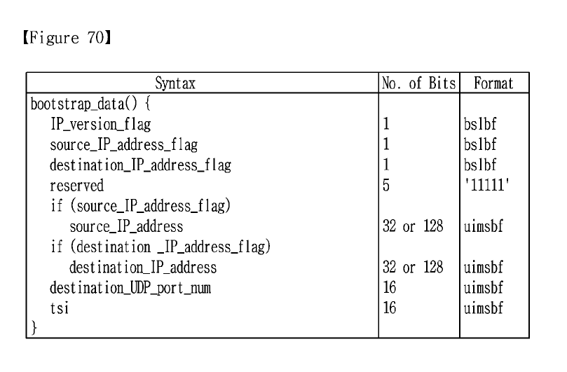

In this case, the bootstrap( ) field for the timebase and the signaling message may comply with the syntax illustrated in FIG. 70. The syntax illustrated in FIG. 70 may be expressed in the format of XML.

The bootstrap data according to the embodiment of FIG. 70 may include identifier (transport session identifier) information of the application layer transport session for transmitting an application layer transport packet including a timebase or a signaling message. In this case, the session for transmitting the transport session may be one of an ALC/LCT session and a FLUTE session. The identifier information of the application layer transport session may be a tsi field.

Referring back to FIG. 67, details will be described.

The timebase transport mode may include a mode in which the broadcasting receiving apparatus 100 acquires a timebase through a session-based flow in another broadcast stream. According to the embodiment of FIG. 67, when the timebase_transport_mode field has a value of 0x03, it may indicate that it is possible to acquire a timebase of a broadcast service through a session-based flow in another broadcast stream. Furthermore, the signaling transport mode may include a mode in which the broadcasting receiving apparatus 100 acquires a signaling message through a session-based flow in the same broadcast stream. When the signaling_transport_mode field has a value of 0x02, it may indicate that it is possible to acquire a signaling message used in a broadcast service through an application layer transport session-based flow in another broadcast stream. In this case, the application layer transport session-based flow may be one of an ALC/LCT session and an FLUTE session.

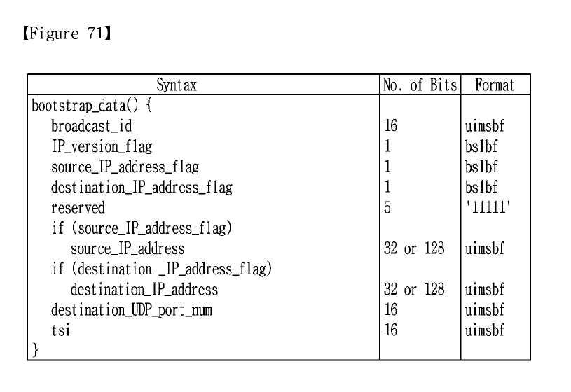

In this case, the bootstrap( ) field for the timebase and the signaling message may comply with the syntax illustrated in FIG. 71. The syntax illustrated in FIG. 71 may be expressed in the format of XML.

Also, the bootstrap data according to the embodiment of FIG. 71 may include identifier information of a broadcaster which transmits a signaling message. Specifically, the bootstrap data may include unique identifier information of a specific broadcaster which transmits the signaling message through a specific frequency or a transmission frame. The identifier information of a broadcaster may be a broadcasting_id field. Also, the identifier information of a broadcaster may be identifier information of a transport stream of a broadcast service.

Referring back to FIG. 67, details will be described.

The timebase transport mode may include a mode in which the broadcasting receiving apparatus 100 acquires a timebase through a packet-based flow in the same broadcast stream. According to the embodiment of FIG. 67, when the timebase_transport_mode field has a value of 0x04, it may indicate that it is possible to acquire a timebase of a broadcast service through a packet-based flow in the same broadcast stream. In this case, the packet-based flow may be an MPEG media transport (MMT) packet flow.

Furthermore, the signaling transport mode may include a mode in which the broadcasting receiving apparatus 100 acquires a signaling message through a packet-based flow in the same broadcast stream. When the signaling_transport_mode field has a value of 0x04, it may indicate that it is possible to acquire a signaling message used in a broadcast service through a packet-based flow in the same broadcast stream. In this case, the packet-based flow may be an MMT packet flow.

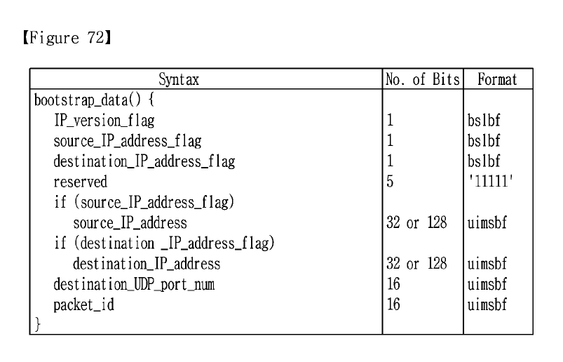

In this case, the bootstrap( ) field for the timebase and the signaling message may comply with the syntax illustrated in FIG. 72. The syntax illustrated in FIG. 72 may be expressed in the format of XML.

The bootstrap data according to the embodiment of FIG. 72 may include identification information of a transport packet for transmitting a timebase or a signaling message. The identifier information of the transport packet may be a packet_id field. The identifier information of the transport packet may be identifier information of an MPEG-2 transport stream.

Referring back to FIG. 67, details will be described.

The timebase transport mode may include a mode in which the broadcasting receiving apparatus 100 acquires a timebase through a packet-based flow in another broadcast stream.

According to the embodiment of FIG. 67, when the timebase_transport_mode field has a value of 0x05, it may indicate that it is possible to acquire a timebase of a broadcast service through a packet-based flow in another broadcast stream. In this case, the packet-based flow may be an MPEG media transport flow.

Furthermore, the signaling transport mode may include a mode in which the broadcasting receiving apparatus 100 acquires a signaling message through a packet-based flow in another broadcast stream. When the signaling_transport_mode field has a value of 0x05, it may indicate that it is possible to acquire a signaling message used in a broadcast service through a packet-based flow in another broadcast stream. In this case, the packet-based flow may be an MMT packet flow.

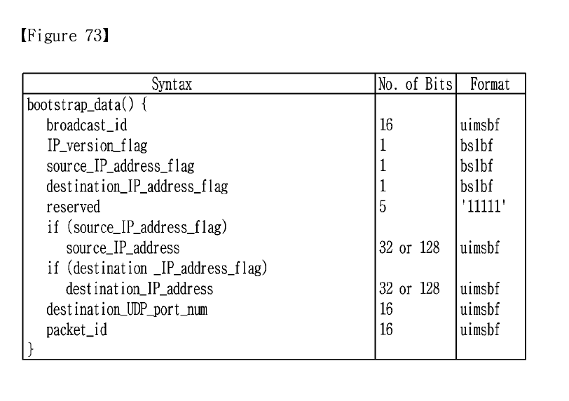

In this case, the bootstrap( ) field for the timebase and the signaling message may comply with the syntax illustrated in FIG. 73. The syntax illustrated in FIG. 73 may be expressed in the format of XML.

The bootstrap data according to the embodiment of FIG. 73 may include identifier information of a broadcaster which transmits a signaling message. Specifically, the bootstrap data may include unique identifier information of a specific broadcaster which transmits the signaling message through a specific frequency or a transmission frame. The identifier information of a broadcaster may be a broadcasting_id field. Also, the identifier information of a broadcaster may be identifier information of a transport stream of a broadcast service.

The bootstrap data according to the embodiment of FIG. 73 may include identification information of a transport packet for transmitting a timebase or a signaling message. The identifier information of the transport packet may be a packet_id field. The identifier information of the transport packet may be identifier information of an MPEG-2 transport stream.

Referring back to FIG. 67, details will be described.

The timebase transport mode may include a mode in which the broadcasting receiving apparatus 100 acquires a timebase through a URL.

According to the embodiment of FIG. 67, when the timebase_transport_mode field has a value of 0x06, it may indicate that it is possible to acquire a timebase of a broadcast service through a URL. Furthermore, the signaling transport mode may include a mode for acquiring a signaling message through a URL. When the signaling_transport_mode field has a value of 0x06, it may indicate that it is possible to acquire a signaling message used in a broadcast service through an identifier for identifying an address at which it is possible to receive the signaling message. In this case, the identifier for identifying an address at which it is possible to receive the signaling message used in the broadcast service may be an URL.

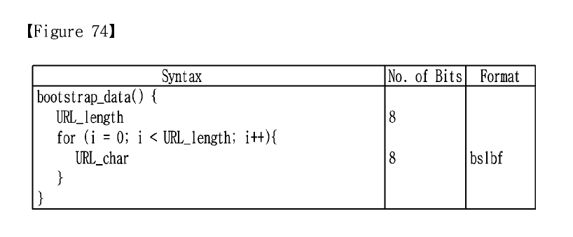

In this case, the bootstrap( ) field for the timebase and the signaling message may comply with the syntax illustrated in FIG. 74. The syntax illustrated in FIG. 74 may be expressed in the format of XML.

The bootstrap data according to the embodiment of FIG. 74 may include length information of the URL at which it is possible to download a timebase or a signaling message of a broadcast service. The URL length information may be a URL_length field.

The bootstrap data according to the embodiment of FIG. 74 may include actual data of the URL at which it is possible to download a timebase or a signaling message of a broadcast service. The actual data of the URL may be a URL_char field.

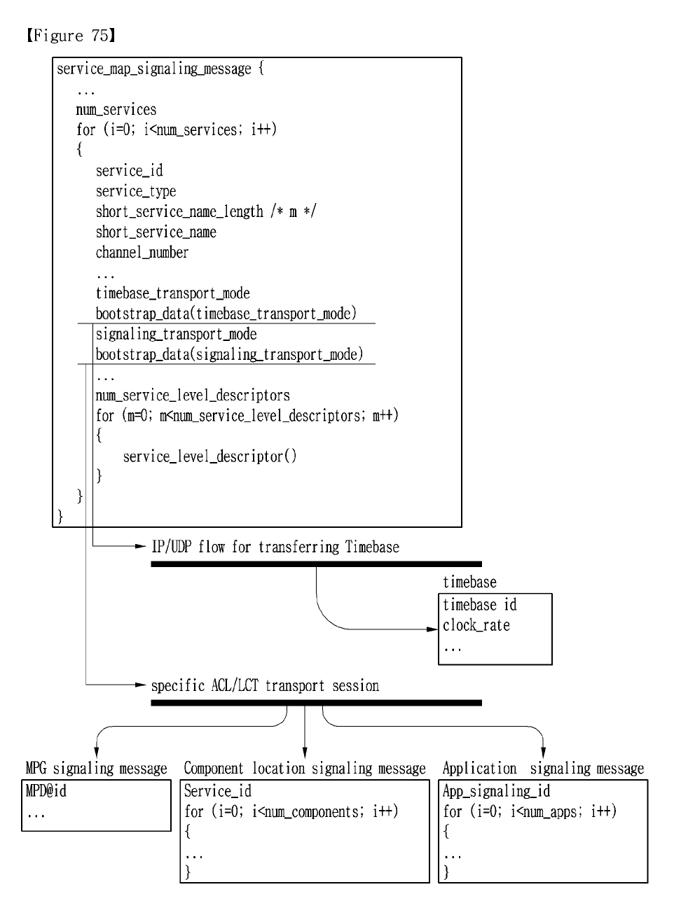

FIG. 75 illustrates a process of acquiring a timebase and a signaling message according to the embodiments of FIGS. 66 to 74.

As illustrated in FIG. 75, the broadcasting receiving apparatus 100 according to an embodiment of the present invention may acquire a timebase through a packet-based transport protocol. Specifically, the broadcasting receiving apparatus 100 may acquire the timebase through an IP/UDP flow by using the service signaling message. Also, the broadcasting receiving apparatus 100 according to the present embodiment of the present invention may acquire a service-related signaling message through a session-based transport protocol. Specifically, the broadcasting receiving apparatus 100 may acquire a service-related signaling message through an ALC/LCT transport session.

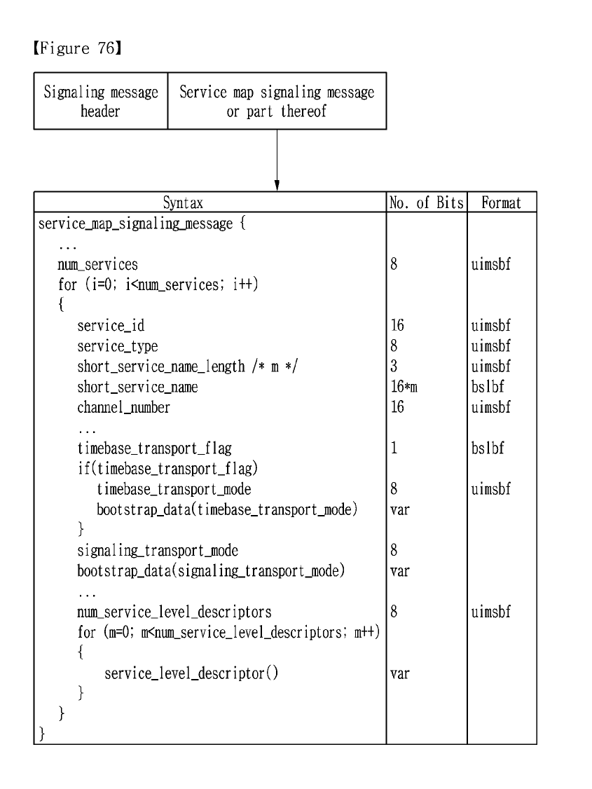

FIG. 76 illustrates a configuration of a broadcast service signaling message in a future broadcast system, according to an embodiment of the present invention. The broadcast service signaling message according to the present embodiment of the present invention is a service signaling method for allowing the broadcasting receiving apparatus to receive a broadcast service and content from the future broadcasting system. The broadcast service signaling method according to the embodiment of FIG. 76 may be based on the configuration of the signaling message illustrated in FIG. 65. The broadcast service signaling message according to the embodiment of FIG. 76 may be transmitted via a service signaling channel. In this case, the service signaling channel may be a sort of physical layer pipe for directly transmitting service signaling information for broadcast service scan without passing through another layer.

In a specific embodiment, the signaling channel may be at least one of a fast information channel (FIC), a low layer signaling, and an application transport session. Also, the broadcast service signaling message according to the embodiment of FIG. 76 may be expressed in the format of XML.

The service signaling message according to the embodiment of FIG. 76 may include information indicating whether the service signaling message includes information necessary to acquire a timebase. In this case, the timebase may include metadata for a timeline used in a broadcast service. The timeline is a series of time information for media content. The information indicating whether the information necessary to acquire the timebase may be a timeline_transport_flag field. In an embodiment, when the timeline_transport_flag field has a value of 1, it may indicate that the service signaling message includes information for timebase transmission.

The service signaling message according to the embodiment of FIG. 76 may include data necessary for the broadcasting receiving apparatus to acquire a timebase or a signaling message according to transport modes to be described below. The data necessary to acquire a timebase or a signaling message may be a bootstrap_data( ) field.

The above-described transport mode may be at least one of a timebase transport mode and a signaling transport mode. The timebase transport mode may be a transport mode for a timebase including metadata for a timeline used by a broadcast service. The information for the timebase transport mode may be a timebase_transport_mode field.

Also, the signaling transport mode may be a mode for transmitting a signaling message used in a broadcast service. The information for the signaling transport mode may be a signaling_transport_mode mode.

Also, the bootstrap_data( ) field according to the timebase_transport_mode field and the signaling_transport_mode field may have the same meaning as described above.

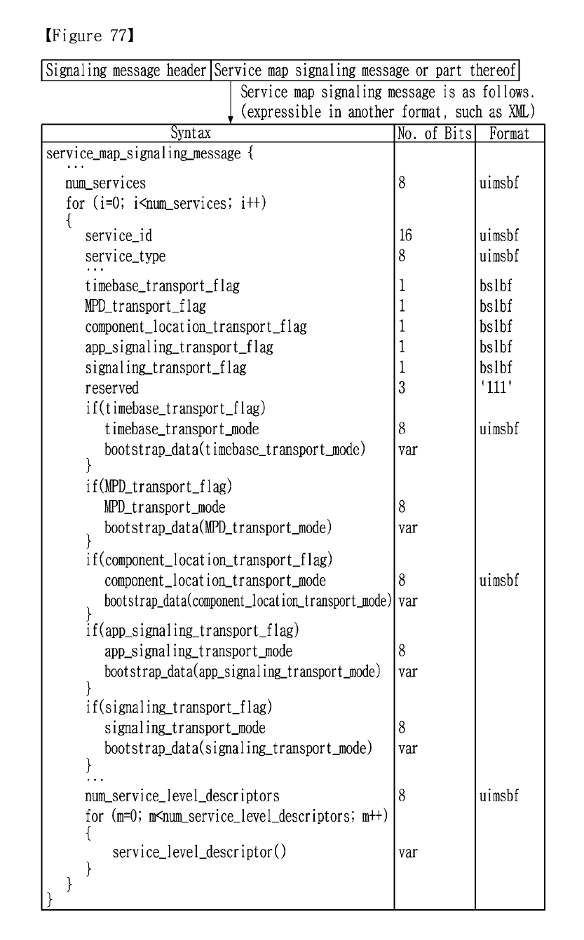

FIG. 77 illustrates a configuration of a broadcast service signaling message in a future broadcast system, according to an embodiment of the present invention. The broadcast service signaling message according to the present embodiment of the present invention is a service signaling method for allowing the broadcasting receiving apparatus to receive a broadcast service and content from the future broadcasting system. The broadcast service signaling method according to the embodiment of FIG. 77 may be based on the configuration of the signaling message illustrated in FIG. 65. The broadcast service signaling message according to the embodiment of FIG. 77 may be transmitted via a service signaling channel. In this case, the service signaling channel may be a sort of physical layer pipe for directly transmitting service signaling information for broadcast service scan without passing through another layer. In a specific embodiment, the signaling channel may be at least one of a fast information channel (FIC) and low layer signaling (LLS) and an application layer transport session. Also, the broadcast service signaling message according to the embodiment of FIG. 77 may be expressed in the format of XML.

The service signaling message according to the embodiment of FIG. 77 may indicate whether the service signaling message includes information necessary to acquire a timebase. In this case, the timebase may include metadata for a timeline used in a broadcast service. The timeline is a series of time information for media content. The information indicating whether the information necessary to acquire a timebase may be a timeline_transport_flag field. In an embodiment, when the timeline_transport_flag field has a value of 1, it may indicate that the service signaling message includes information for timebase transmission.

The service signaling message according to the embodiment of FIG. 77 may indicate whether the service signaling message includes information necessary to acquire a signaling message. In this case, the signaling message may be a signaling message associated with media presentation data (MPD) or an MPD URL used in the broadcast service. The information indicating whether the information necessary to acquire a signaling message may be an MPD_transport_flag field. In an embodiment, when the MPD_transport_flag field has a value of 1, it may indicate that the service signaling message includes information related with transmission of a signaling message associated with MPD or an MPD URL. An adaptive media streaming based on HTTP may be referred to as dynamic adaptive streaming over HTTP. Detailed information which allows a broadcasting receiving apparatus to acquire segments constituting a broadcast service and content in adaptive media streaming. The MPD may be expressed in the format of XML. An MPD URL-related signaling message may include information about an address at which it is possible to acquire the MPD.

Also, the service signaling message according to the embodiment of FIG. 77 may indicate whether the service signaling message includes path information for acquisition of component data. In this case, the component may be one unit of content data for providing a broadcast service. The information indicating whether the service signaling message includes path information for acquisition of component data may be a component_location_transport_flag field. In an embodiment, when the component_location_transport_flag field has a value of 1, the component_location_transport_flag field may indicate that the service signaling message includes path information for acquisition of component data.

Also, the service signaling message according to the embodiment of FIG. 77 may indicate whether information necessary to acquire an application-related signaling message is included therein. The information indicating whether information necessary to acquire an application-related signaling message is included therein may be an app_signaling_transport_flag field. In an embodiment, when the app_signaling_transport_flag field has a value of 1, the app_signaling_transport_flag field may indicate that the service signaling message includes path information for acquisition of component data.

Also, the service signaling message according to the embodiment of FIG. 77 may indicate whether signaling message transport-related information is included therein. The information indicating whether signaling message transport-related information is included therein may be a signaling_transport_flag field. In an embodiment, when the signaling_transport_flag field has a value of 1, the signaling_transport_flag field may indicate that the service signaling message includes signaling message transport-related information. Also, when the service signaling message does not include the MPD-related signaling, component acquisition path information, and the application-related signaling information which are described above, the broadcasting receiving apparatus may acquire the MPD-related signaling, the component acquisition path information, and the application-related signaling information via a signaling message transmission path.

The service signaling message according to the embodiment of FIG. 77 may indicate a mode for transmitting a timebase used in a broadcast service. The information about the mode for transmitting a timebase may be a timebase_transport_mode field.

The service signaling message according to the embodiment of FIG. 77 may indicate a mode for transmitting an MPD-related or MPD URL-related signaling message used in a broadcast service. Information about the mode for transmitting an MPD-related or MPD URL-related signaling message may be an MPD_transport_mode field.

The service signaling message according to the embodiment of FIG. 77 may indicate a mode for transmitting a component location signaling message including a path for acquisition of component data used in a broadcast service. Information about the mode for transmitting a component location signaling message including a path for acquisition of component data may be a component_location_transport_mode field.

The service signaling message according to the embodiment of FIG. 77 may indicate a mode for transmitting an application-related signaling message used in a broadcast service. Information about the mode for transmitting an application-related signaling message may be an app_signaling_transport_mode field.

The service signaling message according to the embodiment of FIG. 77 may indicate a mode for transmitting a service-related signaling message used in a broadcast service. Information about the mode for transmitting a service-related signaling message may be a signaling_transport_mode field.

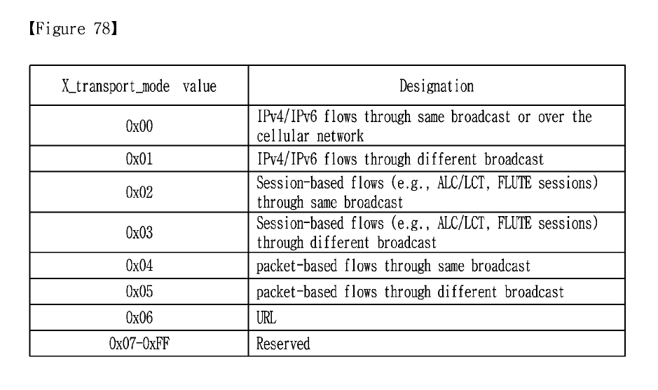

The meaning of values, represented by the timebase_transport_mode field, the MPD_transport_mode field, the component_location_transport_mode field, app_signaling_transport_mode field, and the signaling_transport_mode field, will be described below with reference to FIG. 78.

FIG. 78 illustrates the meaning of values represented by the transport modes described with reference to FIG. 77. In FIG. 78, X_transport_mode may include timebase_transport_mode, MPD_transport_mode, component_location_transport_mode, app_signaling_transport_mode, and signaling_transport_mode. Specific meaning of the values represented by the transport modes are the same as described with reference to FIG. 67. Referring back to FIG. 77, details will be described.

The service signaling message according to the embodiment of FIG. 77 may include information for the broadcasting receiving apparatus to acquire a timebase or a signaling message according to values represented by the modes of FIG. 78. The information necessary to acquire the timebase or the signaling message may be a bootstrap_data( ) field. Specifically, information included in the bootstrap_data( ) field may be the same as described with reference to FIGS. 68 to 74.

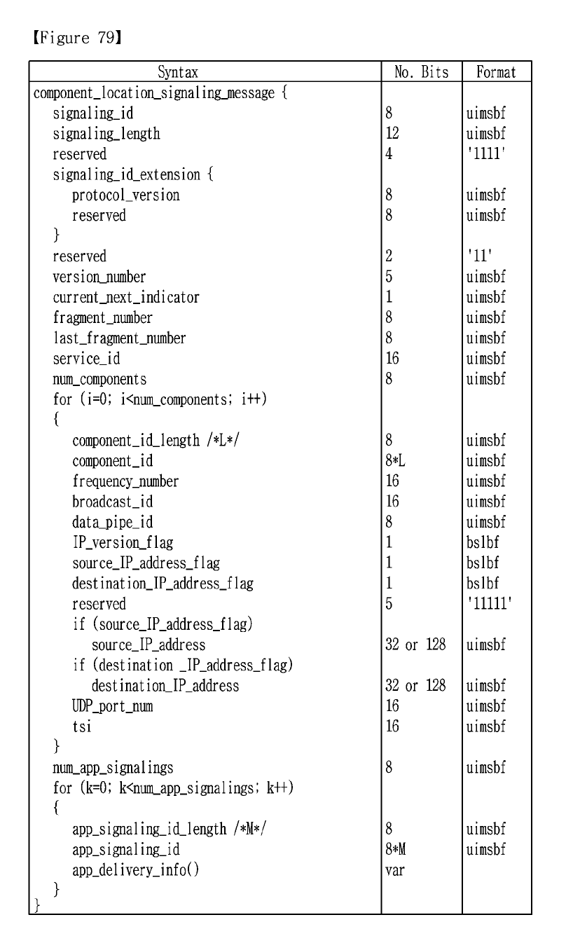

FIG. 79 illustrates a configuration of a signaling message for signaling a component data acquisition path of a broadcast service in a future broadcasting system. A single broadcast service in the future broadcasting system may include one or more components. Based on the signaling message according to the embodiment of FIG. 79, the broadcasting receiving apparatus may acquire information about a path for acquisition of component data and a relevant application from a broadcast stream. In this case, the signaling message according to the embodiment of FIG. 79 may be expressed in the format of XML.

The signaling message according to the embodiment of FIG. 79 may include information for identifying whether the signaling message is a message for signaling a component location. The information for identifying whether the signaling message is a message for signaling a component location may be a signaling_id field. In a specific embodiment, the signaling_id field may be eight bits.

The signaling message according to the embodiment of FIG. 79 may include extension information for identifying whether the signaling message is a message for signaling a component location. In this case, the extension information may include a protocol version of a message for signaling the component location. The extension information may be a signaling_id_extension field.

Also, the signaling message header according to the embodiment of FIG. 79 may include version information of the signaling message. In this case, the version information may indicate that content of the message for signaling the component location is changed. The version information may be a version_number field.

Also, the signaling message according to the embodiment of FIG. 79 may include identifier information of an associated broadcast service. The identifier information of the associated broadcast service may be a service_id field.

Also, the signaling message according to the embodiment of FIG. 79 may include the number of components associated with a broadcast service. The number of associated components may be a num_component field.

Also, the signaling message according to the embodiment of FIG. 79 may include an identifier of each component. For example, the component identifier may be configured by combining MPD@id, period@id, and representation@id of MPEG DASH. The identifier information of each component may be a component_id field.

Also, the signaling message according to the embodiment of FIG. 79 may include a length of a component_id field. The length information of the component_id field may be a component_id_length field.

Also, the signaling message according to the embodiment of FIG. 79 may include frequency information indicating a frequency at which it is possible to acquire component data. The component data may include a DASH segment. In this case, the frequency information at which it is possible to acquire the component data may be a frequency_number field.

Also, the signaling message according to the embodiment of FIG. 79 may include a unique identifier of a broadcaster. The broadcaster may transmit the component data through a specific frequency or a transmission frame to be transmitted. Information about the unique identifier of the broadcaster may be a broadcast_id field.

Also, the signaling message according to the embodiment of FIG. 79 may include an identifier of a physical layer pipe for transmitting component data. In this case, information about the identifier of a physical layer pipe for transmitting component data may be a datapipe_id field.

Also, the signaling message according to the embodiment of FIG. 79 may include an IP address format of an IP datagram including component data. Information about the IP address format of the IP datagram may be an IP_version_flag field. In a specific embodiment, when the IP_version_flag field has a field value of 0 indicates an IPv4 format, or when the IP_version_flag field has a field value of 1 indicates an IPv6 format.

Also, the signaling message according to the embodiment of FIG. 79 may include information indicating whether a source IP datagram including component data includes a source IP address. The information indicating whether an IP datagram including component data includes a source IP address may be a source_IP_address_flag field. In an embodiment, when the source_IP_address_flag field has a value of 1, it indicates that the IP datagram includes a source IP address

Also, the signaling message according to the embodiment of FIG. 79 may include information indicating whether a destination IP datagram including component data includes a destination IP address. The information indicating whether the IP datagram includes a destination IP address may be a destination_IP_address_flag field. In an embodiment, when the destination_IP_address_flag field has a value of 1, it indicate that the IP datagram includes a destination IP address.

Also, the signaling message according to the embodiment of FIG. 79 may include source IP address information of an IP datagram including component data. In an embodiment, when the source_IP_address_flag field has a value of 1, the signaling message may include the source IP address information. The source IP address information may be a source IP address field.

Also, the signaling message according to the embodiment of FIG. 79 may include destination IP address information of the IP datagram including component data. In an embodiment, when the destination_IP_address_flag field has a value of 1, the signaling message may include the destination IP address information. The destination IP address information may be a destination_IP_address field.

Also, the signaling message according to the embodiment of FIG. 79 may include UDP port number information of the IP datagram including component data. The UDP port number information may be a UDP_port_num field.

The signaling message according to the embodiment of FIG. 79 may include identifier (transport session identifier) information of an application layer transport session for transmitting a transport packet including the component data. The session for transmitting the transport session may be at least one of an ALC/LCT session and a FLUTE session. The identifier information of a session may be a tsi field.

Also, the signaling message according to the embodiment of FIG. 79 may include identifier information a transport packet including component data. The identifier information of the transport packet may be a packet_id field.

Also, the signaling message according to the embodiment of FIG. 79 may include the number of application signaling messages associated with a broadcast service. In this case, the broadcast service may be a broadcast service identified by a service_id field. Information about the number of application signaling messages may be a num_app_signaling field.

Also, the signaling message header according to the embodiment of FIG. 79 may include identifier information of an application signaling message. The identifier information of an application signaling message may be an app_signaling_id field.

Also, the signaling message according to the embodiment of FIG. 79 may include length information of the app_signaling_id field. The length information of the app_signaling_id field may be an app_signaling_id_length field.

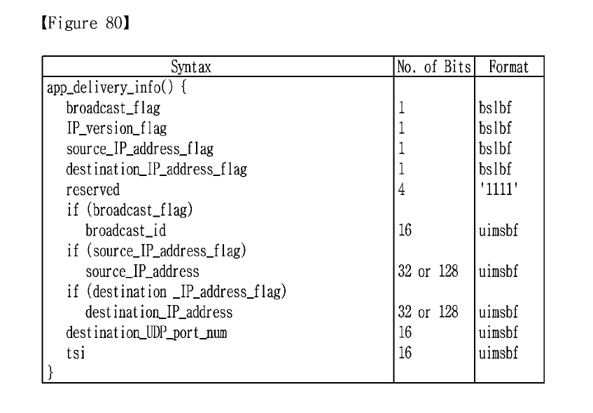

Also, the signaling message header according to the embodiment of FIG. 79 may include data about a path in which application data included in the signaling message associated with the identifier of the application signaling message can be acquired. Path information for application acquisition included in the signaling message associated with the identifier of the application signaling message may be an app_delivery_info( ) field. An embodiment of the app_delivery_info( ) field will be described below with reference to FIG. 80.

FIG. 80 illustrates a syntax an app_delivery_info( ) field according to an embodiment of the present invention.

The data about the path in which application data included in the signaling message associated with the identifier of the application signaling message according to the embodiment of FIG. 80 can be acquired may include information about whether an application or associated data is transmitted through another broadcast stream. The information about whether an application or associated data is transmitted through another broadcast stream may be a broadcasting_flag field.

Also, the data about the path in which application data included in the signaling message associated with the identifier of the application signaling message according to the embodiment of FIG. 80 can be acquired may include an IP address format of the IP datagram including an application or associated data. Information about the IP address format of the IP datagram may be an IP_version_flag field. In an embodiment, when the IP_version_flag field has a value of 0, the IP datagram including an application or associated data may indicate that the IP datagram uses an IPv4 format and when the IP_version_flag field has a value of 1, the IP datagram including an application or associated data may indicate that the IP datagram uses an IPv4 format.

Also, the data about the path in which application data included in the signaling message associated with the identifier of the application signaling message according to the embodiment of FIG. 80 can be acquired may indicate whether the IP datagram including an application or associated data includes a source IP address. In this case, the associated data may be data necessary for execution of the application.

The information indicating whether the IP datagram including an application or associated data includes a source IP address may be a source_IP_address_flag field. In an embodiment, when the source_IP_address_flag field is 1, it may indicate that the IP datagram includes a source IP address.

Also, the data about the path in which application data included in the signaling message associated with the identifier of the application signaling message according to the embodiment of FIG. 80 can be acquired may include information about whether the IP datagram including an application or associated data includes a source IP address. The information about whether the IP datagram including an application or associated data includes a destination IP address may be a destination_IP_address_flag field. In an embodiment, when the destination_IP_address_flag field is 1, it may indicate that the IP datagram includes a destination IP address.

Also, the data about the path in which application data included in the signaling message associated with the identifier of the application signaling message according to the embodiment of FIG. 80 can be acquired may include a unique identifier of a broadcaster which transmits the application or the associated data through a specific frequency or a transmission frame which is transmitted.

In other words, the data about the path in which application data included in the signaling message associated with the identifier of the application signaling message according to the embodiment of FIG. 80 can be acquired may include an identifier of a broadcast service transport stream. Information about the unique identifier of the broadcaster which transmits the application or the associated data through the specific frequency or the transmission frame which is transmitted may be a broadcast_id field.

Also, the data about the path in which application data included in the signaling message associated with the identifier of the application signaling message according to the embodiment of FIG. 80 can be acquired may include a source IP address of the IP datagram including an application or associated data, when the source_IP_address_flag field has a value of 1. Information about the source IP address of the IP datagram including the application or the associated data may be a source_IP_address field.

Also, the data about the path in which application data included in the signaling message associated with the identifier of the application signaling message according to the embodiment of FIG. 80 can be acquired may include a destination IP address of the IP datagram including an application or associated data, when the destination_IP_address_flag field has a value of 1. Information about the destination IP address of the IP datagram including the application or the associated data may be a destination_IP_address field.

Also, the data about the path in which application data included in the signaling message associated with the identifier of the application signaling message according to the embodiment of FIG. 80 can be acquired may include the number of ports of an IP datagram flow including the application or the associated data. Information about the number of ports of the IP datagram flow including the application or the associated data may be a port_num_count field.

Also, the data about the path in which application data included in the signaling message associated with the identifier of the application signaling message according to the embodiment of FIG. 80 can be acquired may include a UDP port number of the datagram including the application or the associated data. Information about the UDP port number of the IP datagram including the application or the associated data may be a destination_UDP_port_number field.

Also, the data about the path in which application data included in the signaling message associated with the identifier of the application signaling message according to the embodiment of FIG. 80 can be acquired may include an identifier of a transport session for transmitting the application or the associated data. The transport session for transmitting the application or the associated data may be one of an ALC/LCT session and a FLUTE session. Information about the identifier of the transport session for transmitting the application or the associated data may be a tsi field.

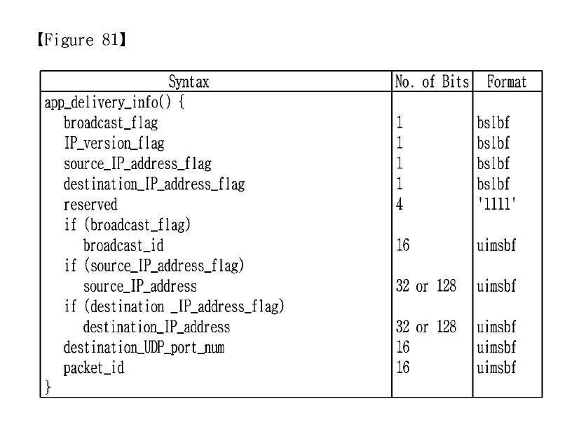

FIG. 81 illustrates a syntax of an app_delivery_info( ) field according to another embodiment of the present invention.

The data about the path in which application data included in the signaling message associated with the identifier of the application signaling message according to the embodiment of FIG. 81 can be acquired may indicate an identifier of a transport packet for transmitting the application or the associated data. The transport packet for transmitting the application or the associated data may comply with a protocol based on a packet-based transmission flow. For example, the packet-based transmission flow may include an MPEG media transport protocol. Information about the identifier of the transport packet for transmitting the application or the associated data may be a packet_id field.

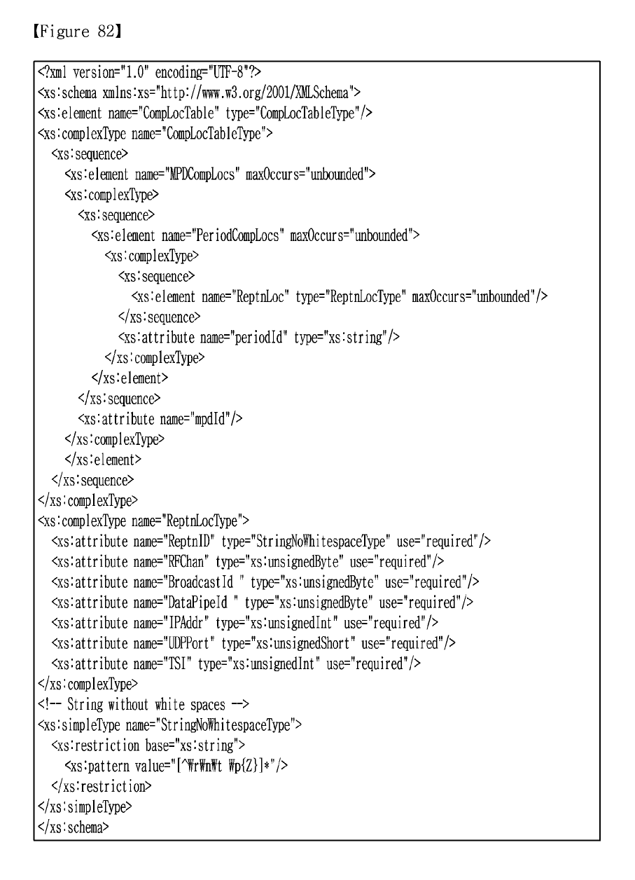

FIG. 82 illustrates component location signaling including information about a path in which one or more pieces of component data constituting a broadcast service can be acquired. Specifically, FIG. 82 illustrates information about a path in which component data including a DASH segment can be acquired, when the one or more pieces of components constituting a broadcast service are expressed by a MPEG DASH segment.

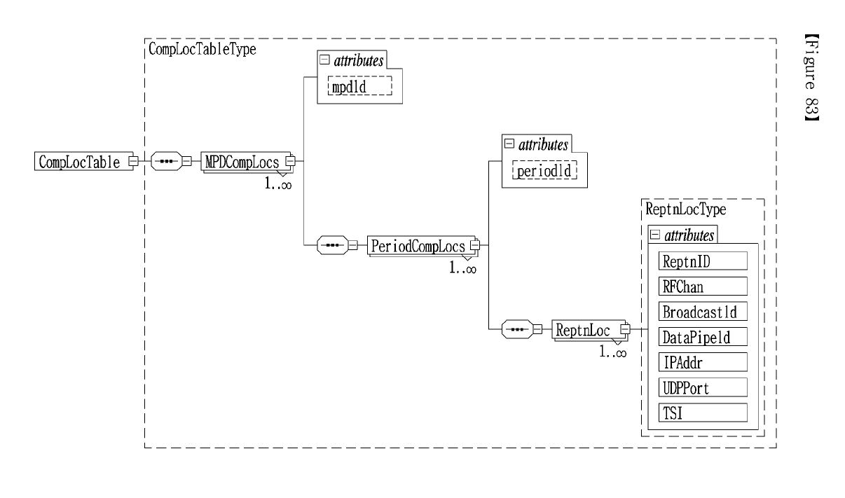

FIG. 83 illustrates a configuration of the component location signaling of FIG. 82.

The component location signaling according to the embodiment of FIG. 83 may include identifier information of an MPEG DASH MPD associated with the broadcast service. The identifier information of the MPEG DASH MPD may be an mpdip field.

Also, the component location signaling according to the embodiment of FIG. 83 may include an identifier of a period attribute in the MPEG DASH MPD indicated by the mpdip field. Information about the identifier of the period attributes in the MPEG DASH MPD may be a periodid field.

Also, the component location signaling according to the embodiment of FIG. 83 may include an identifier of a representation attribute within the period indicated by the periodid field. Information about the identifier of the representation attribute within the period may be a ReptnID field.

Also, the component location signaling according to the embodiment of FIG. 83 may include a frequency number for acquiring a DASH segment included in the representation attribute with in the period indicated by the ReptnID field. The frequency number for acquiring the DASH segment may be an RF channel number. The frequency number for acquiring the DASH segment may be an RFchan field.

Also, the component location signaling according to the embodiment of FIG. 83 may include a unique identifier of a broadcaster which transmits the DASH segment through a specific frequency or a transmission frame which is transmitted. Information about the unique identifier of a broadcaster which transmits the DASH segment may be a Broadcastingid field.

Also, the component location signaling according to the embodiment of FIG. 83 may include an identifier of a physical layer pipe for delivering the DASH segment. The physical layer pipe may be a data pipe transmitted through a physical layer. Information about an identifier of the physical layer pipe for delivering the DASH segment may be a DataPipeId field.

Also, the component location signaling according to the embodiment of FIG. 83 may include a destination IP address of an IP datagram including the DASH segment. Information about the destination IP address of the IP datagram including the DASH segment may be an IPAdd field.

Also, the component location signaling according to the embodiment of FIG. 83 may include a UDP port number of the IP datagram including the DASH segment. Information about the UDP port number of the IP datagram including the DASH segment may be a UDPPort field.

Also, the component location signaling according to the embodiment of FIG. 83 may include an identifier (transport session identifier) of a session for transmitting a transport packet including the DASH segment. The identifier of the session for transmitting the transport packet may be at least one of an ALC/LCT session and a FLUTE session. Information about the identifier of the session for transmitting the transport packet may be a TSI field.

Also, the component location signaling according to the embodiment of FIG. 83 may include an identifier of the transport packet including the DASH segment. Information about the identifier of the transport packet may be a PacketId field.

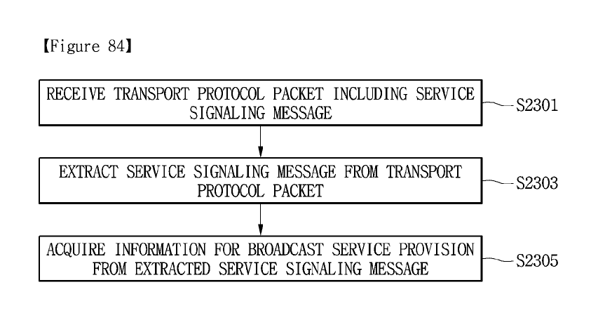

FIG. 84 is a flowchart of operation of a broadcasting receiving apparatus according to an embodiment.

A reception unit of the broadcasting receiving apparatus receives a transport protocol packet including a service signaling message (S2301). The reception unit may include an Internet protocol communication unit and a broadcasting receiving unit. The service signaling message may be information for signaling at least one of a broadcast service and media content. In an embodiment, the transport protocol may be an Internet protocol (IP). Also, in an embodiment, the transport protocol may be expressed by at least one of a binary format and an XML format. A transport protocol packet may include a signaling message header and a signaling message.

The control unit of the broadcasting receiving apparatus extracts the service signaling message from the received transport protocol packet (S2303). Specifically, the service signaling message may be extracted by parsing the transport protocol packet. The control unit may acquire an Internet protocol datagram from a layered transport protocol packet. The acquired Internet protocol datagram may include the service signaling message.

The control unit of the broadcasting receiving apparatus acquires information for providing a broadcast service from the service signaling message. The information for providing a broadcast service may be a part of the service signaling message.

In an embodiment, the information for providing a broadcast service may be transport mode information for a timebase including metadata for a timeline that is a series of time information for content.

In another embodiment, the information for providing a broadcast service may be transport mode information for detailed information for acquisition of segments constituting content in an adaptive media streaming. The detailed information for acquisition of segments constituting content in the adaptive media streaming may be referred to as media presentation description (MPD).

In another embodiment, the information for providing a broadcast service may be transport mode information for a path in which component data constituting content in a broadcast service is acquired. The component data may be an entity constituting the broadcast service or the content. In this case, information about the path in which component data is acquired may be identification information of a physical layer pipe for delivering component data. The layered transport protocol packet may include a physical layer pipe to be delivered through the physical layer. There may be a plurality of physical layer pipes. Therefore, it is required to identify a physical layer pipe including the component data to be acquired, from among the plurality of physical layer pipes.

In another embodiment, the information for providing a broadcast service may be transport mode information for a signaling message for an application used in a broadcast service. In this case, the transport mode information for the signaling message for an application may be at least one of identifier information of a broadcaster that transmits the application, a source IP address of an Internet protocol datagram including the application, a destination IP address of the Internet protocol datagram including the application, a port number of a user datagram protocol (UDP) of the Internet protocol datagram including the application, identifier information of a transport session for transmitting the application, and identifier information of a packet for transmitting the application.

In another embodiment, the information for providing a broadcast service may be transport mode information for a signaling message for a service used in a broadcast service. In this case, the service may be one content.

In another embodiment, the information for providing a broadcast service includes transport mode information for component data constituting a service. The transport mode information for component data may indicate at least one of a transport mode for supporting a non-realtime service, a transport mode for supporting a realtime service, and a transport mode for packet transmission.

In another embodiment, the information for providing the broadcast service may include information for reception of a realtime service with a file format.

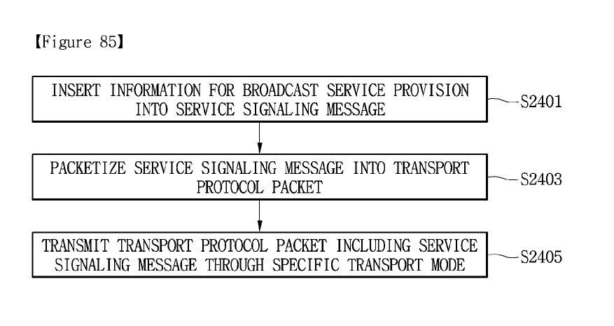

FIG. 85 is a flowchart of operation of a broadcasting transmitting apparatus according to an embodiment of the present invention.

The control unit of the broadcasting transmitting apparatus inserts information for broadcast service provision into a service signaling message (S2401). In an embodiment, the control unit of the broadcasting transmitting apparatus inserts XML formatted-information for broadcast service provision into the service signaling message (S2401). In another embodiment, the control unit of the broadcasting transmitting apparatus may insert binary-formatted information for broadcast service provision into the service signaling message.

The control unit of the broadcasting transmitting control unit packetizes, as a transport protocol packet, the service signaling message into which the information for broadcast service provision (S2403). In this case, the transport protocol may be one of a session-based transport protocol (ALC/LCT or FLUTE) and a packet-based transport protocol (MPEG-2 TS or MMT).

A transmission unit of the broadcasting transmitting apparatus may transmit the transport protocol packet resulting from packetization of the service signaling message to the broadcasting receiving apparatus through a specific transport mode (S2405). In an embodiment, the transport mode for transmitting the packetized transport protocol packet may be a transport mode for a timebase including metadata for a timeline that is a series of time information for content, used for a broadcast service. In another embodiment, the transport mode for transmitting the packetized transport protocol packet may be a transport mode for detailed information for acquisition of segments constituting content in an adaptive media streaming. In another embodiment, the transport mode for transmitting the packetized transport protocol packet may be a transport mode for a path in which component data constituting content in a broadcast service is acquired. In another embodiment, the transport mode for transmitting the packetized transport protocol packet may be a transport mode for a signaling message for an application used in a broadcast service. In another embodiment, the transport mode for transmitting the packetized transport protocol packet may be a transport mode for a signaling message for a service used in a broadcast service.

A hybrid broadcast can provide a service via an application. Specifically, a broadcasting company can provide information associated with broadcast content through an application. For example, the broadcasting company may provide an application that allows viewers to purchase the same products as those used by characters in broadcast content. In order for such an application, the broadcast transmission apparatus 10 may transmit application signaling information for signaling the application. The application signaling information may include at least one of a trigger for triggering an action of the application and triggering application information for signaling information on the application to be triggered. Details thereof will be described with reference to the accompanying drawings.

The triggering application information may include additional information required to execute the application. Specifically, the triggering application information may include an attribute of the application. Also, the triggering application information may include a location at which a file included in the application can be downloaded. Also, the triggering application information may include a location at which an NRT content item used by the application can be received.

Also, the triggering application information may signal a change in a life-cycle of the application. Specifically, the life-cycle of the application may include at least one of preparing, executing, terminating, and suspending. For example, the application may prepare execution through a preparing status. Also, the application may be executed in the preparing status. Also, the application may terminate execution and enter into a terminating status. Also, the application may suspend execution and enter into a suspending status.

The triggering application information may include an action to be executed by the application. Specifically, the triggering application information may include data required to execute the action of the application.

The triggering application information may include a media type. Specifically, the triggering application information may include a media type of content to be synchronized with the application.

Specifically, the broadcast transmission apparatus 10 may transmit a trigger for triggering the action of the application. Also, the broadcast reception apparatus 100 may allow the application to execute a specific action based on the trigger. Specifically, the trigger may have the following format.

The trigger may include a domain name part indicating a registered Internet domain name. Also, the trigger may include a directory path part indicating a random character string for identifying a directory path of the domain name indicated by the domain name part. Also, the trigger may include a parameter part indicating a parameter for triggering the application. Specifically, the trigger may have the following format.

<domain name part>/<directory path>[?<parameter>]

In this case, the domain name part and the directory path part may be essential parts essentially included in the trigger. Also, the parameter part may be an optional part optionally included in the trigger. The parameter part may include at least one of an event identifier for identifying an event, an application identifier for identifying an application to be triggered, and a timing value indicating an executing time of the event. Also, the parameter part may include a media time of content. Also, the parameter part may include a content identifier for identifying content presented by the broadcast reception apparatus 100. Also, the parameter part may include spread information for spreading a triggering application information request traffic of the broadcast reception apparatus 100. Also, the parameter part may include version information indicating a version of the triggering application information associated with the trigger.

Specifically, the parameter part may include at least one of the following strings.

<media time>

<media time> and <spread>

<media time> and <version>

<media time> and <version> and <spread>

<event time>

<event time> and <spread>

<event time> and <version>

<event time> and <version> and <spread>

<event time> may include an event identifier (ID) for identifying an event. In this case, the event may indicate that the action of the application is executed by the trigger. At this time, the event identifier may be designated by “e=”. Also, the event identifier may include two or three decimal numbers following “e=”. In this case, the decimal numbers may be separated from each other by a period (“.”). Also, <event time> may include an application identifier for identifying an application to be triggered. In this case, the application may be referred to as a Triggered Declarative Object (TDO). Also, the application identifier may be matched with an application identifier of application information to be triggered. Therefore, the broadcast reception apparatus 100 may acquire information about the application to be triggered from the triggering application information based on the application identifier of the trigger. In this case, the triggering application information may be a TDO Parameter Table (TPT) for signaling trigger information. Also, the parameter part may include a data identifier for identifying a data element used in an event. Also, the parameter part may include a timing value indicating the executing time of an event. At this time, the timing value may be designated by “t=”. In a specific embodiment, the timing value may be designated by a hexadecimal indicated by one to eight characters following “t=”. When <event time> does not include the timing value, the trigger may perform triggering so that the application performs the corresponding event at the time when the trigger is received.

<media time> may include a media time of content. Specifically, <media time> may indicate a media timestamp of content synchronized with the application triggered by the trigger. Specifically, the media time may be designated by “m=”. The media time may be designated by a hexadecimal indicated by one to eight characters following “m=”. Unit of the media time may be millisecond. Also, <media time> may indicate a content identifier for identifying content that is being currently presented by the broadcast reception apparatus 100. The content identifier may be designated by “c=”. Specifically, when the application is executed by a direct execution model, <media time> may include the content identifier. In a specific embodiment, the broadcast reception apparatus 100 may receive a timebase trigger for transmitting a reference time for application synchronization and extract the content identifier from the timebase trigger. In this case, the broadcast reception apparatus 100 may transmit the content identifier to a server for an interaction service and receive an interaction service for content that is being currently presented by the broadcast reception apparatus. 100.

<version> may include version information indicating the version of the triggering application information associated with the trigger. In this case, the triggering application information may be the TPT. Specifically, the version information may be designated by “v=”. Also, the version information may be designated by a decimal indicated by one to three characters following “v=”. The broadcast reception apparatus 100 may extract the version information from the trigger and acquire the triggering application information based on the version information.

<spread> may include spread information which is a reference for calculating the time that the broadcast reception apparatus 100 has to wait so as to request the triggering application information to a server that provides the application signaling information. Specifically, the broadcast reception apparatus 100 may calculate a random value based on the time indicated by the spread information and request the triggering application information after waiting as long as the random value. The spread information may be designated by “s=”. Specifically, the spread information may be designated by a decimal indicated by one to three characters following “s=”. Since the plurality of broadcast reception apparatuses 100 request the triggering application information through the spread information at a time, a traffic of the server providing the triggering application information can be prevented from concentrate on a traffic reception time.

<other> may include information other than the above-described parameters. The broadcast reception apparatus 100 may ignore unrecognizable parameters.

The trigger including the media time of the content may be referred to as a timebase trigger. Specifically, the timebase trigger may transmit the media timestamp of the content presented by the broadcast reception apparatus 100. Also, the broadcast reception apparatus 100 may generate a reference time which is a reference for synchronizing the application action with the content, based on the timebase trigger.

The trigger including the event time may be referred to as an activation trigger. This is because the activation trigger designates the time to execute the corresponding event. The broadcast reception apparatus 100 may execute the action triggered based on the event time of the trigger. Specifically, the broadcast reception apparatus 100 may extract the event time from the trigger and execute the action triggered at the event time.

Also, the parameter part of the trigger may include a timing value indicating the time to end the corresponding event as well as a timing value indicating the time to start executing the event. Also, when the trigger is received between the time to start executing the event and the time to end the event, the broadcast reception apparatus 100 may execute the event triggered by the corresponding trigger. Specifically, the parameter part may include <event start time> and <event end time>.

<event start time> may include the timing value indicating the time to start executing the event. The timing value may be designated as “st=” after “e=” identifying the event.

<event end time> may include the timing value indicating the time to end the event. The timing value may be designated as “et=” after “e=” identifying the event.

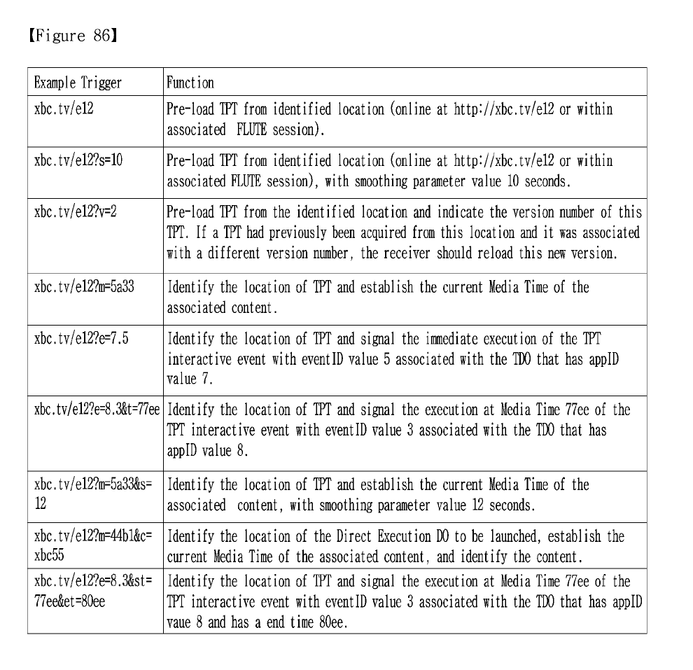

FIG. 86 illustrates the trigger based on the trigger syntax described above.

In another specific embodiment, a trigger syntax may have a format of a timed text displayed at a regular time. Specifically, the timed text may be a closed caption.

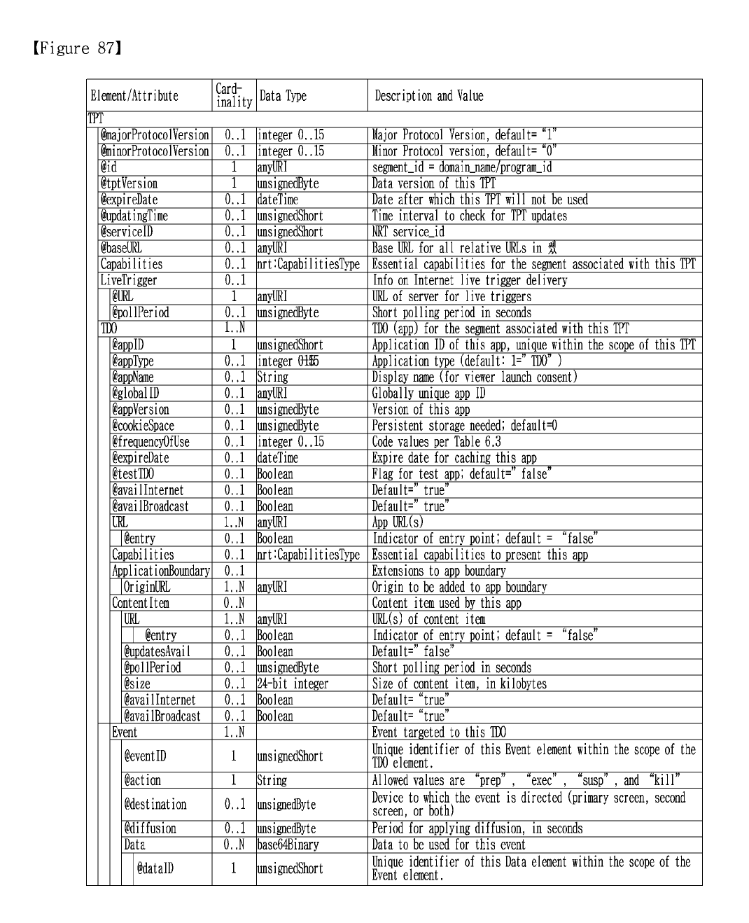

FIG. 87 illustrates a syntax of triggering application information according to an embodiment of the present invention.

In this case, the triggering application information may include the TPT. The triggering application information may signal an application corresponding to all program segments or some program segments according to time. In this case, the program segment indicates a time interval included in the program.

The triggering application information may include protocol version information indicating a protocol version of the triggering application information. Specifically, the triggering application information may include major protocol version information indicating main version information of the protocol and minor protocol version information indicating additional version information of the protocol. In this case, the major protocol version information may be a 3-bit integer. When the broadcast reception apparatus 100 does not support at least one of the major protocol version information and the minor protocol version information, the broadcast reception apparatus may discard the triggering application information. The major protocol version information may be referred to as MajorProtocolVersion. The minor protocol version information may be referred to as MinorProtocolVersion. In a specific embodiment, the major protocol version information may be a 3-bit element. Also, the minor protocol version information may be a 4-bit element.

The triggering application information may include an identifier for identifying the triggering application information. Specifically, the triggering application information may be an identifier for identifying the program segment. In a specific embodiment, the identifier for identifying the program segment may be generated by combining a domain name and a program ID. For example, the identifier may be domain_name?program_id.

The triggering application information may include version information indicating an update history of the triggering application information. Whenever the triggering application information changes, a value of the version information may change. The broadcast reception apparatus 100 may determine whether to extract specific information included in the triggering application information based on the version information. In a specific embodiment, the version information may be referred to as tptVersion. In a specific embodiment, the version information may be an 8-bit element.

The triggering application information may include expiration time information indicating an expiration date and time of the triggering application information. Specifically, the broadcast reception information 100 may store the triggering application information and reuse the triggering application information before the expiration date and time indicated by the expiration time information. In a specific embodiment, the expiration time information may be referred to as expirationDate. In a specific embodiment, the expiration time information may be referred to a 16-bit element.

The triggering application information may include a service identifier for identifying a service including an application. In a specific embodiment, the service identifier may indicate an identifier of a Non-Real-Time (NRT) service defined in the ATSC standard. In a specific embodiment, the service identifier may be referred to as serviceId. In a specific embodiment, the service identifier may be a 16-bit integer.

The triggering application information may include a base URL indicating a basic address of a URL included in the application information. In a specific embodiment, the base URL may be referred to as baseURL.

The triggering application information may include performance information indicating essential performance required for presenting an application signaled by the application information. The performance information may comply with the definition of Capabilities Descriptor defined in the ATSC standard. In a specific embodiment, the performance information may be referred to as Capabilities.

The triggering application information may include live trigger information generated in real time together with the transmission of content and transmitted through the Internet. Specifically, the live trigger information may include a URL of a server that transmits a live trigger. Also, in the case where the live trigger is transmitted by a polling scheme, the live trigger information may include a polling period. In a specific embodiment, the live trigger information may be referred to as LiveTrigger. Also, a URL of a server that transmits the live trigger may be referred to as URL. Also, the polling period may be referred to as pollPeriod.

The triggering application information may include information about the application. Also, the application information may include detailed information about the application as a sub-element. In a specific embodiment, the application information may be referred to as TDO.

The application information may include an application identifier for identifying the application. In a specific embodiment, the application identifier may be referred to as appID. Also, in a specific embodiment, the application identifier may be a 16-bit element.

The application information may include application type information indicating a type of the application. In a specific embodiment, when a value of the application type information is 1, it may indicate that the application type information is TDO. In a specific embodiment, the application type information may be referred to as apType. In a specific embodiment, the application type information may be referred to a 16-bit element.

The application information may include application name information indicating a name of the application. In a specific embodiment, the application name information may be referred to as appName.

The application information may include a global identifier for globally uniquely identifying the application. The global identifier may be used to indicate the same application in other application information as well as the corresponding triggering application. In a specific embodiment, the global identifier may be referred to as globalID.

The application information may include application version information that is version information indicating an update history of the application. In a specific embodiment, the application version information may be referred to as appVersion. In a specific embodiment, the appVersion may be an 8-bit element.

The application information may include cookie space information indicating a size of a persistent storage space necessary for the broadcast reception apparatus 100 to execute the application. The cookie space information may express the size of the storage space necessary for the execution of the execution in kilobytes. In a specific embodiment, the cookie space information may be referred to as cookieSpace. In a specific embodiment, the cookie space information may be referred to an 8-bit element.

The application information may include frequency-of-use information indicating a frequency of use of the application. The frequency-of-use information may indicate at least one of only once, every hour, every day, every week, and every month. In a specific embodiment, the frequency-of-use information may have a value from 1 to 16. In a specific embodiment, the frequency-of-use information may be referred to as frequencyOfUse.

The application information may include expiration time information indicating an expiration date and time of the application. In a specific embodiment, the expiration time information may be referred to as expireDate.

The application information may include test application information indicating that the application is an application for test broadcast. The broadcast reception apparatus 100 may ignore the application for test broadcast based on the test application information. In a specific embodiment, the test application information may be referred to as testTDO. In a specific embodiment, the test application information may be a Boolean element.

The application information may include available Internet information indicating that the application is available via the Internet. In a specific embodiment, the available Internet information may be referred to as availableInternet. In a specific embodiment, the available Internet information may be a Boolean element.

The application information may include available broadcast information indicating that the application is available via a broadcast network. In a specific embodiment, the available broadcast information may be referred to as availableBroadcast. In a specific embodiment, the available broadcast information may be a Boolean element.

The application information may include URL information for identifying a file that is a part of the application. In a specific embodiment, the application information may be referred to as URL.

The URL information may include entry information indicating whether the corresponding file is an entry file. Specifically, the entry file may indicate a file to be executed beforehand so as to execute the corresponding application.

The application information may include application boundary information indicating a boundary of the application. In a specific embodiment, the application boundary information may be referred to as ApplicationBoundary.

Also, the application boundary information may include origin URL information necessary for adding the boundary of the application. The origin URL information may be referred to as orginURL.

The application information may include content item information indicating information about a content item used by the application. The content item information may include detailed information about the content item. In a specific embodiment, the content item information may be referred to as contentItem.

The content item may include URL information for identifying a file that is a part of the corresponding application. The URL information may be referred to as URL.

The URL information may include entry information indicating whether the corresponding file is an entry content file. Specifically, the entry file may indicate a file to be executed beforehand so as to execute the corresponding content item. In a specific embodiment, the entry information may be referred to as entry.

The content item information may include update information indicating whether the update of the corresponding content item is available. Specifically, the update information indicates whether the content item will include a fixed file or the content item is a real-time data feed. In a specific embodiment, the update information may be referred to as updateAvail. The update information may be a Boolean element.

In the case where the update of the content item is available and whether to update a file included in the content item is confirmed in a polling scheme, the content item information may include a polling period. Specifically, the broadcast reception apparatus 100 may confirm whether to update the content item based on the polling period. Also, the polling period may be referred to as pollPeriod.

The content item information may include size information indicating a size of the content item. In a specific embodiment, the size information may indicate the size of the content item in kilobytes. The size information may be referred to as size.

The content item information may include available Internet information indicating that the content item is available via the Internet. In a specific embodiment, the available Internet information may be referred to as availableInternet. In a specific embodiment, the available Internet information may be a Boolean element.

The content item information may include available broadcast information indicating that the content item is available via a communication network. In a specific embodiment, the available broadcast information may be referred to as availableBroadcast. In a specific embodiment, the available broadcast information may be a Boolean element.

The application information may include event information indicating information about an event of the application. In a specific embodiment, the event information may be referred to as Event.

The event information may include an event identifier for identifying the event. Specifically, the event identifier may uniquely identify the event in the range of the corresponding application. In a specific embodiment, the event identifier may be referred to as eventID. In a specific embodiment, the event identifier may be a 16-bit element.

The event information may include destination information indicating a target device that is targeted by the application. The destination information may indicate that the application is only for a primary device that receives a broadcast signal. The destination information may indicate that the application is only for one or more interoperating devices that interoperate with the primary device that receives the broadcast signal. Also, the destination information may indicate that the application is for both the primary device and the interoperating devices. In a specific embodiment, the destination information may be referred to as destination.

The event information may include diffusion information for diffusing a triggering application information request. Specifically, the broadcast reception apparatus 100 may calculate a random value based on the diffusion information and request the server for the triggering application information after waiting as long as the random value. Specifically, the broadcast reception apparatus 100 may request the server for the triggering application information after waiting as long as the random value×10 ms. In a specific embodiment, the diffusion information may be referred to as diffusion. In a specific embodiment, the diffusion information may be an 8-bit element.

The event information may include data information indicating data associated with the event. Each event may have a data element associated with each event. In a specific embodiment, the data information may be referred to as Data.

The data information may include a data identifier for identifying the data. The data identifier may be referred to as dataID. The data identifier may be a 16-bit element.

In the hybrid broadcast, as described above, the media content can be transmitted by using the MPEG-DATA protocol and the MMT protocol. Upon transmission of the media content, it is necessary to transmit a trigger for triggering an application associated with the media content. Therefore, there is a need for a method of transmitting the trigger by using the MPEG-DASH protocol and the MMT protocol. Details thereof will be described with reference to the accompanying drawings.

MPEG-DATA defines an event so as to transmit non-periodic information to a DASH client or an application. Also, the MPEG-DASH defines a related event sequence as an event stream. Specifically, the MPEG-DASH may be for transmitting timed information required to be transmitted at a specific time. In this case, detailed information included in the event of the MPEG-DASH may be referred to as a message of the event. The event of the MPEG-DASH may be transmitted through an MPD. Also, the event of the MPEG-DASH may be transmitted through an inband of a representation. The broadcast transmission apparatus 100 may transmit a trigger for triggering the application as the event of the MPEG-DASH.

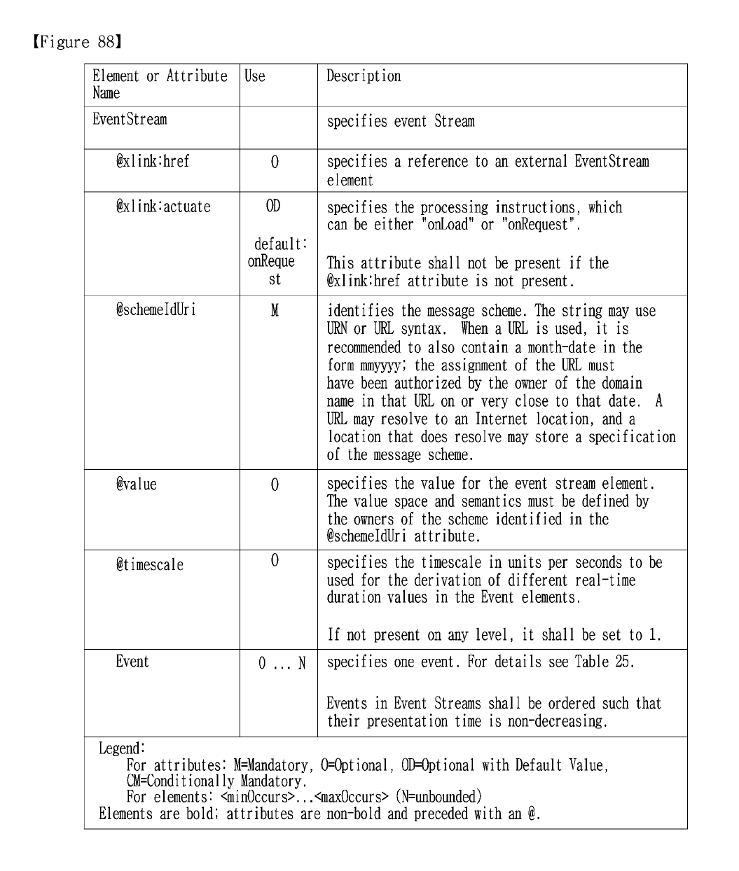

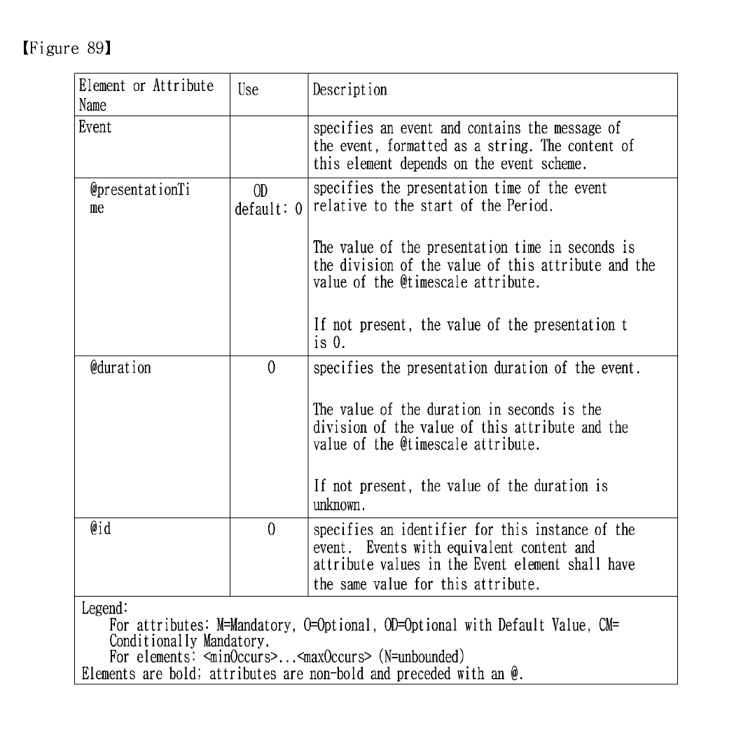

The transmission of the event of the MPEG-DASH through the MPD will be described with reference to FIGS. 88 and 89.

FIG. 88 illustrates a syntax of an Event Stream element included in the MPD according to an embodiment of the present invention. FIG. 89 illustrates a syntax of an Event element of the Event Stream element included in the MPD according to an embodiment of the present invention.

A presentation time of an event sequence of the MPEG-DASH may be provided as a period level. Specifically, the period element of the MPD may include an event stream element indicating information about an event stream. The broadcast reception apparatus 100 may terminate the event when an end time of the period including the event passes by. In particular, even when the event starts at a boundary time of the period, the broadcast reception apparatus 100 may terminate the event when the end time of the period including the event passes by.

The period element may include an event stream element including information about an event stream. In a specific embodiment, the event stream element may be referred to as EventStream.

The event stream element may include a scheme identifier element for identifying a scheme of a message included in the event. In a specific embodiment, the scheme identifier element may be referred to as schemeIDUri.

The event stream element may include a value element indicating a value for the event stream. In a specific embodiment, the value attribute may be referred to as value.

When the event included in the event stream is a timed event, the event stream element may include a timescale attribute indicating a unit of time. In a specific embodiment, the timescale attribute may be referred to as timescale.

The event stream element may specify each event and include an event element containing a message that is the contents of the event. In a specific embodiment, the event element may be referred to as event.

The event element may include a presentation start time attribute indicating a presentation start time of the event. Specifically, the presentation start time attribute may indicate a relative presentation start time with respect to a period start time. If the presentation start time attribute is not present, a value of the presentation start time may be 0. In a specific embodiment, the presentation start time attribute may be referred to as presentationTime.

The event element may include a presentation duration attribute indicating an event presentation duration. If the presentation duration attribute is not present, a value of the presentation duration may be unknown. In a specific embodiment, the presentation duration time attribute may be referred to as duration.

The event element may include an identifier attribute for identifying the event. Events with equivalent content and attribute values in the event element have the same identifier element values.

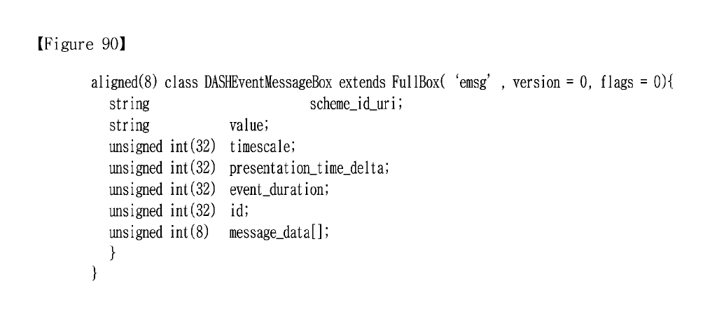

The transmission of the event of the MPEG-DASH through the inband stream will be described with reference to FIG. 90.

FIG. 90 illustrates a syntax of an event message box for inband event signaling according to an embodiment of the present invention.

The broadcast transmission apparatus 10 may multiplex the event stream of the MPEG-DASH together with the representation. Specifically, the broadcast transmission apparatus 10 may multiplex the event stream of the MPEG-DASH as a part of the segment together with the representation.

The event stream of the MPEG-DASH may be inserted into a selected representation. In a specific embodiment, the broadcast transmission apparatus 10 may insert the event stream into some representations included in an adaptation set. In another specific embodiment, the broadcast transmission apparatus 10 may insert the event stream into all partial representations included in the adaptation set.

The inband event stream included in the representation may be indicated by the inband event stream element included in the adaptation set or the representation level. In a specific embodiment, the inband event stream element may be referred to as InbandEventStream. In a specific embodiment, one representation may include a plurality of inband event streams. Each of the plurality of inband event streams may be indicated by a separate inband event stream element.

The event message box (‘emsg’) may provide signaling for a general event associated with the media presentation time. Also, the event message box may signal a specific operation associated with the DASH operation. In the case where the media segment is encapsulated in an ISO BMFF format, the media segment may include one or more event message boxes. Also, the event message box may be located before a moof box (‘moof’).

A scheme of the event message box may be defined in the MPD. Also, the broadcast reception apparatus 100 may ignore the event message box having a scheme that is not defined in the MPD.

The event message box may include a scheme identifier field for identifying the scheme of the event message box. In a specific embodiment, the scheme identifier field may be referred to as scheme_id_uri.

The event message box may include a value field indicating a value of the event. The value of the value field may have a different format and meaning according to the scheme identified by the scheme identifier field. In a specific embodiment, the value field may be referred to as value.

The event message box may include a timescale field for identifying the unit of time associated with the event message box. Specifically, the timescale field may indicate the unit of time of a presentation start time delay field and a presentation duration field included in the event message box. In a specific embodiment, the timescale field may be referred to as timescale.

The event message box may include the presentation start time delay field indicating how long the presentation start time of the event is delayed from the earliest presentation time of the segment. Specifically, the broadcast reception apparatus 100 may extract the earliest presentation time of the segment from a segment index box (‘sidx’). In this case, the broadcast reception apparatus 100 may obtain an event presentation start time by adding the time indicated by the presentation start time delay field to a segment presentation time. In a specific embodiment, this may be referred to as presentation_time_delta.

The event message box may include an event presentation duration field indicating an event presentation duration. If a value of the event presentation duration field is 0xfff, it indicates that the event presentation duration is unknown. In a specific embodiment, the event presentation duration field may be referred to as event_duration.

The event message box may include a message data field indicating a body of a message box. Data that the message data field has may change according to the scheme of the message box.

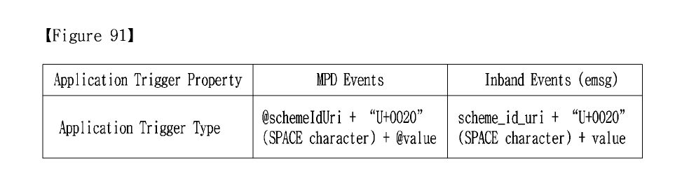

The application signaling information may be transmitted by matching the attribute of the trigger with the element of the MPD indicating the event stream of the MPEG-DASH and the event message box indicating the inband event stream. Details thereof will be described with reference to FIGS. 91 to 96.

First, in order to clearly distinguish the terms, the event of the MPEG-DASH and the event described in the triggering application information will be descried. The event of the MPEG-DASH is additional information associated with the media time that is non-periodically transmitted to the DASH client and the application. The event described in the triggering application information indicates the event triggered by the trigger. Specifically, the event triggered by the trigger may indicate that the application performs a specific action. Also, the event triggered by the trigger may indicate a change in the status of the application. In order to distinguish the event of the MPEG-DASH from the event triggered by the trigger, the event triggered by the trigger is referred to as a triggering event. Specifically, the triggering event may indicate an event generated by the trigger.

FIG. 91 illustrates a matching relationship among a trigger property, an MPD element, and an event message box for signaling a location of information about a triggered application according to an embodiment of the present invention.

The broadcast transmission apparatus 10 may transmit the location of the triggering application information as the event of the MPEG-DASH. In this case, the identifier attribute included in the event element of the MPD may indicate the identifier for identifying the triggering application information. Also, the message of the event may indicate the location of the triggering application information. The broadcast reception apparatus 100 may receive the triggering application information based on the event element. Specifically, the broadcast reception apparatus 100 may receive the triggering application information by extracting the location of the triggering application information from the message of the event.

In another specific embodiment, the identifier field included in the event message box may indicate the identifier for identifying the triggering application information. Also, the message data field included in the event message box may indicate the location of the triggering application information. The broadcast reception apparatus 100 may receive the triggering application information based on the event message box. Specifically, the broadcast reception apparatus 100 may receive the triggering application information by extracting the location of the triggering application information from the message data field of the event message box.

As described above, the triggering application information may be TPT.

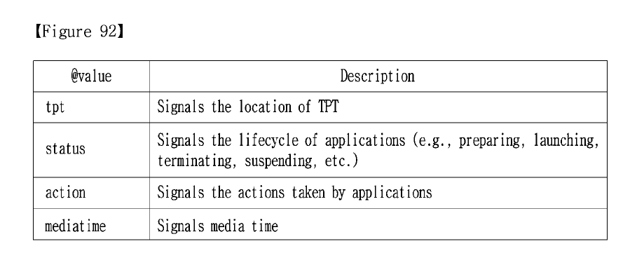

FIG. 92 illustrates a matching relationship among a trigger property, an MPD element, and an event message box for signaling a status of an application according to an embodiment of the present invention.

The broadcast transmission apparatus 10 may transmit the status of the application as the event of the MPEG-DASH. In this case, the presentation start time element included in the event element of the MPD may indicate the start time of the triggering event. Also, the identifier attribute included in the event element of the MPD may indicate the identifier for identifying the triggering application information. Also, the message contained in the event element may indicate the status of the application. The broadcast reception apparatus 100 may change the status of the application based on the event element. Specifically, the broadcast reception apparatus 100 may extract the status of the application from the message contained in the event element and change the status of the application. Specifically, the broadcast reception apparatus 100 may extract the status of the application from the message contained in the event element, extract the event start time from the presentation start time element, and change the status of the application at the start time of the triggering event.

In another specific embodiment, the presentation start delay time field included in the event message box may indicate the start time of the triggering event. Also, the identifier field included in the event message box may indicate the identifier for identifying the triggering application information. Also, the message data field included in the event message box may indicate the status of the application. The broadcast reception apparatus 100 may change the status of the application based on the event message box.

The status of the application may indicate at least one of preparing, executing, terminating, and suspending.

As described above, the triggering application information may be TPT.

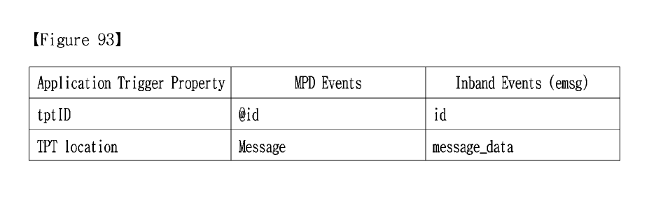

FIG. 93 illustrates a matching relationship among a trigger property, an MPD element, and an event message box for signaling an action of an application according to an embodiment of the present invention.

The broadcast transmission apparatus 10 may transmit the action of the application as the event of the MPEG-DASH. In this case, the presentation start time element included in the event element of the MPD may indicate the start time of the triggering event. Also, the presentation duration element included in the event element of the MPD may indicate a difference between the start time of the triggering event and the end time of the triggering event. In another specific embodiment, the presentation duration element included in the event element of the MPD may indicate the end time of the triggering event. Also, the identifier attribute included in the event element of the MPD may indicate the identifier for identifying the triggering application information. Also, the message contained in the event element may indicate the action carried out by the application. Specifically, the message contained in the event element may include at least one of the application identifier for identifying the triggered application, the event identifier for identifying the triggering event, and the data identifier for identifying the data. Specifically, the message contained in the event element may have a trigger type as described above. In this case, the message contained in the event element may not include the start time of the triggering event, the end time of the triggering event, and the identifier for identifying the program segment, which are included in the above-described attribute. For example, the message contained in the event element may be xbc.tv/e12?e=7.5. The broadcast reception apparatus 100 may carry out the action of the application based on the event element. Specifically, the broadcast reception apparatus 100 may extract the action of the application from the message contained in the event element and carry out the action of the application. Specifically, the broadcast reception apparatus 100 may extract the action of the application from the message contained in the event element, extract the start time of the triggering event from the presentation start time element, and carry out the action of the application at the start time of the triggering event. Also, in a specific embodiment, the broadcast reception apparatus 100 may extract the action of the application from the message contained in the event element, extract the start time of the triggering event from the presentation start time element, and carry out the action of the application between the start time of the triggering event and the end time of the triggering event. If the broadcast reception apparatus 100 receives the event message of the MPEG-DASH after the end time of the triggering event, the broadcast reception apparatus 100 may ignore the event message of the MPEG-DASH.

In another specific embodiment, the presentation start delay time field included in the event message box may indicate the start time of the triggering event. Also, the presentation duration field included in the event message box of the MPD may indicate a difference between the start time of the triggering event and the end time of the triggering event. In another specific embodiment, the presentation duration field included in the event message box of the MPD may indicate the end time of the triggering event. Also, the identifier field included in the event message box may indicate the identifier for identifying the triggering application information. Also, the message data field included in the event message box may indicate the action carried out by the application. Specifically, the message data field included in the event message box may include at least one of the application identifier for identifying the triggered application, the event identifier for identifying the triggering event, and the data identifier for identifying the data. Specifically, the message data field included in the event message box may have the above-described trigger type. In this case, the message data field included in the event message box may not include the start time of the triggering event, the end time of the triggering event, and the identifier for identifying the program segment, which are included in the above-described attribute. For example, the message data field included in the event message box may be xbc.tv/e12?e=7.5. The broadcast reception apparatus 100 may carry out the action of the application based on the event message box. Specifically, the broadcast reception apparatus 100 may extract the action of the application from the message data field of the event message box and carry out the action of the application. In a specific embodiment, the broadcast reception apparatus 100 may extract the action of the application from the message data field of the event message box, extract the start time of the triggering event from the presentation start time delay field, and carry out the action of the application at the start time of the triggering event. Also, in a specific embodiment, the broadcast reception apparatus 100 may extract the action of the application from the message data field of the event message box, extract the start time of the triggering event from the presentation start time delay field, and carry out the action of the application after the start time of the triggering event and before the end time of the triggering event. If the broadcast reception apparatus 100 receives the event message box after the end time of the triggering event, the broadcast reception apparatus 100 may ignore the event message box.

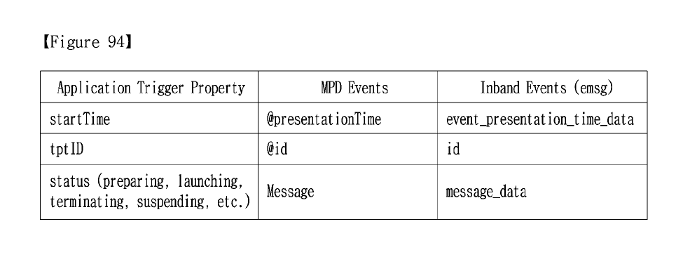

FIG. 94 illustrates a matching relationship among a trigger property, an MPD element, and an event message box for signaling a media time according to an embodiment of the present invention.

The broadcast transmission apparatus 10 may transmit the media time of the content as the event of the MPEG-DASH. In this case, the presentation start time element included in the event element of the MPD may indicate the media time of the content. In this case, the content may be content presented by the broadcast reception apparatus 100. Also, the identifier attribute included in the event element of the MPD may indicate the identifier for identifying the triggering application information. The broadcast reception apparatus 100 may extract the media time of the content based on the event element. Also, the broadcast reception apparatus 100 may generate a timeline which is a reference for synchronization between the triggering event and the content based on the media time of the content. Specifically, the broadcast reception apparatus 100 may extract the media time of the content from the presentation start time element included in the event element and generate the timeline which is a reference for synchronization between the triggering event and the content.

Also, the presentation start time delay field included in the event message box of the MPD may indicate the media time of the content. In this case, the content may be content presented by the broadcast reception apparatus 100. Also, the identifier attribute included in the event element of the MPD may indicate the identifier for identifying the triggering application information.

The broadcast reception apparatus 100 may extract the media time of the content based on the event message box. Also, the broadcast reception apparatus 100 may generate a timeline which is a reference for synchronization between the triggering event and the content based on the media time of the content. In this case, the content may be content presented by the broadcast reception apparatus 100. Specifically, the broadcast reception apparatus 100 may extract the media time of the content from the presentation start time delay field included in the event message box and generate the timeline which is a reference for synchronization between the triggering event and the content.

Also, the broadcast reception apparatus 100 may synchronize the content with the triggering event without extracting media time information included in the content.

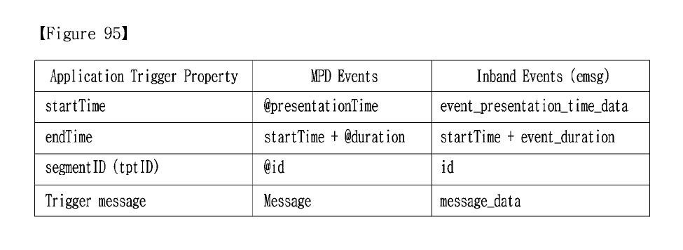

FIG. 95 illustrates a definition of value attributes for signaling all trigger properties as one event according to an embodiment of the present invention.

In order to transmit the trigger as the event of the MPEG-DASH, the event element may indicate a type of information signaled by the trigger. Specifically, the value attribute included in the event stream element may indicate that the trigger included in the message of the event signals the location of the triggering application information. In this case, a value of the value attribute may be tpt. Also, the value attribute included in the event stream element may indicate that the trigger included in the message of the event signals the status of the application. In this case, a value of the value attribute may be status. Also, the value attribute included in the event stream element may indicate that the trigger included in the message of the event signals the action of the application. In this case, a value of the value attribute may be action. Also, the value attribute included in the event stream element may indicate that the trigger included in the message of the event signals the media time of the content. In this case, a value of the value attribute may be mediatime. Also, the value attribute included in the event stream element may indicate that the trigger included in the message of the event includes any information that can be included in the trigger. In this case, a value of the value attribute may be trigger.

In another specific embodiment, the value field included in the event message box may indicate that the trigger included in the data message field of the event message box signals the location of the triggering application information. In this case, a value of the value field may be tpt. Also, the value field included in the event message box may indicate that the trigger included in the data message field of the event message box signals the status of the application. In this case, a value of the value field may be status. Also, the value field included in the event message box may indicate that the trigger included in the data message field of the event message box signals the action of the application. In this case, a value of the value field may be action. Also, the value field included in the event message box may indicate that the trigger included in the data message field of the event message box signals the media time of the content. In this case, a value of the value field may be mediatime. Also, the value field included in the event message box may indicate that the trigger included in the data message field of the event message box includes any information that can be included in the trigger. In this case, a value of the value field may be trigger. Details thereof will be described in detail with reference to the accompanying drawings.

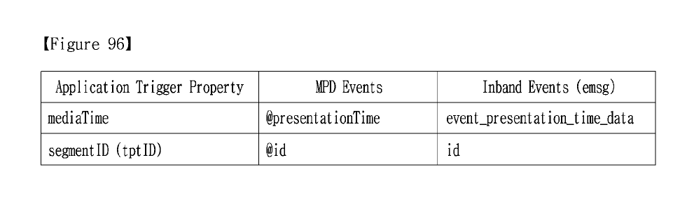

FIG. 96 illustrates a matching relationship among an identifier attribute and a message attribute of an event element and an identifier field and a message data field of an event message box for signaling all trigger properties as one event according to an embodiment of the present invention.

As described above, any attributes that can be included in the trigger may be signaled by one event of the MPEG-DASH. Specifically, the message of the event of the MPEG-DASH may include at least one of the identifier for identifying the triggered application, the identifier for identifying the triggering event, the identifier for identifying the data, the start time of the triggering event, and the end time of the triggering event.

In this case, the identifier attribute included in the event element may indicate the identifier for identifying the triggering application information. Also, the message contained in the event element may include the trigger itself. Specifically, the message contained in the event element may include the trigger having the above-described format. Also, the message contained in the event element may be the trigger having the timed text format.

Also, the identifier field of the event message box may indicate the identifier for identifying the triggering application information. Also, the message data field included in the event message box may include the trigger itself. Specifically, the message data field included in the event message box may include the trigger having the above-described format. Also, the message data field included in the event message box may include the trigger having the timed text format.

In this way, the broadcast transmission apparatus may multiplex a plurality of trigger properties through one event message of the MPEG-DASH. The broadcast reception apparatus 100 may obtain the plurality of trigger properties through one event message of the MPEG-DASH.

Also, the trigger may be signaled through the MMT protocol. Details thereof will be described with reference to the accompanying drawings.

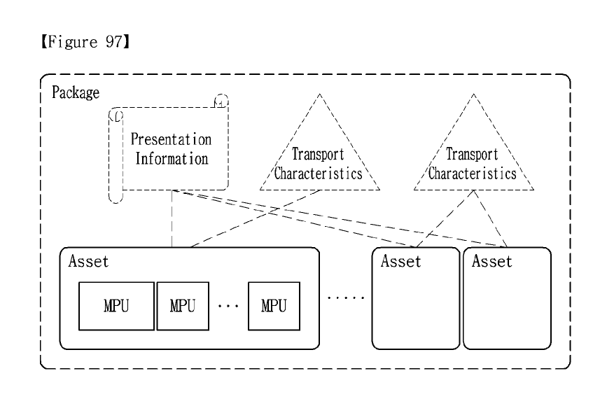

FIG. 97 illustrates a structure of a package of an MMT protocol according to an embodiment of the present invention.

As described above, the MMT protocol may be used as a protocol for transmitting media content in a hybrid broadcast. The transmission of the media content through the MMT protocol will be described through a package, an asset, a Media Processing Unit (MPU), and Presentation Information (PI).

The package is a logical transport unit of content transmitted by the MMT protocol. Specifically, the package may include the PI and the asset.

The asset is a unit of encoded media data included in the package. In a specific embodiment, the asset may indicate an audio track included in the content. Also, the asset may indicate a video track included in the content. Also, the asset may indicate a caption track included in the content. A service provider asset that provides the asset may include one or more MPUs.

The MPU is a media processing unit of the content transmitted by the MMT protocol. Specifically, the MPU may include a plurality of access units. Also, the MPU may include data having other formats, such as MPEG-4 AVC or MPEG-TS.

The PI is the media content presentation information described above. Specifically, the PI may include at least one of spatial information and temporal information necessary for consuming the asset. In a specific embodiment, the PI may be composition information defined in ISO-IEC 23008-1.

The broadcast transmission apparatus 10 may transmit the packet as an MMTP packet that is a transport unit of the MMT protocol. Types included in a payload of the MMT packet will be described with reference to the accompanying drawings.

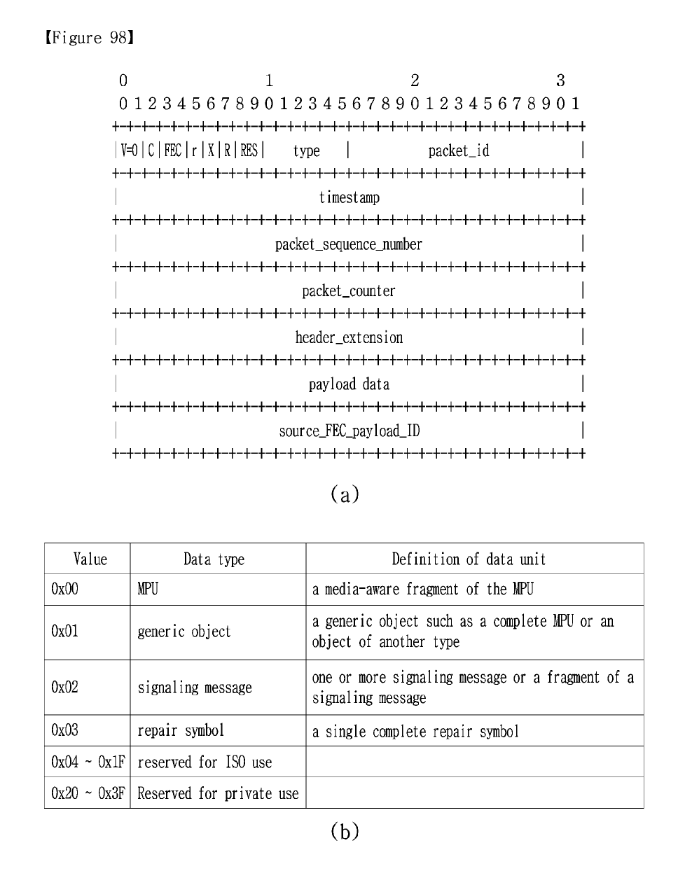

FIG. 98 illustrates a structure of an MMTP packet and types of data included in the MMTP packet according to an embodiment of the present invention.

The MMTP packet according to an embodiment of the present invention may have the structure illustrated in FIG. 98(a). In particular, the MMTP packet may indicate the type of the data included in the corresponding packet through a type field.

The MMTP packet may include a fragment of the MPU in the payload. Also, the MMTP packet may include a generic object indicating generic data in the payload. Specifically, the generic object may be one complete MPU. Also, the generic object may be an object of another type. Also, the MMTP packet may include a signaling message in the payload. Specifically, the MMTP packet may include one or more signaling messages. Also, the MMTP packet may include a fragment of a signaling message. The signaling message may be a unit of signaling information for signaling the media content transmitted by the MMT protocol. The MMTP packet may include one repair symbol. In a specific embodiment, the broadcast transmission apparatus 100 may transmit application signaling information through the MMTP packet including the fragment of the MPU. Specifically, the broadcast transmission apparatus 100 may transmit a trigger through the MMTP packet including the fragment of the MPU. Details thereof will be described with reference to the accompanying drawings.

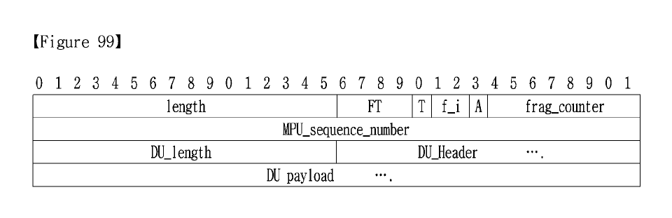

FIG. 99 illustrates a syntax of a header of an MMTP payload header when an MMTP packet includes a fragment of an MPU according to an embodiment of the present invention.

In the case where the MMTP packet includes the fragment of the MPU, the payload header of the MMTP packet may include a length field indicating length information of the payload of the MMTP packet. In a specific embodiment, the length field may be referred to as length. In a specific embodiment, the length field is a 16-bit field.

In the case where the MMTP packet includes the fragment of the MPU, the payload header of the MMTP packet may include a type field indicating a type of the MPU included in the payload of the MMTP packet. Specifically, in the case where the MMTP packet includes the fragment of the MPU, the payload of the MMTP packet may include media fragment unit, MPU metadata, and a movie fragment metadata. The MPU metadata may include ftyp, mmpu, and moov of ISO BMFF, and other boxes included between ftyp, mmpu, and moov. The movie fragment metadata may include a moof box and an mdat box from which the media data is excluded. The media fragment unit may include at least one of samples and sub-samples of the media data. In this case, the media data may be any one of timed media data, which is presented at a fixed time, and non-timed media data, whose presentation time is not determined. In a specific embodiment, the type field may be referred to as FT. In a specific embodiment, the type field may be a 4-bit field.

In the case where the MMTP packet includes the fragment of the MPU, the payload header of the MMTP packet may include a timed flag indicating whether the fragment of the MPU includes timed media. Specifically, if a value of the timed flag is 1, the timed flag may indicate that the fragment of the MPU included in the MMTP packet includes the timed media. In a specific embodiment, the timed flag may be referred to as T. In a specific embodiment, the timed flag may be a 1-bit flag.

In the case where the MMTP packet includes the fragment of the MPU, the payload header of the MMTP packet may include a fragment indicator indicating fragment information of data unit included in the payload. The data unit may indicate the unit of data included in the payload of the MMTP packet. The payload of the MMTP packet may include one or more data units. In a specific embodiment, the fragment indicator may be referred to as f_i. In a specific embodiment, the fragment indicator may be a 2-bit field.

In the case where the MMTP packet includes the fragment of the MPU, the payload header of the MMTP packet may include an aggregation flag indicating that one or more data units are included in the payload. In a specific embodiment, the aggregation flag may be referred to as A. In a specific embodiment, the aggregation flag may be a 1-bit flag.

In the case where the MMTP packet includes the fragment of the MPU, the payload header of the MMTP packet may include a fragment counter field indicating the number of fragments included in the same data units included in the payload. In the case where the aggregation flag indicates that one or more data units are included in the payload, a value of the fragment counter field may be 0. In a specific embodiment, the fragment counter field may be referred to as frag_counter. In a specific embodiment, the fragment counter field may be an 8-bit field.

In the case where the MMTP packet includes the fragment of the MPU, the payload header of the MMTP packet may include an MPU sequence field indicating a sequence number of a sequence including the fragment of the MPU. In a specific embodiment, the MPU sequence field may be referred to as MPU_sequence_number.

In the case where the MMTP packet includes the fragment of the MPU, the payload header of the MMTP packet may include a data unit length field indicating a length of the data unit. Specifically, in the case where the payload of the MMTP packet includes one or more data units, the payload header of the MMTP packet may include a data unit length field indicating a length of the data units. In a specific embodiment, the data unit length field may be referred to as DU_length. In a specific embodiment, the data unit length field may be referred to as DU_length.

In the case where the MMTP packet includes the fragment of the MPU, the payload header of the MMTP packet may include a data unit header field indicating a header of the data unit. A format of the data unit header field may be changed according to a type of data included in the data unit. Specifically, the format of the data unit header field may be changed according to the value of the type field described above. The transmission of the application signaling information by using such a payload header syntax will be described with reference to the accompanying drawings.

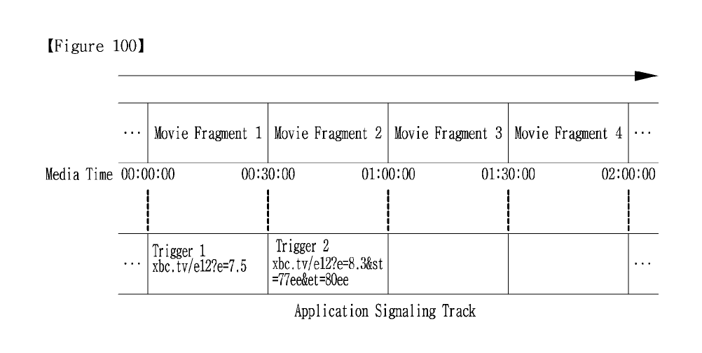

FIG. 100 illustrates synchronization of content and a trigger transmitted through an MPU according to an embodiment of the present invention.

The broadcast transmission apparatus 10 may transmit the application signaling information to the track of the ISO BMFF by transmitting the application signaling information to the MPU. In this way, the broadcast transmission apparatus 10 may transmit the application signaling information so that the application signaling information is synchronized with the content in frame unit. Specifically, the broadcast transmission apparatus 10 may transmit the application signaling information through the payload header syntax of the MMTP packet described above, so that the application signaling information is synchronized with the content in frame unit. In a specific embodiment, the broadcast transmission apparatus 10 may set the fragment type of the MPU as the media fragment unit and insert the application signaling message into the data unit payload before transmission. Also, the broadcast transmission apparatus 10 may be set so that the timed flag is transmitted by the timed media. Specifically, the broadcast transmission apparatus 10 may be set so that the timed flag is transmitted by the timed media in the case where the application signaling information must be transmitted together with the trigger at a specific time. Also, in the case where the application signaling information included in the data unit is the trigger, the trigger may have the above-described format. In another specific embodiment, the trigger may have a timed text format. Also, the trigger may have an XML format. Also, the trigger may include an application identifier for identifying the triggered application. Also, the trigger may include a triggering event identifier for identifying the triggering event. Also, the trigger may include an action indicating the operation of the triggered application. Also, the trigger may include a data identifier for identifying data required by the triggering event. Also, the trigger may include a start time of the triggering event. Also, the trigger may include an end time of the triggering event. As described above, the broadcast reception apparatus 10 may carry out the action between the start time of the triggering event and the end time of the triggering event. Specifically, the trigger may synchronize the application signaling information with a movie fragment presented in a determined sequence and a determined time. In a specific embodiment, the broadcast transmission apparatus 10 may set the start time of the triggering event and the end time of the triggering event with respect to an internal media time of the movie fragment. Also, the broadcast transmission apparatus 10 may set the start time of the triggering event and the end time of the triggering event as a relative time of the inside of the trigger. Also, the broadcast transmission apparatus 10 may set the start time of the triggering event and the end time of the triggering event as the time based on a wall clock provided through an out-of-band. For example, the broadcast transmission apparatus 10 may set the start time of the triggering event and the end time of the triggering event as the time based on a wall clock provided by CI. Also, the broadcast transmission apparatus 10 may set the start time of the triggering event and the end time of the triggering event as the time based on a wall clock provided by timestamp descriptor( ).

In the embodiment of FIG. 100, a first trigger (trigger 1) is synchronized with a first movie fragment (Movie Fragment 1). Also, a second trigger (trigger 2) is synchronized with a second movie fragment (Movie Fragment 2). Specifically, the first trigger signals the location of the triggering application information according to the above-described trigger type, and triggers the triggering event having the triggering event identifier of 5 to be immediately executed with respect to the application having the application identifier of 7. Also, the second trigger signals the location of the triggering application information according to the above-described trigger type, and triggers the triggering event having the triggering event identifier of 3 to be executed between 77ee and 88ee with respect to the application having the application identifier of 8.

The broadcast transmission apparatus 10 may transmit the application signaling message as one of the signaling messages of the MMT protocol. Details thereof will be described with reference to the accompanying drawings.

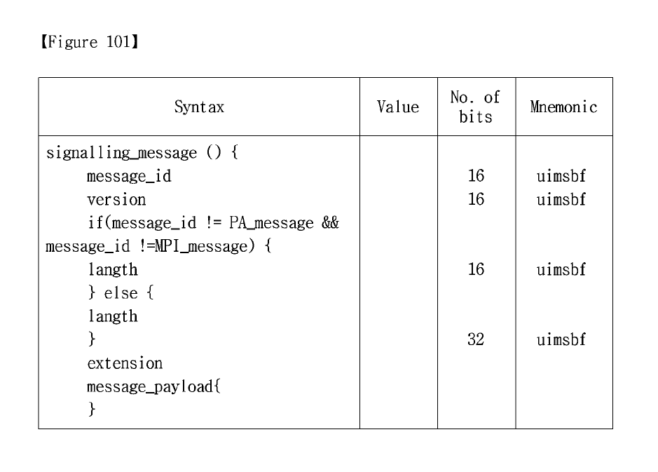

FIG. 101 illustrates a syntax of an MMT signaling message according to another embodiment of the present invention.

The MMT signaling message according to an embodiment of the present invention may include a message identifier for identifying the signaling message. In a specific embodiment, the message identifier may be referred to as message_id. In a specific embodiment, the message identifier may be a 16-bit element.

Also, the MMT signaling message may include version information indicating an update history of the signaling message. In a specific embodiment, the version information may be referred to as version. In a specific embodiment, the version information may be an 8-bit field.

The signaling message may include length information indicating a length of data included in the signaling message. The length information may be referred to as length. In a specific embodiment, the length information may be a 16-bit field or a 32-bit field.

The signaling message may include extension information indicating further extension of the signaling message. The signaling message may include a variety of information. Details thereof will be described with reference to the accompanying drawings.

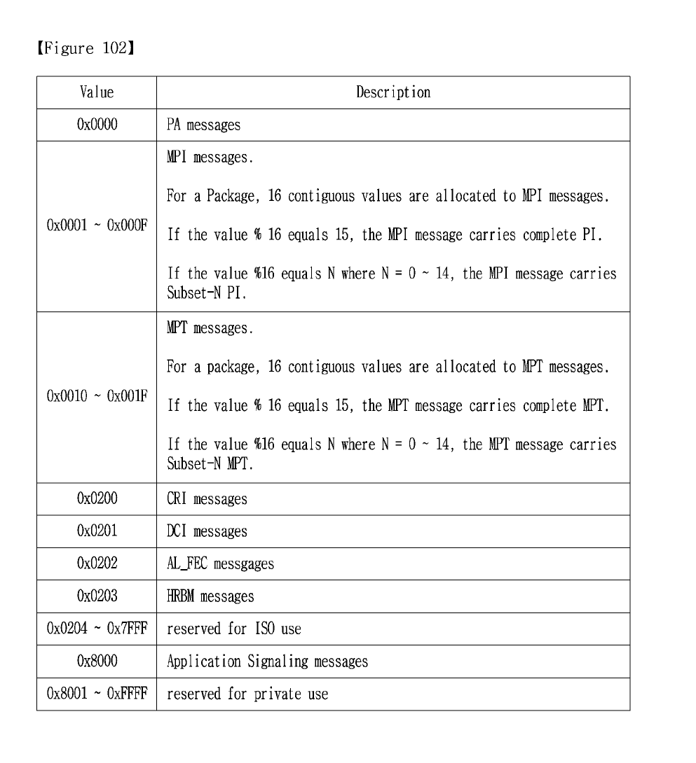

FIG. 102 illustrates a relationship between a value of an identifier for identifying an MMT signaling message and data signaled by the MMT signaling message according to another embodiment of the present invention.

Specifically, the signaling message may be a PA message indicating information of all different signaling tables. In this case, a value of the message identifier may be 0x0000. The signaling message may be an MPI message including media content presentation information. In this case, a value of the identifier may range from 0x0001 to 0x000F. The signaling message may be an MPT message including an MP table indicating information about an asset included in the package. In this case, a value of the message identifier may range from 0x0011 to 0x001F. Also, the signaling message may be a CRI message including a CRI table indicating synchronization information. In this case, a value of the message identifier may be 0x0200. The signaling message may be a DCI message including a DCI table indicating device performance necessary for consuming the package. In this case, a value of the message identifier may be 0x0201. Also, the signaling message may be an AL_FEC message indicating FEC information necessary for receiving the asset. In this case, a value of the message identifier may be 0x0202. Also, the signaling message may be an HRBM message indicating a memory required for the broadcast reception apparatus 100 and an end-to-end transmission delay. In this case, a value of the message identifier may be 0x0203. In order for transmitting the application signaling information, the signaling message may be an application signaling message including application signaling information, in addition to the above-described type of the message. The broadcast reception apparatus 100 may identify the type of the message included in the signaling message by the above-described message identifier. In this case, a value of the message identifier may be 0x8000. The format of the application signaling message will be described with reference to the accompanying drawings.

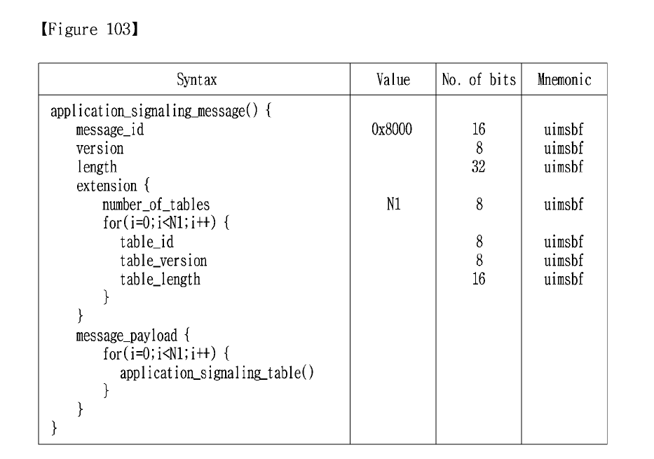

FIG. 103 illustrates a syntax of a signaling message including application signaling information according to another embodiment of the present invention.

The application signaling message according to another embodiment of the present invention may include an application signaling table containing application signaling information. In a specific embodiment, the signaling message may include a plurality of application signaling tables.

The application signaling message may include number-of-tables information indicating the number of application tables included in the application signaling message. In a specific embodiment, the number-of-tables information may be referred to as number_of_tables. The number-of-tables information may be an 8-bit field.

The application signaling message may include table identifier information for identifying the application table included in the application signaling message. In a specific embodiment, the table identifier information may be referred to as table_id. The table identifier information may be an 8-bit field.

The application signaling message may include table version information indicating an update history of the signaling table. In a specific embodiment, the table version information may be referred to as table_version. In a specific embodiment, the table version information may be an 8-bit field.

The application signaling message may include table length information indicating a length of the signaling table. In a specific embodiment, the table length information may be referred to as table_length. In a specific embodiment, the table length information may be an 8-bit field. A syntax of the application signaling table will be described in detail with reference to the accompanying drawings.

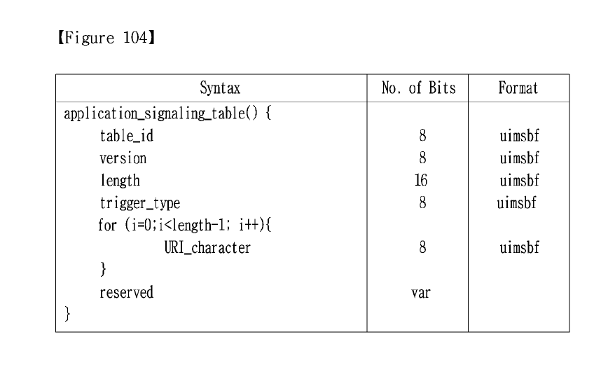

FIG. 104 illustrates a syntax of an application signaling table including application signaling information according to another embodiment of the present invention.

The application signaling table according to another embodiment of the present invention may include an identifier for identifying the application signaling table. In a specific embodiment, the identifier may be referred to as table_id. The identifier information may be an 8-bit field.

The application signaling table may include version information indicating an update history of the application signaling table. In a specific embodiment, the version information may be referred to as version. In a specific embodiment, the version information may be an 8-bit field.

The application signaling table may include length information indicating a length of the application signaling table. In a specific embodiment, the length information may be referred to as length. In a specific embodiment, the length information may be a 16-bit field.

The application signaling table may include trigger type information indicating a type of a trigger included in the application signaling table. The type of the trigger included in the signaling table may be various. Details thereof will be described with reference to the accompanying drawings.

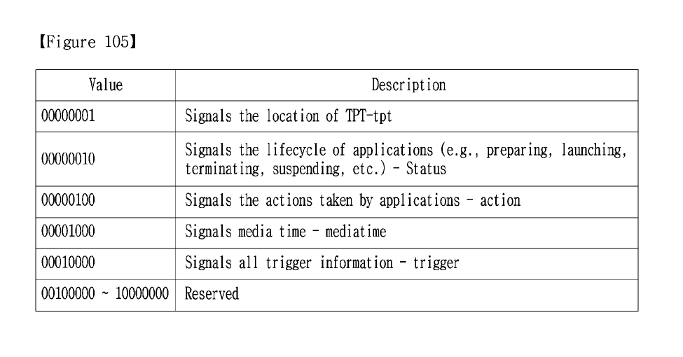

FIG. 105 illustrates a relationship between trigger type information included in an application signaling table and a trigger property included in a trigger according to another embodiment of the present invention.

The trigger included in the signaling table may signal the location of the triggering application information. In this case, a value of trigger type information may be 1. Also, the trigger included in the signaling table may signal a lifecycle of an application. Specifically, the trigger included in the signaling table may signal a status of the application. In this case, a value of the trigger type information may be 2. Also, the trigger included in the signaling table may signal an action of the application. In this case, a value of the trigger type information may be 3. Also, the trigger included in the signaling table may signal media time of content. In this case, a value of the trigger type information may be 4. Also, the trigger included in the signaling table may include any information that can be included in the trigger. In this case, a value of the trigger type information may be 5. Returning to FIG. 104, the description will be given.

In a specific embodiment, the trigger type information may be referred to as trigger_type. In a specific embodiment, the trigger type information may be an 8-bit field.

The signaling information table may include a text indicating the trigger. Specifically, the signaling information table may include text information indicating the text included in the trigger. In a specific embodiment, the signaling information table may include a plurality of text information. In a specific embodiment, the text information may be referred to as URL_character. Also, the type of the trigger is the same as described above. In a specific embodiment, the text information may be an 8-bit field.

However, in the embodiments described with reference to FIGS. 104 and 105, the type of the trigger is indicated through the trigger type information in the application signaling message table. However, in this case, the broadcast reception apparatus 100 must parse the application signaling table so as to recognize the type of the trigger. Therefore, there is a problem that the broadcast reception apparatus 100 cannot selectively receive only a necessary type of the trigger. A method for solving the above problem will be described with reference to the accompanying drawings.

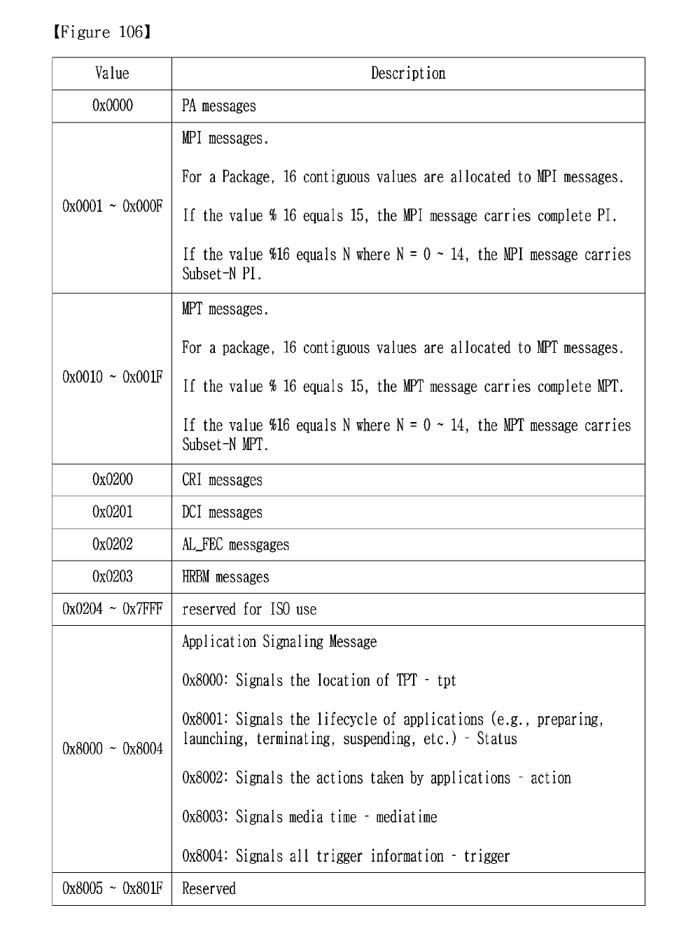

FIG. 106 illustrates a relationship between a value of an identifier for identifying an MMT signaling message and data signaled by the MMT signaling message according to another embodiment of the present invention.

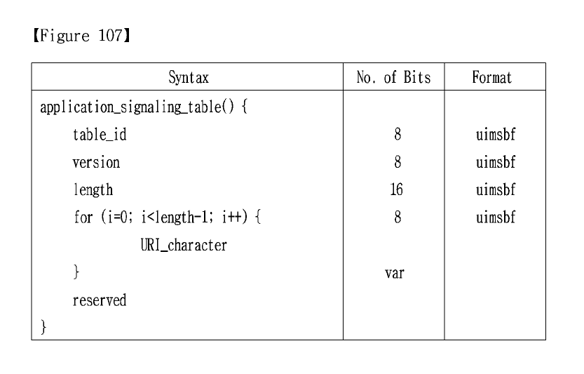

The broadcast transmission apparatus 10 may change a message identifier value for identifying the application signaling message based on the type of the trigger included in the application signaling message. Specifically, the broadcast transmission apparatus 10 may differently set the message identifier value according to whether the type of the trigger is a trigger for signaling the location of the triggering application information, a trigger for signaling the lifecycle of the application, a trigger for signaling the action of the application, a trigger for signaling the media time of the content, and a trigger including any information that can be included by the trigger. Specifically, if the value of the message identifier is in a range of 0x8000 to 0x8004, it may indicate that the signaling message is the application signaling message. Also, in a specific embodiment, if the trigger included in the application signaling message signals the location of the triggering application information, the value of the message identifier may be 0x8000. Also, if the trigger included in the application signaling message signals the lifecycle of the application, the value of the message identifier may be 0x8001. Also, if the trigger included in the application signaling message signals the action of the application, the value of the message identifier may be 0x8002. Also, if the trigger included in the application signaling message signals the media time of the content, the value of the message identifier may be 0x8003. Also, if the trigger included in the application signaling message includes any information that can be included by the trigger, the value of the message identifier may be 0x8004. Since the message identifier of the signaling message indicates the type of the trigger included in the application signaling message, the application signaling table may not include the trigger type information. In the embodiment of FIG. 107, unlike the application signaling table described above, the application signaling table may not include the trigger type information.

As such, if the value of the message identifier for identifying the application signaling message is different according to the type of the trigger included in the signaling message, the broadcast reception apparatus 100 may know the type of the trigger without parsing the application signaling table included in the application signaling message. Therefore, the broadcast reception apparatus 100 can selectively receive a specific type of the trigger in an efficient manner.

The broadcast transmission apparatus 10 may transmit the application signaling information through a generic packet. Details thereof will be described with reference to the accompanying drawings.

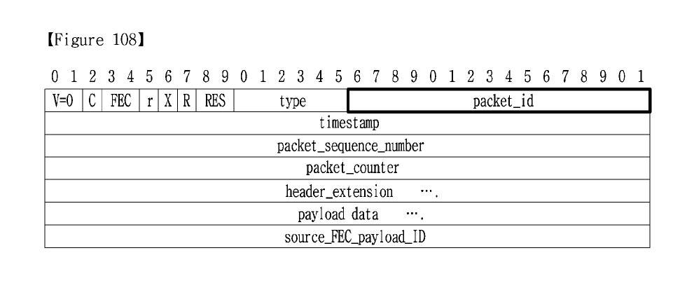

FIG. 108 illustrates a structure of an MMTP according to another embodiment of the present invention.

First, a syntax of an MMTP packet will be described.

The MMTP packet may include version information indicating a version of the MMTP protocol. In a specific embodiment, the version information may be referred to as V. In a specific embodiment, the version information may be a 2-bit field.

The MMTP packet may include packet counter flag information indicating the presence of packet counting information. In a specific embodiment, the packet counter flag information may be referred to as C. In a specific embodiment, the packet counter flag information may be a 1-bit field.

The MMTP packet may include FEC type information illustrating a scheme of an FEC algorithm for error prevention of the MMTP packet. In a specific embodiment, the FEC type information may be referred to as FEC. In a specific embodiment, the FEC type information may be a 2-bit field.

The MMTP packet may include extension flag information indicating the presence of header extension information. In a specific embodiment, the extension flag information may be referred to as X. In a specific embodiment, the extension flag information may be a 1-bit field.

The MMTP packet may include RAP (Random Access Point) flag information indicating whether the RAP for data random access of the payload is included. In a specific embodiment, the RAP flag information may be referred to as R. In a specific embodiment, the RAP flag information may be a 1-bit field.

The MMTP packet may include type information indicating the data type of the payload. In a specific embodiment, the type information may be referred to as type. In a specific embodiment, the type information may be a 6-bit field.

The MMTP packet may include packet identifier information indicating the identifier for identifying the packet. The broadcast reception apparatus 100 may determine in which asset the corresponding packet is included, based on the packet identifier information. Also, the broadcast reception apparatus 100 may obtain a relationship between the asset and the packet identifier from the signaling message. The packet identifier information may have a unique value during a lifetime of a corresponding transport session. In a specific embodiment, the packet identifier information may be referred to as packet_id. In a specific embodiment, the packet identifier information may be a 16-bit field.

The MMTP packet may include packet sequence number information indicating a packet sequence number. In a specific embodiment, the packet sequence number information may be referred to as packet_sequence_number. In a specific embodiment, the packet sequence number information may be a 32-bit field.

The MMTP packet may include timestamp information specifying a time instance value of the MMTP packet transmission. The timestamp information may be based on a UTC value. Also, the timestamp information may indicate the time at which the first byte of the MMTP packet is transmitted. In a specific embodiment, the timestamp information may be referred to as timestamp. In a specific embodiment, the timestamp information may be a 32-bit field.

The MMTP packet may include packet counting information indicating a count of the transmitted packet. In a specific embodiment, the packet counting information may be referred to as packet_counter. In a specific embodiment, the packet counting information may be a 32-bit field.

The MMTP packet may include necessary FEC information according to an FEC protection algorithm. In a specific embodiment, the FEC information may be referred to as Sourece_FEC_payload_ID. In a specific embodiment, the FEC information may be a 32-bit field.

The MMTP packet may include header extension information reserved for further header extension. In a specific embodiment, the header extension information may be referred to as header_extension.

The broadcast transmission apparatus 10 may insert the application signaling information into the payload of the packet of the generic type before transmission. Specifically, the broadcast transmission apparatus 10 may insert the application signaling information into the payload of the packet of the generic type in a file format before transmission. In this case, the broadcast transmission apparatus 10 may assign different packet identifiers to the respective files. The broadcast reception apparatus 100 may extract the application signaling information from the generic packet. Specifically, the broadcast reception apparatus 100 may extract a file including the application signaling information from the generic packet. Specifically, the broadcast reception apparatus 100 may extract the file including the application signaling information based on the packet identifier of the generic packet. For example, the broadcast reception apparatus 100 may determine whether the corresponding packet includes necessary application signaling information based on the packet identifier value of the generic packet.

The broadcast transmission apparatus 10 may transmit the application signaling information by using the header extension information of the MMTP packet. Details thereof will be described with reference to the accompanying drawings.

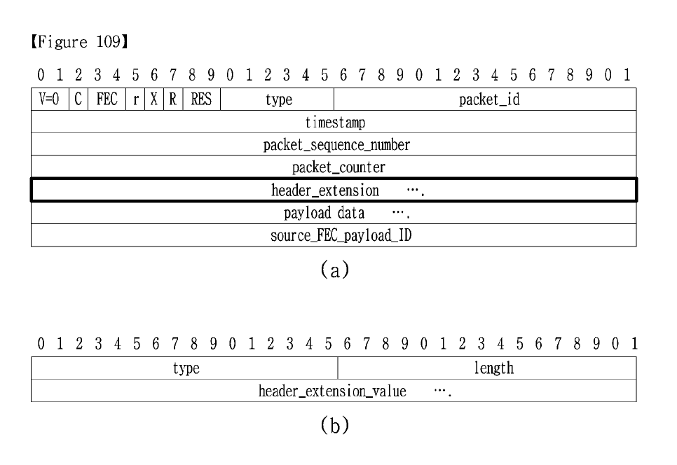

FIG. 109 illustrates a structure of an MMTP packet and a syntax of a header extension field for transmitting application signaling information according to another embodiment of the present invention.

The broadcast transmission apparatus 10 may insert the application signaling information into the header of the MMTP packet before transmission. Specifically, the broadcast transmission apparatus 10 may insert the application signaling information into the header extension information before transmission.

In a specific embodiment, the header extension information may include header extension type information indicating a type of the header extension information which is included in the header extension information. In this case, the header extension type may indicate that the header extension information includes the application signaling message. In another specific embodiment, the header extension type information may indicate the type of the application signaling information which is included in the header extension information. In this case, the type of the application signaling information may include the type of the trigger according to the property included in the trigger described above. In a specific embodiment, the header extension type information may be referred to as type.

In a specific embodiment, the header extension information may be a 16-bit field. In a specific embodiment, the header extension information may include header extension length information indicating a length of the header extension information. In this case, the header extension length information may indicate the length of the application signaling information included in the header extension information. In a specific embodiment, the header extension length information may be referred to as length. In a specific embodiment, the header extension length information may be a 16-bit field.

In a specific embodiment, the header extension information may include a header extension value indicating extension information included in the header extension information. In this case, the header extension value may indicate the application signaling information included in the header extension information. In this case, the application signaling information may be a trigger. Also, the type of the application signaling information may be a URL of a string format. Also, the URI of the string format may be the trigger of the string format described above. In a specific embodiment, the header extension value may be referred to as header_extension_value.

Therefore, the broadcast reception apparatus 100 may extract the application signaling information from the header extension information. Specifically, the broadcast reception apparatus 100 may extract the application signaling information based on the header extension type information included in the header extension information. Specifically, the broadcast reception apparatus 100 may determine whether the corresponding header extension information includes the application signaling information based on the header extension type information. When the corresponding header extension information includes the application signaling information, the broadcast reception apparatus 100 may extract the application signaling information. Also, the broadcast reception apparatus 100 may determine the type of the application signaling information included in the corresponding header extension information, based on the header extension type information. Therefore, the broadcast reception apparatus 100 may selectively obtain the application signaling information.

The operations of the broadcast transmission apparatus 10 and the broadcast reception apparatus 100 for transmission and reception of the application signaling information, according to the above-described embodiments of the present invention, will be described in detail with reference to the accompanying drawings.

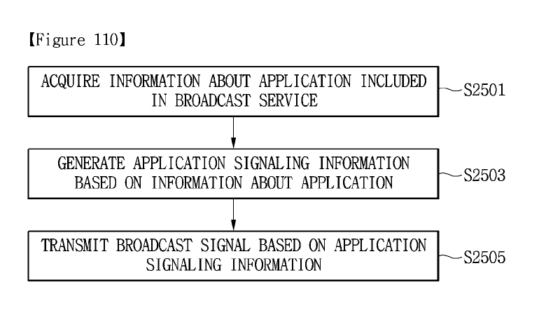

FIG. 110 illustrates that a broadcast transmission apparatus transmits a broadcast signal based on application signaling information according to another embodiment of the present invention.

The broadcast transmission apparatus 10 obtains information about an application included in a broadcast service (S2501). Specifically, the broadcast transmission apparatus 10 may obtain the information about the application included in the broadcast service through a control unit.

The broadcast transmission apparatus 10 generates application signaling information based on the information about the application (S2503). Specifically, the broadcast transmission apparatus 10 may generate the application signaling information based on the information about the application through the control unit. In this case, as described above, the application signaling information may include at least one of a trigger for triggering an action of the application and triggering application information for signaling the information about the triggered application.

The broadcast transmission apparatus 10 transmits the broadcast signal based on the application signaling information (S2505). Specifically, the broadcast transmission apparatus 10 may transmit the broadcast signal based on the application signaling information through a transmission unit. Specifically, as described above, the broadcast transmission apparatus 10 may transmit the application signaling information by using an MPEG-DASH protocol. Specifically, the broadcast transmission apparatus 10 may transmit the application signaling information to the event stream of the MPD of the MPEG-DASH. Also, the broadcast transmission apparatus 10 may transmit the application signaling information to the inband event stream. For example, the broadcast transmission apparatus 10 may transmit the application signaling information through the event message box. In another specific embodiment, the broadcast transmission apparatus 10 may transmit the application signaling information by using the MMT protocol. Specifically, the broadcast transmission apparatus 10 may transmit the application signaling message based on the packet format including the MPU of the MMT protocol. Also, the broadcast transmission apparatus 10 may transmit the application signaling message based on the packet format including the generic object of the MMT protocol. Also, the broadcast transmission apparatus 10 may transmit the application signaling message based on the packet format including the signaling message of the MMT protocol. Also, the broadcast transmission apparatus 10 may transmit the application signaling message based on the header extension information of the packet of the MMT protocol.

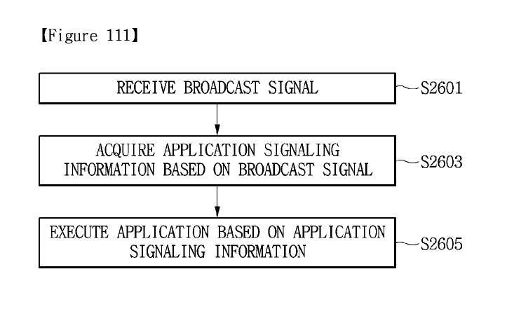

FIG. 111 illustrates that a broadcast reception apparatus obtains application signaling information based on a broadcast signal according to embodiments of the present invention.

The broadcast reception apparatus 100 receives the broadcast signal (S2601). Specifically, the broadcast reception apparatus 100 may receive the broadcast signal through a reception unit 110.

The broadcast reception apparatus 100 obtains the application signaling information based on the broadcast signal (S2603). Specifically, the broadcast reception apparatus 100 may obtain the application signaling information based on the broadcast signal through the control unit 150. Specifically, as described above, the broadcast reception apparatus 100 may obtains the application signaling information based on the MPEG-DASH protocol. Specifically, the broadcast reception apparatus 100 may obtain the application signaling information based on the event stream of the MPD of the MPEG-DASH. Also, the broadcast reception apparatus 100 may obtain the application signaling information to the inband event stream. For example, the broadcast reception apparatus 100 may transmit the application signaling information from the event message box. In another specific embodiment, the broadcast reception apparatus 100 may obtain the application signaling information based on the MMT protocol. Specifically, the broadcast reception apparatus 100 may obtain the application signaling message based on the packet format including the MPU of the MMT protocol. Also, the broadcast reception apparatus 100 may obtain the application signaling message based on the packet format including the generic object of the MMT protocol. Also, the broadcast reception apparatus 100 may obtain the application signaling message based on the packet format including the signaling message of the MMT protocol. Also, the broadcast reception apparatus 100 may obtain the application signaling message based on the header extension information of the packet of the MMT protocol. As described above, the application signaling information may include at least one of a trigger for triggering an action of the application and triggering application information for signaling the information about the triggered application.

The broadcast reception apparatus 100 executes the application based on the application signaling information (S2605). Specifically, the broadcast reception apparatus 100 may executes the application based on the application signaling information through the control unit. In a specific embodiment, the broadcast reception apparatus 100 may change the status of the application based on the application signaling information. Specifically, the broadcast reception apparatus 100 may change the status of the application based on the application signaling information at the triggering event start time. Also, the broadcast reception apparatus 100 may change the status of the application based on the application signaling information between the triggering event start time and the triggering event end time. In another specific embodiment, the broadcast reception apparatus 100 may carry out an action triggered to the application based on the application signaling information. Specifically, the broadcast reception apparatus 100 may carry out the action triggered to the application based on the application signaling information at the triggering event start time. Also, the broadcast reception apparatus 100 may carry out the action triggered to the application based on the application signaling information between the triggering event start time and the triggering event end time. In another specific embodiment, the broadcast reception apparatus 100 may receive the triggering application information based on the application signaling information. In another specific embodiment, the broadcast reception apparatus 100 may obtain the media time of the content based on the application signaling information. Specifically, the broadcast reception apparatus 100 may obtain the media time of the presented content. Also, the broadcast reception apparatus 100 may obtain the media time and generate the timeline which is a reference for synchronization between the triggering event and the content based on the media time of the content.

The broadcast transmission apparatus 10 may efficiently transmit the application signaling information through such an operation method. In particular, the broadcast transmission apparatus 10 may transmit the application signaling information through the MPEG-DASH protocol or the MMT protocol. Also, the broadcast reception apparatus 100 may efficiently receive the application signaling information. In particular, the broadcast transmission apparatus 10 may transmit the application signaling information through the MPEG-DASH protocol or the MMT protocol.

The features, structures, and effects described above are included in at least one embodiment, and are not necessarily limited to only one embodiment. Furthermore, the features, structures, and effects described in each embodiment can be achieved through combination or modification with respect to other embodiments by those skilled in the art to which the embodiments pertain.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A broadcast reception apparatus for receiving broadcast signals, the broadcast reception apparatus comprising:
a broadcast reception unit for receiving broadcast signals; and
a control unit for obtaining application signaling information regarding application signaling included in a broadcasting service on the basis of the broadcast signals.

2. The broadcast reception apparatus of claim 1, wherein the control unit obtains the application signaling information based on Moving Picture Expert Group-Dynamic Adaptive Streaming over HTTP (MPEG-DASH).

3. The broadcast reception apparatus of claim 2, wherein the control unit obtains the application signaling message based on an event message of a Media Presentation Description (MPD) of an event stream of the MPEG-DASH.

4. The broadcast reception apparatus of claim 3, wherein the control unit obtains a start time of a triggering event from the MPD.

5. The broadcast reception apparatus of claim 2, wherein the control unit obtains the application signaling information from an inband event stream of the MPEG-DASH.

6. The broadcast reception apparatus of claim 5, wherein the control unit obtains a start time of a triggering event from an event message box.

7. The broadcast reception apparatus of claim 1, wherein the control unit obtains the application signaling information based on a Moving picture expert group Media Transport (MMT) protocol packet.

8. The broadcast reception apparatus of claim 7, wherein the control unit obtains the application signaling information based on a format of the MMT protocol packet including a Media Processing Unit (MPU).

9. The broadcast reception apparatus of claim 7, wherein the control unit obtains the application signaling information based on a format of the MMT protocol packet including a generic object.

10. The broadcast reception apparatus of claim 7, wherein the control unit obtains the application signaling information based on a format of the MMT protocol packet including a signaling message.

11. The broadcast reception apparatus of claim 7, wherein the control unit obtains the application signaling information based on header extension information indicating information for header expansion of the MMT protocol packet.

12. The broadcast reception apparatus of claim 1, wherein the application signaling information includes a trigger for triggering the application.

13. The broadcast reception apparatus of claim 12, wherein the control unit carries out an action of the application based on the trigger.

14. The broadcast reception apparatus of claim 13, wherein the control unit carries out the action of the application after a start time of a triggering event from the trigger and before an end time of the triggering event included in the trigger, and
the triggering event indicates an event generated by a trigger.

15. The broadcast reception apparatus of claim 12, wherein the control unit changes a status of the application based on the trigger.

16. The broadcast reception apparatus of claim 12, wherein the control unit obtains a location of triggering application information for signaling information about an application triggered by the trigger, based on the trigger, and obtains the triggering application information based on the location of the triggering application information.

17. The broadcast reception apparatus of claim 12, wherein the control unit obtains a media time of content presented by the broadcast reception apparatus, based on the trigger.

18. The broadcast reception apparatus of claim 17, wherein the control unit generates a timeline which is a reference for synchronization between the triggering event and the content based on the media time of the content, and
the triggering event indicates an event generated by a trigger.

19. An operation method of a broadcast reception apparatus for receiving broadcast signals, the operation method comprising:
receiving broadcast signals; and
obtaining application signaling information regarding application signaling included in a broadcasting service on the basis of the broadcast signals.

20. An operation method of a broadcast transmission apparatus for transmitting broadcast signals, the broadcasting transmission apparatus comprising:
a control unit for obtaining information about an application included in a broadcast service and generating application signaling information regarding application signaling on the basis of the information about the application; and
a transmission unit for transmitting the broadcast signal on the basis of the application signaling information.
